(19) United States
(12) Patent Application Publication
(10) Pub. No.: US 2026/0134686 A1
(43) Pub. Date: May 14, 2026

(54) ARTIFICIAL INTELLIGENCE VIDEO ANALYZER FOR COMPLIANCE ASSESSMENT

(71) Applicant: Know Me, Inc., Las Vegas, NV (US)

(72) Inventors: Phil Hui-Bon-Hoa, Henderson, NV (US); Helmar Gerhardt, Redondo Beach, CA (US); Luke Patay, Rancho Palos Verdes, CA (US)

(21) Appl. No.: 19/308,156

(22) Filed: Aug. 22, 2025

Related U.S. Application Data
(60) Provisional application No. 63/686,654, filed on Aug. 23, 2024.
(60) Provisional application No. 63/686,663, filed on Aug. 23, 2024.
(60) Provisional application No. 63/686,660, filed on Aug. 23, 2024.

(51) Int. Cl. G06V 20/40; G06Q 10/1053; G06T 3/02; G06T 5/40; G06T 5/50; G06T 5/92; G06T 7/246; G06V 10/25; G06V 10/62; G06V 10/764; G06V 10/82; G06V 20/62; G06V 30/10; G06V 40/10; G06V 40/16; G10L 15/02; G10L 15/04; G10L 15/16; G10L 15/187; G10L 15/26; G10L 25/18; G10L 25/24; G10L 25/57; G10L 25/84

(52) U.S. Cl. CPC G06V 20/46; G06T 3/02; G06T 5/40; G06T 5/50; G06T 5/92; G06T 7/246; G06V 10/25; G06V 10/62; G06V 10/764; G06V 10/82; G06V 20/41; G06V 20/635; G06V 30/10; G06V 40/103; G06V 40/161; G06V 40/174; G10L 15/02; G10L 15/04; G10L 15/16; G10L 15/187; G10L 15/26; G10L 25/18; G10L 25/24; G10L 25/57; G10L 25/84; G06Q 10/1053; G06T 2207/10016; G06T 2207/10024; G06T 2207/20084; G10L 2015/025

(57) ABSTRACT

Provided is a process, including: obtaining a video data stream comprising a sequence of image frames and associated audio; extracting a plurality of features from the transformed video data stream; evaluating the plurality of features with respect to a plurality of compliance rules by applying one or more trained machine learning models to detect patterns indicative of potential violations, the trained models configured to capture semantic, contextual, and cross-modal relationships between extracted content and predefined policy constraints; and constructing an output data structure comprising an assessment of whether the video content conforms to the plurality of compliance rules, the output data structure identifying nonconforming segments and providing time-aligned annotations corresponding to the detected nonconformities.

### CROSS-REFERENCE TO RELATED APPLICATIONS

This patent claims the benefit of U.S. Provisional Patent App. 63/686,654, titled AI-POWERED VIDEO ANALYZER, filed Aug. 23, 2024; U.S. Provisional Patent App. 63/686,663, titled AI-POWERED VIDEO ANALYZER FOR COMPLIANCE ASSESSMENT, filed Aug. 23, 2024; and U.S. Provisional Patent App. 63/686,660, titled SCALABLE MATCHING BASED ON HIGH-DIMENSIONAL DATA, filed Aug. 23, 2024; each of which is hereby incorporated by reference in its entirety.

### FIELD OF INVENTION

The present disclosure relates to artificial intelligence-powered video analysis systems and, more particularly, to an AI video analyzer for compliance assessment.

### BACKGROUND

The field of computer vision and artificial intelligence has advanced considerably in recent years, affording automated analysis of human behavior through video recordings. Machine learning algorithms can now detect and interpret facial expressions, body language, vocal patterns, and other behavioral cues with increasing accuracy. These technological developments have opened new possibilities for objective behavioral assessment across various domains.

Video-based analysis systems have emerged as a promising approach for evaluating human characteristics and behaviors. Such systems can process large volumes of data consistently and provide standardized assessments without the variability introduced by human evaluators. The ability to analyze multiple behavioral modalities simultaneously, including visual and auditory cues, offers potential advantages over traditional assessment methods. The integration of artificial intelligence with video analysis presents opportunities for developing more efficient and scalable assessment tools. These systems can potentially reduce the time and resources required for individual evaluations while providing detailed insights into behavioral patterns that may not be readily apparent through conventional assessment approaches.

### SUMMARY

The following is a non-exhaustive listing of some aspects of the present techniques. These and other aspects are described in the following disclosure. This summary is not intended to identify key features or essential features of the claimed subject matter, nor is it intended to be used as an aid in determining the scope of the claimed subject matter.

Provided is a process, including: obtaining a video data stream comprising a sequence of image frames and associated audio; extracting a plurality of features from the transformed video data stream; evaluating the plurality of features with respect to a plurality of compliance rules by applying one or more trained machine learning models to detect patterns indicative of potential violations, the trained models configured to capture semantic, contextual, and cross-modal relationships between extracted content and predefined policy constraints; and constructing an output data structure comprising an assessment of whether the video content conforms to the plurality of compliance rules, the output data structure identifying nonconforming segments and providing time-aligned annotations corresponding to the detected nonconformities.

The foregoing general description of the illustrative embodiments and the following detailed description thereof are merely exemplary aspects of the teachings of this disclosure and are not restrictive.

### BRIEF DESCRIPTION OF FIGURES

Non-limiting and non-exhaustive examples are described with reference to the following figures.

FIG. 1 illustrates a block diagram of a computing environment with a video analyzer, according to aspects of the present disclosure.

FIG. 2 illustrates a flowchart of a process to classify video, according to aspects of the present disclosure.

FIG. 3 illustrates a flowchart of a process to pre-process video, according to aspects of the present disclosure.

FIG. 4 is a block diagram of a system for performing automated job search and recruitment using an AI-powered matching pipeline, according to aspects of the present disclosure.

FIG. 5 is a flowchart illustrating a method for automated job search and recruitment, according to aspects of the present disclosure.

FIG. 6 is a block diagram of a system for performing AI-powered video content analysis to assess compliance with organizational policies and applicable legal standards, according to aspects of the present disclosure.

FIG. 7 is a flowchart of a process executed by the system of FIG. 6, according to aspects of the present disclosure.

FIG. 8 illustrates a block diagram of a computer system, according to aspects of the present disclosure.

While the present techniques are susceptible to various modifications and alternative forms, specific embodiments thereof are shown by way of example in the drawings and will herein be described in detail. The drawings may not be to scale. It should be understood, however, that the drawings and detailed description thereto are not intended to limit the present techniques to the particular form disclosed, but to the contrary, the intention is to cover all modifications, equivalents, and alternatives falling within the spirit and scope of the present techniques as defined by the appended claims.

### DETAILED DESCRIPTION

The following description sets forth exemplary aspects of the present disclosure. It should be recognized, however, that such description is not intended as a limitation on the scope of the present disclosure. Rather, the description also encompasses combinations and modifications to those exemplary aspects described herein. To mitigate the problems described herein, the inventors had to both invent solutions and, in some cases just as importantly, recognize problems overlooked (or not yet foreseen) by others in the field of artificial intelligence. Indeed, the inventors wish to emphasize the difficulty of recognizing those problems that are nascent and will become much more apparent in the future should trends in industry continue as the inventors expect. Further, because multiple problems are addressed, it should be understood that some embodiments are problem-specific, and not all embodiments address every problem with traditional systems described herein or provide every benefit described herein. That said, improvements that solve various permutations of these problems are described below.

Headings below delineate aspects that may be used independently (which is not to imply that features described under the same heading may not also be used independently) or together.

### Artificial Intelligence for Video-Based Work Style and Motivator Analysis

Some embodiments address technical challenges in processing video data to extract, analyze, and classify behavioral patterns that may correlate with work styles and motivational factors. The technical challenges associated with automated video-based behavioral analysis encompass multiple domains of computer science and engineering. Video preprocessing operations face difficulties with inconsistent lighting conditions, camera movement artifacts, background noise interference, and varying video quality parameters across different capture devices. Computer vision systems encounter complexities in accurately detecting and tracking facial expressions, body language patterns, and micro-expressions across diverse demographic populations and recording environments. Machine learning models often require sophisticated training methodologies to establish reliable correlations between extracted visual features and behavioral classifications while avoiding overfitting to limited training datasets.

Audio processing components within video analysis systems confront additional technical obstacles, including speech recognition accuracy across different accents and speaking patterns, tone analysis in varying acoustic environments, and synchronization between audio and visual feature extraction processes. The integration of multiple data streams from video, audio, and potentially supplementary sources creates computational challenges related to data fusion, temporal alignment, and multi-channel processing capabilities.

Some video analysis technologies often operate as isolated systems focused on single-domain applications such as facial recognition or speech processing, lacking the integrated approach needed for comprehensive behavioral assessment. These systems typically demonstrate limited adaptability to different video formats, recording conditions, and user interface requirements. Additionally, some approaches may not provide sufficient granularity in feature extraction to capture subtle behavioral indicators that contribute to accurate work style and motivational assessments.

Some embodiments mitigate these challenges through an integrated video analysis architecture that combines advanced preprocessing algorithms, multi-modal feature extraction techniques, and machine learning classification systems. Some embodiments are expected to enhance objectivity in behavioral assessment through automated processing pipelines, improved scalability for handling large volumes of video data, and standardized analysis protocols that may reduce variability in assessment outcomes across different evaluation scenarios.

Many video analysis algorithms are not well suited for the fine-grained types of detection and classification beneficial to use cases described herein. Automated approaches to detect micro-expressions include Feature Difference (FD) Analysis and Peak Detection and Thresholding. FD Analysis often involves calculating the differences between the appearance-based features of sequential video frames within a specified interval. The FD analysis compares the current frame's features with those of an average feature frame (AFF), which represents the average of the features from frames preceding and following the current frame. A rapid change in facial movements results in larger FD values, which are used to identify potential micro-expressions. After FD analysis, peak detection and thresholding may be applied to identify significant peaks, which correspond to the highest intensity frames of rapid facial movements (e.g., micro-expressions). The threshold may be calculated dynamically based on the average and maximum difference values across the video sequence.

These and other existing approaches to detecting micro-expressions (or otherwise inferring latent psychographic attributes of a person in video, such as based on gestures, audio, and the like) are not well suited for video captured by camera-bearing mobile devices, like cell phones, wearables (such as watches or head-mounted displays), tablets, or laptops. Cell phone videos often suffer from lower quality and inconsistent frame rates compared to professional-grade cameras. This variability can make it difficult for FD Analysis to accurately capture the subtle changes associated with things like micro-expressions, which rely on high-resolution, stable footage to detect minute facial movements. Further, cell phone videos are typically recorded in various lighting conditions, which can introduce shadows and changes in facial appearance that are unrelated to genuine facial expressions. FD Analysis might incorrectly interpret these lighting variations as facial movements, leading to false positives. Additionally, cell phone videos often include more motion artifacts, such as shaky camera movements, due to the handheld nature of the devices. This additional movement can interfere with the FD Analysis, which is designed to detect small, subtle facial changes, not large, global movements of the entire frame. In real-world scenarios captured on cell phones, subjects are often not perfectly positioned or facing the camera directly. Variations in angles, distances, and occlusions (like hands or hair partially covering the face) can complicate the accurate tracking of facial features and degrade the performance of FD Analysis in spotting and recognizing micro-expressions. Moreover, the above-mentioned algorithms often do not account for information in other modalities like gestures, tone of voice, word choice, and the like when making inferences, nor do they infer a latent psychographic attribute revealed by detected features. These challenges necessitate more robust algorithms or preprocessing steps to handle the variability inherent in video captured by mobile devices. None of which is to suggest that the above-mentioned techniques are disclaimed or disavowed or that any other approaches for which trade-offs are discussed herein are disclaimed or disavowed.

In some embodiments, a system may be implemented to mitigate the challenges associated with detecting micro-expressions or otherwise inferring latent psychographic attributes from video captured by mobile devices. This system may include a multi-stage processing pipeline designed to address the specific issues often present in such video, including lower quality, inconsistent frame rates, variable lighting conditions, motion artifacts, and non-ideal subject positioning. An example is described with reference to a use case in the field of human resource management and psychology, and more specifically to an AI-powered video analyzer that determines a user's motivators and desired work styles based on video analysis. But it should be emphasized that this system can be used in various other applications, including recruitment, career counseling, educational guidance, therapy, law enforcement, marketing, product evaluation, and the like, where it may be desirable to infer latent psychographic attributes from video.

In addition to these technical advantages, some embodiments are expected to offer several advantages over traditional methods of work style and motivator assessment (which is not to suggest embodiments are limited to systems that provide any or all of these benefits, or that any other description is limiting):
a. Objective Assessment: By analyzing behavior, the system, in some embodiments, offers a more objective assessment compared to self-reported questionnaires, which can be susceptible to bias.
b. Scalability: The AI-powered approach, in some embodiments, allows for automated analysis of a large number of video recordings, saving time and resources.
c. Early Identification: The system, in some embodiments, can be used to identify potential candidates with desired work styles and motivators early in the recruitment process.
d. Enhanced Self-Awareness: The video analysis, in some embodiments, can provide users with valuable insights into their own work style preferences and motivators, aiding in career planning and development.

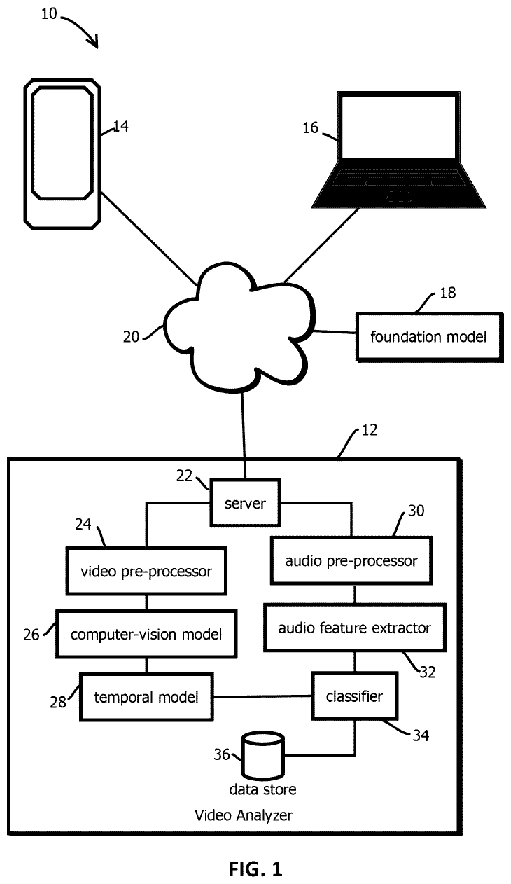

FIG. 1 illustrates a computing environment 10 that provides a distributed architecture for automated video analysis and behavioral assessment through interconnected computing components and network infrastructure. The computing environment 10, in some embodiments, encompasses multiple computing devices and processing systems that collaborate to perform video-based analysis of human behavioral characteristics, work styles, and motivational factors. The computing environment 10 may be configured to handle various types of video input data, process the data through multiple analytical stages, and generate classification results for human resource management applications. In some cases, the computing environment 10 operates across different geographical locations and network configurations to provide scalable video analysis capabilities.

A video analyzer 12 within the computing environment 10, in some embodiments, serves as a processing system for performing automated behavioral analysis operations on video. The video analyzer 12 may be configured to receive video input from multiple sources, apply preprocessing operations to enhance video quality, extract behavioral features through computer vision techniques, and generate classification outputs based on machine learning analysis. The video analyzer 12, in some embodiments, supports various video formats for input processing, allowing the system to accommodate different recording devices and video encoding standards. In some cases, the video analyzer 12 allows users to specify the purpose of the recording such as job application or career assessment, helping the system to apply context-appropriate analysis parameters and classification criteria.

A mobile device 14, in some embodiments, connects to the video analyzer 12 through network communication pathways and provides video capture capabilities for users seeking behavioral assessment services. The mobile device 14 may be a webcam, handheld smartphone, or dedicated camera for video capture, offering flexibility in how users record and submit video content for analysis. The mobile device 14 may include integrated camera systems, microphone arrays, and network communication interfaces that enable high-quality video recording and transmission to the video analyzer 12. In some cases, the mobile device 14 provides real-time video streaming capabilities, allowing users to conduct live or pre-recorded video sessions that are processed immediately or after some delay by the video analyzer 12.

As shown in FIG. 1, a computing device 16, in some embodiments, operates within the computing environment 10 to provide additional user interface capabilities for video analysis operations and interrogate results of the same. In some cases, classifications from analyzer 12 may be presented to an employer, supervisor, recruiter, or employee on device 16, e.g., in a webpage or native application. The computing device 16 may include desktop computers, laptop systems, tablet devices, or other computing platforms that offer enhanced processing power and display capabilities compared to the mobile device 14. The computing device 16, in some embodiments, may serve as an alternative input source for video data or provide administrative interfaces for managing video analysis operations. In some cases, the computing device 16 hosts user interface applications that allow individuals to upload pre-recorded video files, configure analysis parameters, and review assessment results generated by the video analyzer 12.

A foundation model 18, in some embodiments, provides advanced machine learning capabilities to the computing environment 10 through network-accessible artificial intelligence services. The foundation model 18 may include large-scale neural networks trained on diverse datasets to perform natural language processing, computer vision, and multimodal analysis tasks that support the behavioral assessment operations. The foundation model 18 may be hosted on cloud computing platforms and accessed through application programming interfaces that enable the video analyzer 12 to leverage sophisticated AI capabilities without maintaining local copies of large model parameters. In some cases, the foundation model 18 contributes to speech-to-text conversion, language analysis, and contextual understanding of verbal content within submitted video recordings.

The internet 20, in some embodiments, facilitates network communication between the various components of the computing environment 10, providing for data transmission, remote processing coordination, and distributed system operations. The internet 20, in some embodiments, provides the communication infrastructure through which the mobile device 14 and computing device 16 transmit video data to the video analyzer 12, and through which the video analyzer 12 accesses services provided by the foundation model 18. The internet 20 may encompass various network technologies including wireless communication protocols, broadband internet connections, and cloud computing network architectures. The video analyzer 12 allows users to stream video recordings in addition to uploading pre-recorded videos through the internet 20, providing multiple modes of video data submission that accommodate different user preferences and technical requirements.

As further shown in FIG. 1, a server 22 within the video analyzer 12 coordinates the processing operations and manages communication between different analytical components of the system. The server 22 may include multiple processing units, memory systems, and network interfaces that afford concurrent processing of multiple video analysis requests from different users. The server 22, in some embodiments, orchestrates the flow of video data through various processing stages, manages computational resources allocation, and coordinates with external services such as the foundation model 18 to complete comprehensive behavioral assessments. In some cases, the server 22 implements load balancing algorithms to distribute processing tasks across available computational resources and maintain responsive performance levels as the number of concurrent video analysis requests varies throughout different time periods.

A video pre-processor 24 within the video analyzer 12, in some embodiments, performs initial processing operations on incoming video data to prepare the content for subsequent analysis stages. The video pre-processor 24 may apply multiple enhancement techniques to improve video quality and standardize input characteristics across different recording conditions. In some cases, the video pre-processor 24 stabilizes video content to reduce effects of camera movement during capture, particularly for recordings obtained through the mobile device 14. The video pre-processor 24 may normalize lighting conditions across video frames to account for variations in ambient illumination and exposure settings. Additionally, the video pre-processor 24 may enhance contrast levels to improve feature visibility and detail preservation in processed video frames.

In some embodiments, video footage stabilization may involve analyzing successive frames to detect camera motion, followed by applying transformations to correct for the detected motion. One algorithm for stabilizing video footage may involve calculating the optical flow between consecutive frames. Optical flow may be computed by examining the pixel intensity patterns across frames and identifying motion vectors that describe the apparent movement of objects or the camera. In some embodiments, the Lucas-Kanade method may be used to estimate optical flow. This method may assume that the motion of pixels within small neighborhoods is consistent, and it may solve a system of linear equations to calculate the displacement vectors.

Once the optical flow has been estimated, some embodiments may aggregate these vectors to estimate the global camera motion. This global motion estimate may involve averaging the flow vectors or applying techniques such as RANSAC (Random Sample Consensus) to filter outliers that represent local object motion rather than camera movement.

In some embodiments, normalizing lighting conditions in video footage may involve the application of algorithms that adjust the luminance and color balance of individual frames to achieve consistent brightness and color levels across the entire video sequence. One approach may involve analyzing the histogram of pixel intensities for each frame to detect areas of underexposure or overexposure. The algorithm may then apply gamma correction, where the luminance values are adjusted using a non-linear mapping function to bring the pixel intensities within a desired range. This may involve raising or lowering the gamma value depending on whether the image is too dark or too bright, respectively.

In addition, some embodiments may employ histogram equalization. This process may involve redistributing the pixel intensity values to achieve a uniform histogram, where all intensity levels are represented equally across the image. This may be done by calculating the cumulative distribution function (CDF) of the pixel intensities and mapping the original intensity values to new values that correspond to the desired CDF. Histogram equalization may help in improving contrast and ensuring that lighting appears more uniform across different frames.

Another approach that may be used in some embodiments involves the application of a Retinex algorithm, which may be used to enhance images by simulating the human visual system's ability to perceive color and brightness in a way that is invariant to the lighting conditions. The Retinex algorithm may compute the reflectance of surfaces in the image by comparing pixel values with those in their surrounding neighborhood. The algorithm may then adjust the pixel values based on this comparison to achieve a consistent appearance regardless of varying illumination.

Further, in some embodiments, normalization may include color correction techniques that adjust the white balance of the video. This process may involve detecting the color temperature of the light source in each frame and adjusting the RGB (Red, Green, Blue) channels accordingly to ensure that white objects appear white, rather than tinted by the ambient lighting conditions. This may be achieved through algorithms that analyze the average color of pixels assumed to be neutral gray and then applying an inverse transformation to balance the color channels.

In some embodiments, these techniques may be applied in a sequence or in combination to achieve optimal normalization of lighting conditions. The specific parameters used in these algorithms may be dynamically adjusted based on the analysis of each frame, ensuring that the video maintains consistent lighting and color balance across varying conditions.

In some embodiments, removing background noise in video footage may involve a combination of spatial and temporal filtering techniques that identify and reduce unwanted noise while preserving the integrity of the main visual content. Background noise in video may manifest as random variations in pixel intensity or color that can result from low light conditions, sensor limitations, or compression artifacts.

Some embodiments may perform spatial filtering, where each frame of the video is processed to reduce noise. This may include applying a Gaussian blur or median filter (e.g., as a convolution over pixel space), which may smooth the pixel values by averaging them with their neighboring pixels. The Gaussian blur may reduce high-frequency noise by weighing the influence of nearby pixels based on their distance from the center pixel, while the median filter may replace each pixel's value with the median of neighboring pixel values, which is particularly effective at reducing salt-and-pepper noise. These filters may be applied in a way that preserves edges and details by adjusting the kernel size or by using adaptive techniques where the degree of filtering is modulated based on local image characteristics.

In addition to spatial filtering, temporal filtering may also be employed to reduce noise by leveraging the temporal coherence between consecutive frames. Temporal filtering algorithms may compare pixels across multiple frames to distinguish between transient noise and consistent features. Some embodiments may perform frame averaging, where the pixel values in a sequence of frames are averaged to cancel out noise. Another technique may include the use of a Kalman filter, which may predict the value of each pixel in the current frame based on a model of how pixel values evolve over time, and then update this prediction based on the actual observed values, effectively smoothing out fluctuations caused by noise.

In some embodiments, other techniques such as non-local means (NLM) filtering may be used, where the noise reduction algorithm identifies similar patches of pixels within a frame or across adjacent frames. The NLM algorithm may then average these patches to reduce noise, relying on the assumption that similar structures or textures in the image are less likely to contain noise. This method may be particularly effective for reducing noise while preserving details and textures.

In some embodiments, machine learning techniques may be employed for noise reduction. A convolutional neural network (CNN) may be trained on a dataset of clean and noisy video frames, learning to predict the clean frame by identifying and subtracting noise patterns. Once trained, the CNN may be applied to each frame of the video to remove noise. This method may allow for more comprehensive noise reduction that adapts to the specific characteristics of the video content.

In some embodiments, these pre-processing tasks may be further accelerated by leveraging dedicated AI co-processors available on the mobile computing devices. For example, Apple's devices may include a Neural Engine, which is optimized for performing machine learning tasks with low power consumption, while Google Pixel devices may include the Tensor Processing Unit (TPU), designed to accelerate machine learning workloads on the device. These co-processors may handle tasks such as running MobileNet models for video stabilization, lighting normalization, noise reduction, and cropping, allowing the client device to perform complex pre-processing tasks efficiently without heavily impacting battery life or performance. By offloading these tasks to the client device, the server may focus on more resource-intensive operations, such as gesture or facial expression recognition, thereby improving the overall system's performance (which is not to suggest that embodiments are limited to systems that afford this or any other benefit described herein). In some cases, some of the below feature extraction techniques may also be performed by the mobile computing device, with results fed to the server.

These techniques may be used individually or in combination, with parameters dynamically adjusted based on the analysis of the video content, to mitigate background noise while maintaining the clarity and quality of the main visual elements.

A computer-vision model 26, in some embodiments, receives preprocessed video data from the video pre-processor 24 and performs detailed analysis of visual content to extract behavioral features. The computer-vision model 26 may employ convolutional neural networks or vision transformers to analyze facial expressions and body language patterns within video frames. In some cases, the computer-vision model 26 applies filter matrices to pixel subsets at different frame locations to compute feature values. The computer-vision model 26 may apply multiple layers of filter matrices, with output values from initial filtering operations serving as inputs for subsequent matrix operations. The computer-vision model 26 may extract eye gaze patterns through specialized detection algorithms that track pupil movement and viewing direction across video frames. Additionally, the computer-vision model 26 may analyze vocal patterns by processing visual mouth movements to extract information about speech characteristics including pitch variations and fluency patterns.

Model 26 may include a trained convolutional neural network (CNN). The CNN may begin by taking individual video frames or a batch of frames as input. Each frame, represented as a matrix of pixel values, may pass through multiple layers of convolutional filters. These filters, which may be small matrices of weights, slide over the input frame to perform convolutions, producing feature maps. Each convolution operation may involve multiplying the filter values by the corresponding pixel values in the frame, summing the results, and applying a non-linear activation function, such as ReLU (Rectified Linear Unit). This process may allow the CNN to detect low-level features, such as edges, corners, or textures, in the early layers.

As the data progresses through deeper layers of the CNN, the network may combine these low-level features to detect more complex patterns, such as shapes, objects, or motion. Pooling layers may be interspersed between convolutional layers to reduce the spatial dimensions of the feature maps, which may help in reducing computational complexity and capturing the most relevant features. Pooling may involve operations like max pooling, where the maximum value within a defined region of the feature map is selected, or average pooling, where the average value is computed.

In the final layers of the CNN, fully connected layers may aggregate the features learned from all previous layers to make predictions or classifications based on the entire video or frame sequence. The output might be a probability distribution over different classes for classification tasks, bounding box coordinates for object detection, or enhanced frames in the case of video enhancement tasks.

During the training phase, the CNN may be trained on a large dataset of labeled video frames or sequences, where the network learns to adjust the weights of its filters and connections by minimizing a loss function. The loss function quantifies the difference between the network's predictions and the ground truth labels. Optimization techniques like stochastic gradient descent (SGD) with backpropagation may be used to iteratively update the weights, allowing the network to improve its performance on the given task.

Once trained, the CNN may be deployed to process new video data, where it can automatically extract features, recognize patterns, and perform the desired tasks efficiently.

A temporal model 28, in some embodiments, processes sequential data extracted by the computer-vision model 26 to analyze behavioral patterns that develop across multiple video frames. In some cases, models 26 and 28 may be integrated (e.g., trained in the same training run with an objective function used to optimize both concurrently) or trained independently. The temporal model 28 may include a cyclic neural network architecture designed to detect and track facial expressions and gestures that unfold over time. Some embodiments use a long-short term memory model or other recurrent neural network for this purpose. In some cases, the temporal model 28 includes a feed forward neural network incorporating one or more attention heads to focus processing on relevant temporal features. Some embodiments may use a transformer, for example. The temporal model 28 may employ recurrent neural networks specifically configured for analyzing speech patterns and their evolution throughout video recordings. The temporal model 28 may process sequences of feature sets extracted from consecutive video frames (each set belonging to one frame or set of frames in a sequence) to identify micro-expressions, gestures, and tone variations that may indicate underlying motivators and preferred work styles.

For video processing, some embodiments may extend the CNN architecture to handle temporal information by incorporating 3D convolutional layers. These 3D convolutions may operate on a sequence of frames, where the third dimension of the convolutional filter captures temporal features by considering pixel values across multiple frames. This may allow the CNN to learn motion patterns and temporal dynamics in the video.

In some cases, a Recurrent Neural Network (RNN), such as a Long Short-Term Memory (LSTM) network, may be combined with the CNN to better capture temporal dependencies. The CNN may first extract spatial features from individual frames, which are then fed into the RNN (such as a LSTM) to analyze how these features evolve over time, allowing the network to recognize complex temporal patterns in the video.

In some embodiments, a model designed to extract features such as facial expressions from video may involve a combination of CNNs for spatial feature extraction and temporal models for analyzing sequences of frames. The process, in some embodiments, begins with the input video, where each frame is treated as an image containing facial data. The model may first detect and isolate the face within each frame using a face detection algorithm, such as a Multi-task Cascaded Convolutional Network (MTCNN) or a Histogram of Oriented Gradients (HOG) combined with a support vector machine (SVM) classifier.

Once the face is detected, the region containing the face may be passed through a CNN, which may be pre-trained on large-scale facial expression datasets such as AffectNet or FER2013. The CNN may extract spatial features that correspond to different facial landmarks, such as the corners of the mouth, eyes, and eyebrows. These landmarks may be helpful for identifying expressions, as they capture the variations in facial muscle movements. The CNN may apply multiple convolutional layers to detect edges, textures, and shapes associated with different expressions. For example, a smile may be identified by the upward curvature of the mouth and the presence of crow's feet near the eyes, while a frown may be recognized by the downward pull of the mouth corners and the furrowing of the eyebrows.

To account for the temporal dynamics of facial expressions (e.g., how expressions change over time) the model may incorporate a RNN, such as an LSTM network. These networks may be capable of analyzing sequences of feature maps extracted by the CNN from consecutive frames. By examining the evolution of facial landmarks across multiple frames, the RNN may detect more complex expressions that unfold over time, such as a gradual smile or a sudden expression of surprise. Similar approaches maybe applied to gestures by other parts of the body and voice tone and inflection.

In some embodiments, the model may employ attention mechanisms that focus on the most relevant parts of the face for expression analysis. For instance, attention layers may give more weight to the mouth and eye regions when detecting smiles or frowns, while giving less emphasis to other parts of the face that contribute less to the specific expression.

To improve the accuracy of expression recognition, the model may also use data augmentation techniques during training, such as randomly rotating, scaling, or shifting the facial images to make the model more robust to variations in head pose and lighting conditions. Additionally, the model may be fine-tuned on a domain-specific dataset, particularly if the target application involves recognizing expressions in a specific demographic or cultural context, as expressions can vary subtly across different populations.

The output of the model may be a set of probabilities or confidence scores associated with different facial expressions (e.g., happy, sad, angry, surprised), allowing for the classification of the observed expression in each frame or across the entire video segment. In some embodiments, the model may also generate a continuous score reflecting the intensity of the detected expression, which may be useful in applications like mood tracking or emotion-driven user interfaces.

This model, by combining spatial and temporal analysis, may facilitate the effective extraction and recognition of facial expressions from video, providing valuable insights into the emotional states and reactions of individuals.

In some embodiments, certain pre-processing tasks for video captured on a mobile client computing device may be offloaded to the device itself to reduce the computational load on a server, reduce bandwidth, reduce latency, and optimize the overall processing pipeline. These pre-processing tasks may include video stabilization, normalization of lighting conditions, removal of background noise, and cropping to eliminate extraneous background information.

To efficiently perform these tasks on resource-constrained mobile devices, lightweight neural network architectures such as MobileNetV2 or V3 may be employed. Some embodiments may use depthwise separable convolutions to reduce the computational complexity compared to traditional convolutional layers by separating the convolution operation into a depthwise convolution followed by a pointwise convolution. This approach may reduce the number of parameters and the amount of computation involved, making it feasible to run real-time video processing tasks directly on mobile devices.

The process implemented by a CNN may begin with the input, which may be a grid of pixel values representing an image. The first key operation in a CNN may be the convolution, performed by convolutional layers. These layers consist of multiple small filters (also called kernels) that slide, or convolve, over the input image. Each filter may be a small matrix, e.g., 3×3 or 5×5, that is applied to a localized region of the image. The filter multiplies its weights with the corresponding pixel values in the region and sums the results to produce a single output value, known as a feature map or activation map. This process is repeated as the filter moves across the entire image, capturing spatial features such as edges, textures, and simple shapes.

After the convolution operation, the output feature maps may be passed through a non-linear activation function, such as ReLU (Rectified Linear Unit). ReLU replaces all negative values in the feature maps with zero, introducing non-linearity into the model, which allows the CNN to learn more complex patterns.

To reduce the dimensionality of the feature maps and make the model more computationally efficient, pooling layers may be applied after the convolutional layers. Pooling layers may downsample the feature maps by summarizing the information within small regions, e.g., using operations like max pooling or average pooling. In max pooling, for example, the maximum value within a small window, such as 2×2, is selected and used to represent that region in the downsampled map. This may reduce the spatial resolution of the feature maps, while retaining the most significant information.

As the data moves deeper into the CNN, multiple convolutional and pooling layers may be stacked, each layer extracting increasingly abstract and complex features from the input. Early layers may detect simple patterns like edges, while deeper layers may recognize more sophisticated structures, such as parts of objects or even entire objects.

In the final stages of the CNN, the feature maps may be flattened into a one-dimensional vector and passed through one or more fully connected layers. These layers may operate like a (non-convolutional) neural network, where each neuron is connected to every neuron in the previous layer. The fully connected layers may combine the features learned by the convolutional layers to make a final prediction. For example, in an image classification task, the output might be a probability distribution over different classes (e.g., smile, frown, pound the desk with the hands, cover face with hands, etc.), with the class having the highest probability being the predicted label for the image.

During training, the CNN may learn the optimal (e.g., local or global optimum) weights for the filters and fully connected layers by minimizing a loss function, which measures the difference between the predicted output and the true labels. This optimization may be done using backpropagation and gradient descent, where the model iteratively updates its weights to improve accuracy on the training data.

In some embodiments, a Vision Transformer (ViT) may be used in place of a CNN for image or video processing tasks, leveraging the architecture of transformers, which were originally designed for natural language processing, to handle visual data. Unlike CNNs, which may rely on convolutional layers to extract spatial features from images, Vision Transformers may apply a transformer architecture (such as that described in Attention Is All You Need, arXiv:1706.03762, the contents of which are incorporated by reference) that processes images by treating them as sequences of patches.

The process may begin by dividing the input image into a grid of small, non-overlapping patches, e.g., of equal size. Each patch may be then flattened into a one-dimensional vector and linearly embedded into a higher-dimensional space, resulting in a series of patch embeddings. These embeddings are then augmented with positional encodings, which provide the model with information about the spatial location of each patch within the original image, since transformers lack the inherent spatial inductive bias present in CNNs.

Once the patches are embedded and positioned, they may be passed through a transformer architecture, which may consist of multiple layers of self-attention mechanisms and feedforward neural networks. The self-attention mechanism allows the Vision Transformer to model the relationships between different patches by considering the entire sequence of patches simultaneously. This means that the ViT may capture long-range dependencies and global context within the image, which may be challenging for CNNs, particularly those with limited receptive fields.

In each self-attention layer, the model may compute attention scores that determine how much focus each patch should give to every other patch in the image. These scores may be used to create weighted combinations of the patch embeddings, allowing the model to aggregate information from different parts of the image. This ability to model global interactions is particularly useful for tasks that require understanding the overall structure of the image or complex relationships between different regions, such as object detection or image classification.

The transformer layers may be stacked, and the output of the final layer is typically passed through a classification head, where a [CLS] (classification) token, which may be added at the beginning of the sequence of patch embeddings, is used to aggregate the information from all patches. This token may then be fed into a fully connected layer to produce the final output, such as a probability distribution over different image classes.

One of the key advantages of using a Vision Transformer over a CNN is its flexibility in handling global context and its ability to scale with data. While CNNs excel at capturing local patterns through convolutions, Vision Transformers may better understand the relationships across the entire image due to the self-attention mechanism, which considers all patches simultaneously. This global perspective allows ViTs to potentially outperform CNNs, particularly on large datasets where the model can learn complex visual patterns.

However, ViTs may require more data to achieve optimal performance compared to CNNs, as they do not inherently encode spatial hierarchies through convolutions. To mitigate this, ViTs may be pretrained on large datasets and then fine-tuned on specific tasks, similar to how transformers are used in natural language processing.

In some embodiments, skeleton detection in computer vision may be used to detect and interpret human gestures by identifying and tracking the key points or joints of a person's body in video frames. Skeleton detection involves extracting a simplified, skeletal representation of the human body, typically consisting of nodes representing joints (e.g., wrists, elbows, shoulders, knees) and edges representing the connections between these joints (e.g., limbs). Or some embodiments may use optical flow, such as CoTracker available from Meta Inc, described in CoTracker: It is Better to Track Together, arXiv:2307.07635, the contents of which are hereby incorporated by reference.

The process may begin with the application of a CNN or another deep learning model trained to recognize and localize key points on the human body within an image or video frame. The CNN may process the input image to generate heatmaps for each joint, where each heatmap corresponds to the probability distribution of the location of a specific joint. The peak value in each heatmap may indicate the most likely position of the corresponding joint in the frame.

In some embodiments, a pose estimation model, such as OpenPose™, PoseNet, or the newer BlazePose™, may be utilized. These models may take an input image and output the coordinates of key body joints by first detecting the person's presence and then estimating the positions of joints based on learned patterns from large datasets of labeled images. The pose estimation model may output a set of 2D or 3D coordinates that represent the skeleton of the person in the image.

After detecting the joints, the model may construct a skeleton by connecting the detected joints based on a predefined human body topology. For example, the wrist joint may be connected to the elbow joint, and the elbow to the shoulder, forming a limb. The skeleton representation simplifies the complex shape of the human body into a set of points and lines, making it easier to analyze body posture and movements.

Once the skeleton is detected, gesture recognition may be performed by analyzing the relative positions and movements of the joints over time. The system may track changes in the angles formed by connected joints, the trajectory of specific joints, or the relative distances between different parts of the body. For example, raising both arms above the head may be recognized as a “hands-up” gesture, while waving may be detected by tracking the oscillatory motion of the hand joint relative to the shoulder.

In some embodiments, temporal models such as RNNs networks may be integrated with skeleton detection to recognize more complex gestures that involve sequences of movements. These models may analyze the time-series data of joint coordinates to detect patterns indicative of specific gestures, such as clapping, pointing, or dancing.

For 3D skeleton detection, depth cameras or stereo vision systems may be used to capture the depth information in addition to the 2D image data. This allows the system to generate a 3D skeleton, providing more accurate detection of gestures that involve movements towards or away from the camera.

In some embodiments, skeleton detection may also incorporate attention mechanisms or ensemble methods that focus on the most informative joints for specific gestures. For instance, hand gestures may be detected by giving more weight to the movements of the hands and fingers, while ignoring less relevant joint movements.

In some embodiments, the RNNs described herein process sequential data by maintaining a form of memory that captures dependencies and patterns over time. Unlike traditional neural networks that treat each input independently, RNNs may handle sequences where the order of inputs is significant, making them particularly useful for tasks such as language modeling, time series prediction, and speech recognition.

The RNN may include recurrent layers, which processes input data one element at a time, while maintaining a hidden state that carries information from previous elements in the sequence. As each element of the sequence is processed, the RNN may take both the current input and the hidden state from the previous step, processes them together, and produces both an output and an updated hidden state. This step-by-step process may allow the network to build an understanding of the sequence, taking into account what has come before.

The hidden state, in some embodiments, acts as the memory of the RNN, retaining information across the sequence and enabling the network to recognize dependencies in the data. For example, in a sentence, the meaning of a word may depend on the words that came before it. The RNN's hidden state may help capture this context, allowing the network to consider the entire sequence rather than just the current input.

One challenge with RNNs is their difficulty in learning long-term dependencies, where information from far earlier in the sequence influences later outputs. This difficulty often arises due to issues with gradient calculations during training, which can lead to problems known as vanishing or exploding gradients. To mitigate these issues, more advanced variants of RNNs, such as LSTM networks and Gated Recurrent Units (GRUs) may be used.

LSTM networks introduce a more complex memory cell that, in some embodiments, learns when to retain or forget information as it processes the sequence. This is managed by mechanisms called gates—input, forget, and output gates—that control the flow of information. The input gate, in some embodiments, determines how much of the new input should influence the memory, the forget gate decides which part of the memory to retain, and the output gate, in some embodiments, determines what the final output and updated hidden state should be. These gates may help the LSTM maintain relevant information over long sequences, helping it to handle long-term dependencies effectively.

GRUs, on the other hand, simplify the LSTM structure by using fewer gates. They, in some embodiments, combine the input and forget gates into a single update gate and use a reset gate to manage the influence of the previous hidden state. This makes GRUs more computationally efficient while still capable of capturing long-term dependencies.

In some embodiments, contrastive methods may be employed to detect and distinguish among gestures, tone, inflection, and facial expressions in video by focusing on the creation and comparison of feature representations of video frames. Initially, each video frame or sequence of frames may be processed to generate feature vectors that capture relevant spatial and temporal characteristics of the gestures, tone, inflection, or facial expressions. These feature vectors may be used within a contrastive learning framework, where the relationships between pairs or triplets of these vectors are analyzed.

In some embodiments, during the contrastive learning process, the system may consider pairs of feature vectors that represent either similar (positive) or dissimilar (negative) examples. A contrastive loss function may be applied to ensure that the distance between vectors representing similar gestures or expressions is minimized, while the distance between vectors representing dissimilar ones is maximized. For instance, using a contrastive loss such as triplet loss, the system may be provided with an anchor feature vector, a positive feature vector (corresponding to the same gesture or expression as the anchor), and a negative feature vector (corresponding to a different gesture or expression). The learning objective may be to decrease the distance between the anchor and positive vectors while increasing the distance between the anchor and negative vectors.

In other embodiments, contrastive learning may be enhanced by using data augmentation techniques, which generate variations of the same gesture or facial expression through transformations such as rotation, scaling, or changes in lighting. These augmented examples may serve as positive pairs in the contrastive learning process, refining the system's ability to discern subtle differences in gestures or expressions. Additionally, the processing of temporal sequences of video frames may be incorporated to capture dynamic aspects of gestures and expressions, which may be helpful for accurately distinguishing between them.

The result of this contrastive learning process may be a set of discriminative embeddings that effectively represent different gestures or facial expressions in a lower-dimensional space. These embeddings may then be processed by additional components, such as a classifier or a clustering algorithm, to identify and label the specific gestures or expressions present in the video. In some embodiments, a feedback mechanism may be included, where misclassified gestures or expressions are reintroduced into the contrastive learning process to further enhance the system's ability to distinguish between similar but distinct gestures or expressions.

In some embodiments, Joint Embedding Predictive Architectures (JEPAs) may be used to infer latent psychographic attributes of a person appearing in video by learning a shared representation between video frames and auxiliary data that are predictive of psychological traits, behaviors, or preferences. These architectures may involve the use of two or more neural networks that are trained together to produce embeddings—vector representations of input data—where the embeddings are designed to capture high-level semantic information.

The JEPA framework may begin by processing the video data through a CNN or a similar feature extractor to generate an initial embedding that captures the visual and temporal patterns related to the person in the video. These patterns may include facial expressions, body language, gaze direction, and other non-verbal cues that are indicative of underlying psychographic attributes such as personality traits, emotional states, or preferences.

Concurrently, another network may process auxiliary data that are potentially related to the person's psychographic profile. This auxiliary data may include text data from social media posts, audio data from speech, or demographic information, which can be transformed into embeddings through the use of language models (e.g., transformers for text) or other specialized neural networks for non-visual data. The embeddings generated from this auxiliary data may capture aspects such as linguistic style, tone of voice, or social context, which may correlate with specific psychographic traits.

The JEPA model may align these embeddings in a joint latent space where the proximity between the embeddings reflects their semantic similarity. For example, the architecture may employ contrastive loss functions that encourage embeddings from related data (e.g., a video frame of a smiling person and their positive social media post) to be closer in the latent space, while pushing unrelated embeddings apart. Through this training process, the JEPA may learn to encode both visual and auxiliary data into a common space that effectively captures latent psychographic attributes.

Once trained, the JEPA may infer latent psychographic attributes by projecting new video data into this joint latent space and comparing the resulting embeddings with known psychographic profiles. For example, if the embedding of a video segment closely matches the embedding of data associated with a known psychographic trait (e.g., high extraversion or a preference for certain products), the architecture may predict that the person in the video possesses that attribute.

Furthermore, the JEPA may be extended to perform these inferences continuously as the video progresses, allowing the model to update its predictions based on changing visual cues and contextual information. This dynamic capability may be particularly useful in capturing temporal aspects of psychographic traits, such as mood fluctuations or changes in behavior in different contexts.

In some embodiments, the architecture may also incorporate attention mechanisms that focus on the most relevant parts of the video (e.g., facial expressions during emotional peaks or specific gestures) and the auxiliary data, further refining the embeddings and improving the accuracy of psychographic inference. The JEPA may also be designed to incorporate feedback loops where the predicted psychographic attributes are used to fine-tune the embedding process, enhancing the model's ability to learn from new data.

As shown in FIG. 1, the video pre-processor 24, computer-vision model 26, and temporal model 28 may operate as an integrated processing pipeline within the video analyzer 12. The server 22 may coordinate data flow between these components, managing the progression of video content from initial preprocessing through feature extraction and temporal analysis. In some cases, the computer-vision model 26 generates feature sequences that feed directly into the temporal model 28 for continuous processing of behavioral patterns. The foundation model 18 may provide supplementary processing capabilities to enhance the operation of both the computer-vision model 26 and temporal model 28 through advanced machine learning techniques accessed via the internet 20.

An audio pre-processor 30, in some embodiments, operates within the video analyzer 12 to process audio content extracted from video recordings submitted through the mobile device 14 or computing device 16. The audio pre-processor 30 may receive audio data streams that accompany video content and apply various enhancement techniques to improve audio quality for subsequent analysis operations. The audio pre-processor 30 may remove background noise from audio tracks to isolate speech content and reduce interference from environmental sounds that could affect feature extraction accuracy. In some cases, the audio pre-processor 30 applies noise reduction algorithms that identify and filter out consistent background frequencies while preserving speech characteristics. The audio pre-processor 30 may normalize audio volume levels across different recording conditions to ensure consistent processing parameters regardless of microphone sensitivity or recording distance variations.

The audio pre-processor 30 may synchronize audio content with corresponding video frames processed by the computer-vision model 26 to maintain temporal alignment between visual and auditory features. In some cases, the audio pre-processor 30 segments continuous audio streams into discrete time intervals that correspond to video frame sequences analyzed by the temporal model 28. The audio pre-processor 30 may apply filtering operations to enhance speech clarity and reduce artifacts introduced during video compression or transmission through the internet 20. Additionally, the audio pre-processor 30 may convert audio data between different sampling rates and encoding formats to standardize input characteristics for downstream processing components.

As shown in FIG. 1, an audio feature extractor 32, in some embodiments, receives processed audio data from the audio pre-processor 30 and performs detailed analysis to extract speech characteristics and vocal patterns from recorded content. The audio feature extractor 32 may implement speech-to-text conversion algorithms that transform spoken words into natural language text for linguistic analysis. In some cases, the audio feature extractor 32 utilizes speech recognition models that can accommodate various accents, speaking speeds, and pronunciation patterns encountered in video submissions from different users. The audio feature extractor 32 may extract natural language text uttered in audio content and provide this textual data to classification systems for content analysis. The audio feature extractor 32 may access processing capabilities provided by the foundation model 18 to enhance speech recognition accuracy through advanced machine learning techniques.

The audio feature extractor 32 may analyze vocal tone characteristics through specialized speech models that detect emotional indicators and speaking patterns within audio content. In some cases, the audio feature extractor 32 identifies pitch variations, speaking rhythm, and vocal stress patterns that may correlate with different motivational factors and work style preferences. The audio feature extractor 32 may extract prosodic features including intonation patterns, pause durations, and speech rate variations that provide additional behavioral indicators beyond visual analysis performed by the computer-vision model 26. The audio feature extractor 32 may detect tone variations in speech that indicate confidence levels, enthusiasm, or other emotional states relevant to behavioral assessment applications. Additionally, the audio feature extractor 32 may analyze fluency patterns and speech hesitations that could provide insights into communication styles and personality characteristics.

In some embodiments, an algorithm to detect vocal patterns, such as pitch, tone, and fluency, may involve several stages of signal processing and feature extraction, followed by classification or analysis using machine learning techniques. The process may begin with the collection of raw audio data, which is typically represented as a time-domain signal sampled at a certain frequency. The first step may involve preprocessing the audio signal to remove noise and normalize the amplitude. This may include applying a high-pass filter to eliminate low-frequency noise or using a denoising algorithm such as spectral subtraction to enhance the clarity of the vocal signal.

To detect pitch, the algorithm may employ techniques such as autocorrelation or the Fast Fourier Transform (FFT). In the autocorrelation method, the algorithm may compare the audio signal with a delayed version of itself to identify periodicity, which corresponds to the fundamental frequency or pitch. The algorithm calculates the autocorrelation function over short segments of the signal, often referred to as frames, and the time lag at which the autocorrelation function reaches a peak indicates the period of the fundamental frequency. The pitch, in some embodiments, is then determined as the inverse of this period. Alternatively, the FFT may be used to convert the time-domain signal into the frequency domain, where the dominant frequency component corresponds to the pitch. The algorithm may analyze the peaks in the frequency spectrum to identify the fundamental frequency, which represents the pitch of the voice.

Tone detection may involve analyzing the spectral content and the harmonic structure of the voice signal. The algorithm may perform a Short-Time Fourier Transform (STFT) to break down the signal into overlapping time windows, allowing for the examination of how the frequency components evolve over time. By analyzing the distribution and intensity of frequencies within each window, the algorithm may infer the tone quality. For example, a warmer tone may have more energy in the lower frequency bands, while a brighter tone may have more energy in the higher frequency bands. The algorithm may also compute Mel-Frequency Cepstral Coefficients (MFCCs), which are a representation of the short-term power spectrum of a sound, to capture the timbral characteristics of the voice. MFCCs may be derived by applying a filter bank spaced according to the Mel scale, which approximates the human car's response. These coefficients can be used to characterize the tone or timbre of the voice.

Fluency detection may focus on temporal patterns in the speech signal, such as the rate of speech, pauses, and rhythm. The algorithm may first segment the speech by detecting periods of vocal activity versus silence or pauses, using Voice Activity Detection (VAD) techniques based on energy thresholds, zero-crossing rate, or machine learning models that classify frames as speech or non-speech. To analyze fluency, the algorithm may extract prosodic features, including speaking rate (syllables or words per second), pause duration, and speech rhythm. Speaking rate may be determined by counting the number of syllables or words in a given time frame, while pauses can be identified as segments of the signal with little to no vocal activity. The algorithm may apply dynamic time warping (DTW) or Hidden Markov Models (HMMs) to model the temporal sequence of speech features, allowing it to detect patterns associated with fluent or disfluent speech. For instance, frequent pauses, repetitions, or prolongations of sounds may indicate disfluency.

After extracting features related to pitch, tone, and fluency, the algorithm may use machine learning models to classify or interpret these vocal patterns. The extracted features may be fed into classifiers such as Support Vector Machines (SVMs), Random Forests, or neural networks that have been trained on labeled datasets to recognize specific vocal patterns or attributes. For example, the model may classify the overall tone as “neutral,” “happy,” or “angry,” based on the spectral features and MFCCs. Techniques such as Principal Component Analysis (PCA) or t-Distributed Stochastic Neighbor Embedding (t-SNE) may be used to visualize or cluster the vocal patterns into distinct groups, which can aid in identifying correlations between different vocal attributes. This algorithmic approach may facilitate the detection and analysis of various vocal patterns, facilitating applications in emotion recognition, speaker profiling, and speech therapy. The combination of signal processing and machine learning techniques allows for the robust characterization of vocal attributes in real time or from recorded audio.

As further shown in FIG. 1, the audio pre-processor 30 and audio feature extractor 32 operate as complementary components within the video analyzer 12 processing pipeline. The server 22 may coordinate data flow between these audio processing components and the visual analysis pathway comprising the computer-vision model 26 and temporal model 28. In some cases, the audio feature extractor 32 generates feature vectors that combine with visual features to provide comprehensive behavioral analysis capabilities. The audio processing pathway may operate concurrently with video processing operations to maximize computational efficiency and reduce overall analysis time for submitted recordings. The foundation model 18 may provide enhanced natural language processing capabilities that support both speech-to-text conversion and semantic analysis of extracted textual content.

A classifier 34 within the video analyzer 12, in some embodiments, receives processed data from both the temporal model 28 and the audio feature extractor 32 to perform comprehensive behavioral analysis and generate classification outputs for submitted video recordings. The classifier 34 may integrate visual features extracted through the computer-vision model 26 and temporal model 28 with audio characteristics processed by the audio feature extractor 32 to create multi-modal feature representations that capture both verbal and non-verbal behavioral indicators. In some cases, the classifier 34 applies machine learning algorithms trained on datasets of labeled video recordings with known user work styles and motivators to establish correlations between extracted features and behavioral classifications. The classifier 34 may utilize neural network architectures that process combined feature vectors from multiple input sources to generate probability distributions across different classification categories.

The classifier 34 may categorize work styles into specific types including collaborative, independent, and detail-oriented classifications based on behavioral patterns detected in video content. In some cases, the classifier 34 analyzes communication patterns, body language characteristics, and vocal tone variations to determine whether individuals demonstrate preferences for team-based collaboration, autonomous work environments, or methodical attention to specific tasks. The classifier 34 may identify specific motivator types including financial security, growth opportunities, and work-life balance through analysis of speech content, facial expressions, and gesture patterns that indicate underlying value systems and career priorities. The classifier 34 may process natural language text extracted by the audio feature extractor 32 to identify keywords and phrases that correlate with different motivational factors, while simultaneously analyzing visual cues that support or contradict verbal statements.

As shown in FIG. 1, the classifier 34 may generate classification outputs that designate individuals as suitable or unsuitable for hiring based on alignment between detected behavioral characteristics and predetermined job requirements. The classifier 34 may compare extracted work style and motivator profiles against target criteria established for specific positions or organizational cultures to produce compatibility scores and recommendations. In some cases, the classifier 34 processes both work style preferences and motivational factors simultaneously to create comprehensive behavioral profiles that encompass multiple dimensions of individual characteristics. The classifier 34 may access processing capabilities provided by the foundation model 18 through the internet 20 to enhance classification accuracy through advanced natural language understanding and contextual analysis of video content.

The classifier 34 may generate classification data that supports preparation of career plans or development plans for individuals based on identified behavioral characteristics and motivational factors. In some cases, outputs may be placed in context of the foundation model 18 with a prompt and other data, like resumes, reviews, ratings, work history, survey results, and the like, to generate a career plan or hiring recommendation. In some cases, the classifier 34 provides classification indicators to language models that utilize behavioral assessment results as contextual information for generating personalized career guidance and professional development recommendations. The classifier 34 may produce structured output data that includes confidence scores, alternative classification possibilities, and detailed feature analysis results that support downstream applications in human resource management and career counseling. The classifier 34 may coordinate with the server 22 to manage computational resources and processing queues when handling multiple concurrent video analysis requests from different users accessing the system through the mobile device 14 or computing device 16.

In some embodiments, classifier 34 may ingest temporally aligned outputs from the visual pathway and the audio pathway and form a multi-modal feature representation per recording segment. The visual pathway may provide per-frame or per-clip embeddings from a computer-vision model and an associated temporal model, while the audio pathway may provide prosodic, paralinguistic, and automatic speech recognition text features. The classifier may be trained on labeled video recordings annotated with known work styles and motivators and may output a probability distribution or confidence scores over predefined label sets for work style and motivator categories.

In some embodiments, the classifier 34 may operate over fixed or adaptive temporal windows. Each window may be represented by a fused vector constructed by concatenating or otherwise combining: a visual embedding sequence pooled by attention across frames, an audio-prosody vector comprising pitch-range statistics, pause patterns, and speaking-rate features, and a text embedding derived from window-localized transcripts. The classifier may apply a gating unit that computes scalar weights for each modality conditioned on window context and recording-level metadata; the gated vectors may then be summed to yield a fused window embedding. A segment-level head may produce per-window scores for each work-style and motivator label, and a recording-level head may aggregate segment scores using learnable attention weights to produce final label scores.

In some embodiments, the following pseudocode-level procedure may be used. Inputs may include a sequence of visual embeddings V\[1 . . . . T], audio embeddings A\[1 . . . . T], and tokenized transcript spans W\[1 . . . . T], where indices denote aligned windows. The procedure may compute, for each t, a visual summary v\_t using attention over frames in the window; compute an audio summary a\_t from prosodic features and learned projections; compute a text summary w\_t from a language encoder applied to the transcript span; compute modality gates g\_t via a small network that takes \[v\_t, a\_t, w\_t] and outputs three non-negative weights that sum to one; compute a fused embedding z\_t as g\_t\hat{ }v·v\_t+g\_t\hat{ }a·a\_t+g\_t\hat{ }w·w\_t; compute per-label window scores s\_t via a feed-forward network; aggregate {s\_t} across t using attention weights α\_t that may depend on z\_t and on a learned query vector per label; and output final label scores y by a normalization function applied to the attention-weighted sum of window scores. The classifier may then threshold y with label-specific thresholds that may be calibrated from validation data to control precision/recall tradeoffs, and may emit labels whose scores exceed thresholds together with calibrated confidence values.

In some embodiments, contradictions between verbal content and non-verbal cues may be explicitly modeled. The classifier may compute a consistency feature c\_t by comparing sentiment or semantic intent derived from the text span with affect estimates from facial expression and prosody for the same window; the fused embedding may be augmented with c\_t so that the model can learn patterns where divergence between what is said and how it is said correlates with particular motivators or work styles.

In some embodiments, alternative classifier architectures may be used. A multilayer neural network with normalization and dropout may be trained with a cross-entropy objective for multi-class work-style prediction and a multi-label objective for motivators. A hierarchical arrangement may first assign a coarse work-style family and then refine to subtypes in a second head. Other embodiments may employ gradient-boosted decision trees trained on engineered features such as gesture rates, eye-gaze dispersion, and turn-taking metrics; margin-based methods such as support vector machines may also be used over fixed-length fused embeddings. The training dataset may comprise labeled recordings with both work-style and motivator annotations as described, and the classifier may learn the correlations between extracted patterns and the targeted categories.

In some embodiments, the classifier may generate structured outputs comprising the assigned labels, per-label confidence scores, alternative label hypotheses, and fine-grained feature attributions at the segment level. These outputs may be consumed by downstream modules to prepare reports and, when configured, to compare the derived profile against target criteria for roles to compute compatibility scores or binary hiring recommendations.

In some embodiments, the post-processing pipeline may include probability calibration and business-rule constraints. Calibration may be performed by learning a temperature parameter or by fitting isotonic or Platt mappings on a held-out set. Business rules may cap or defer low-confidence assignments, require agreement between multiple segments for a label to be accepted, or incorporate auxiliary information such as survey responses or resumes supplied to the system so that the final classification reflects both inferred behavior and supplied context.

In some embodiments, when transcripts are available, the classifier may incorporate lexical triggers and phrasal patterns extracted from the audio feature extractor's speech-to-text output and may also include tone-derived features such as mean pitch, pitch range, jitter, shimmer, pause statistics, and syllables-per-second. The classification may therefore be based at least in part on audio, including both the extracted natural-language text and the detected tone of speech.

The analyzer 12, in some embodiments, may interpret the results from the AI analysis module and generate a report that categorizes the user's work style based on the observed behavioral patterns. The report may also identify the user's primary motivators based on their communication style and the emphasis placed on certain aspects during the video recording.

In some embodiments, the video described herein may be encoded in a variety of different formats, each characterized by specific data structures and processing techniques. Monocular video may consist of a sequence of two-dimensional (2D) frames captured by a single camera, where each frame may represent a discrete moment in time and may be encoded using various compression algorithms, such as H.264 or H.265, to reduce storage and transmission requirements. Stereoscopic video may involve two separate video streams captured simultaneously from slightly different perspectives, corresponding to the left and right eyes, respectively. These streams may be synchronized to preserve the temporal correlation between corresponding frames and may be combined to produce a perception of depth when viewed through appropriate stereoscopic display devices or processed by suitable software algorithms.

Light field video may be characterized by its ability to capture not only the intensity and color of light rays but also their directional information. This format may involve capturing a large number of views of the scene from different angles, which may then be used to reconstruct images from new viewpoints or adjust the focus post-capture. The data may be stored in a multidimensional array, often referred to as a light field, which may include multiple images representing the scene from slightly varying perspectives. In some embodiments, computational techniques, such as depth estimation algorithms or synthetic aperture adjustments, may be applied to manipulate the captured light field data.

Video with depth information may be captured using a depth camera, such as a time-of-flight (ToF) sensor or a structured light camera. This format may involve capturing both 2D color frames and corresponding depth maps, where each pixel in the depth map may represent the distance from the camera to the scene surface at that point. The depth data may be encoded as a separate channel or interleaved with the color information in a single video stream. In some embodiments, this depth information may be used in conjunction with the color data to create three-dimensional (3D) representations of the scene, perform object segmentation, or enable augmented reality (AR) applications.

In other embodiments, video formats may include variations or combinations of the aforementioned formats, such as multi-view stereo video, where multiple cameras capture video from different angles, and the data is processed to create a more comprehensive 3D model of the scene. Additional formats may include volumetric video, where the video data represents a 3D volume of space rather than a 2D plane, allowing viewers to move around within the captured scene. Each format may be processed and manipulated using various algorithms depending on the desired output, such as rendering for different display types, extraction of specific features, or real-time interaction with the video content.

As further shown in FIG. 1, a data store 36 within the video analyzer 12 maintains classification results generated by the classifier 34 and provides persistent storage capabilities for behavioral assessment data. The data store 36 may store classification outputs in structured database formats that enable efficient retrieval and analysis of assessment results across different time periods and user populations. In some cases, the data store 36 maintains separate storage partitions for different types of classification data, including work style categories, motivational factor assessments, and supplementary metadata associated with video processing operations. The data store 36 may implement data indexing and search capabilities that allow rapid access to stored classification results based on various query parameters such as assessment dates, user identifiers, or specific behavioral characteristics.

The data store 36 may maintain historical records of classification results that afford longitudinal analysis of behavioral patterns and assessment accuracy over extended time periods. In some cases, these records may be augmented with ground truth hiring or career results for assessed individuals, and those augmented records may be used for training the various models described, particularly the classifier 34. In some cases, the data store 36 stores training data used by the classifier 34, including labeled video recordings and corresponding behavioral assessments that support machine learning model development and refinement. The data store 36 may implement data backup and replication mechanisms to ensure classification results remain accessible despite hardware failures or system maintenance operations. The data store 36 may coordinate with the server 22 to manage data access permissions and ensure that stored classification results are available to authorized applications and user interfaces within the video analyzer 12.

The video analyzer 12 may include a user interface that offers an intuitive interface for users to upload videos and view analysis results generated by the classifier 34 and stored in the data store 36. The user interface may provide features for customizing analysis settings that influence how the classifier 34 processes video content and generates behavioral assessments. In some cases, the user interface allows individuals to specify analysis parameters such as assessment focus areas, classification sensitivity levels, or reporting detail preferences that modify classifier 34 operations. The user interface may access stored classification data from the data store 36 to present assessment results in various formats including graphical visualizations, detailed text reports, and comparative analysis displays that highlight different aspects of behavioral characteristics.

The video analyzer 12 may generate detailed reports that can be viewed through the user interface and present comprehensive analysis results based on classification outputs stored in the data store 36. In some cases, the detailed reports include work style categorizations, motivational factor assessments, confidence scores, and recommendations for career development or hiring decisions based on classifier 34 analysis results. The user interface may provide interactive features that allow users to explore different aspects of their behavioral assessments, compare results across multiple video submissions, or access historical classification data maintained in the data store 36. The user interface may coordinate with the foundation model 18 to provide enhanced report generation capabilities that incorporate natural language explanations and contextual guidance based on classification results produced by the classifier 34.

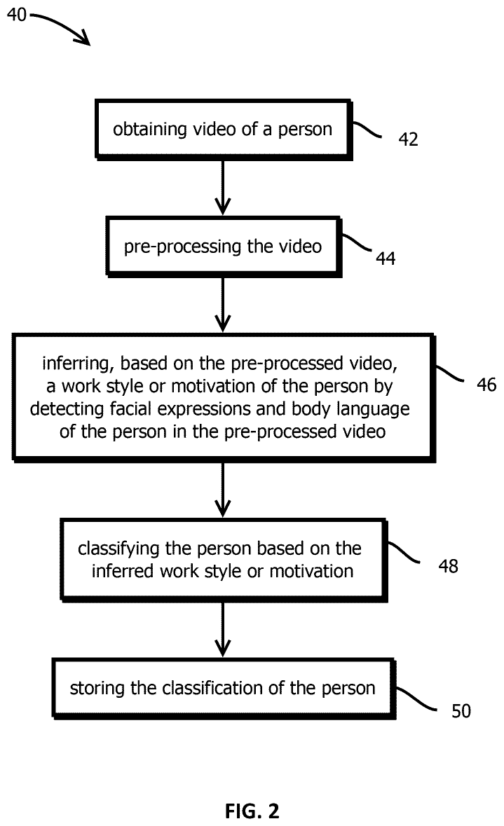

FIG. 2 is a flowchart of a process 40 to classify video, which provides a systematic methodology for analyzing video recordings to determine behavioral characteristics and generate classification outputs, e.g., within the computing environment 10. The process to classify video 40 may be executed by the video analyzer 12 through coordinated operations of the server 22, computer-vision model 26, temporal model 28, audio feature extractor 32, and classifier 34. The process to classify video 40, in some embodiments, encompasses multiple sequential operations that transform raw video input into structured behavioral assessments suitable for human resource management applications. In some cases, the process to classify video 40 processes video content submitted through the mobile device 14 or computing device 16 via the internet 20. The process to classify video 40 may accommodate various video formats and recording conditions while maintaining consistent analysis protocols across different input sources.

The process to classify video 40, in some embodiments, initiates with a step 42 that involves obtaining video of a person through various capture mechanisms and input pathways. The step 42 may receive video content directly from the mobile device 14 during real-time recording sessions or through uploaded files transmitted via the internet 20 to the video analyzer 12. In some cases, the step 42 accommodates video recordings captured during job interviews, career assessment sessions, or self-evaluation presentations where individuals discuss professional topics and demonstrate natural behavioral patterns. The step 42 may coordinate with the server 22 to manage incoming video data streams and establish processing queues for multiple concurrent analysis requests. The step 42 may validate video format compatibility and assess recording quality parameters to determine whether submitted content meets minimum requirements for subsequent analysis operations.

Following video acquisition, the process to classify video 40, in some embodiments, advances to a step 44 that encompasses pre-processing operations applied to received video content. The step 44 may invoke processing capabilities provided by the video pre-processor 24 to enhance video quality and standardize input characteristics across different recording conditions. In some cases, the step 44 pre-processes video from a mobile computing device camera that address specific challenges associated with handheld recording devices, including camera movement artifacts and variable lighting conditions. The step 44 may apply stabilization algorithms to reduce effects of camera shake and movement during video capture, particularly for recordings obtained through portable devices. The step 44 may normalize lighting conditions across video frames to account for variations in ambient illumination and exposure settings that could affect feature extraction accuracy. Additionally, the step 44 may enhance contrast levels and remove background noise from audio tracks to improve overall content quality for downstream analysis operations.

As shown in FIG. 2, the process to classify video 40, in some embodiments, proceeds to a step 46 that performs behavioral analysis through computer vision techniques and machine learning algorithms. The step 46 may utilize processing capabilities provided by the computer-vision model 26 and temporal model 28 to extract and analyze visual features from preprocessed video content. In some cases, the step 46 infers the work style or motivation through detection of facial expressions, body language patterns, and micro-expressions that may correlate with underlying behavioral characteristics. The step 46 may analyze sequences of video frames to identify temporal patterns in facial expressions and gestures that unfold over multiple time intervals. The step 46 may coordinate with the audio feature extractor 32 to incorporate vocal tone analysis and speech pattern recognition into the behavioral inference process. The step 46 may access advanced processing capabilities provided by the foundation model 18 to enhance feature extraction accuracy and support complex pattern recognition tasks that exceed local computational resources.

The process to classify video 40, in some embodiments, continues with a step 48 that generates behavioral classifications based on features and patterns identified during the inference operations. The step 48 may invoke processing capabilities provided by the classifier 34 to transform extracted behavioral features into structured classification outputs that categorize work styles and motivational factors. In some cases, the step 48 applies machine learning algorithms trained on datasets of labeled video recordings with known behavioral characteristics to establish correlations between detected patterns and classification categories. The step 48 may generate work style classifications including collaborative, independent, and detail-oriented categories based on communication patterns, body language characteristics, and vocal tone variations observed in video content. The step 48 may identify motivational factors including financial security, growth opportunities, and work-life balance through analysis of speech content and non-verbal behavioral indicators. The step 48 may produce classification outputs that include confidence scores and alternative classification possibilities to support decision-making processes in human resource applications.

As further shown in FIG. 2, the process to classify video 40 concludes with a step 50 that manages persistent storage of classification results generated through the analysis operations. The step 50 may coordinate with the data store 36 to maintain classification outputs in structured database formats that enable efficient retrieval and subsequent analysis of behavioral assessment results. In some cases, the step 50 stores classification data alongside metadata that includes processing timestamps, confidence scores, and feature analysis details that support audit trails and result validation procedures. The step 50 may implement data indexing mechanisms that facilitate rapid access to stored classification results based on various query parameters such as user identifiers, assessment dates, or specific behavioral characteristics. The step 50 may coordinate with user interface components to make stored classification results available for report generation and visualization applications that present assessment outcomes to end users. The step 50 may establish data retention policies and backup procedures that ensure classification results remain accessible for extended time periods while maintaining data security and privacy protections.

The process to classify video 40 may execute these sequential operations through coordinated interactions between multiple components of the video analyzer 12, with the server 22 managing computational resource allocation and data flow coordination throughout the analysis pipeline. In some cases, the process to classify video 40 processes multiple video submissions concurrently through parallel execution pathways that maximize computational efficiency while maintaining consistent analysis quality across different processing requests. The process to classify video 40 may adapt processing parameters based on video content characteristics and user-specified analysis preferences to optimize classification accuracy for different application contexts. The process to classify video 40 may generate detailed processing logs and performance metrics that support system monitoring and continuous improvement of analysis capabilities within the computing environment 10.

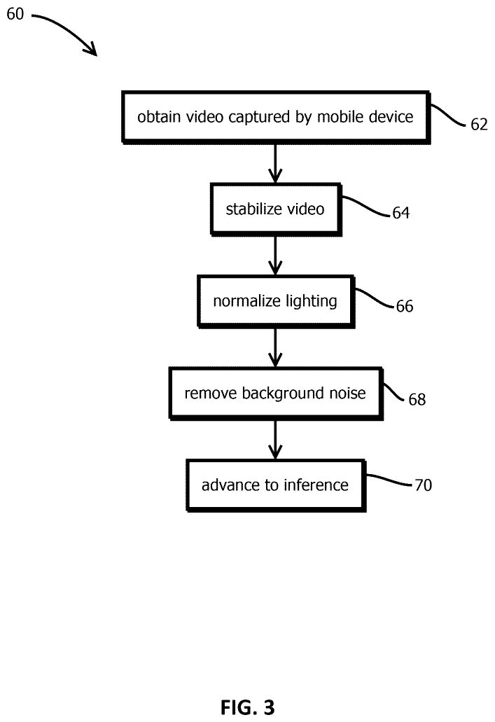

FIG. 3 is a flow chart of a process to pre-process video 60, which in some embodiments, provides detailed preprocessing operations that enhance video quality and standardize input characteristics for subsequent behavioral analysis within the video analyzer 12. The process to pre-process video 60 may be executed by the video pre-processor 24 under coordination of the server 22 to address various quality issues and inconsistencies that may affect the accuracy of feature extraction performed by the computer-vision model 26 and temporal model 28. The process to pre-process video 60, in some embodiments, encompasses multiple sequential enhancement operations that transform raw video input received from the mobile device 14 or computing device 16 into optimized content suitable for computer vision analysis. In some cases, the process to pre-process video 60 operates as a subprocess within the broader process to classify video 40, providing enhanced video data that improves the reliability of behavioral pattern detection and classification accuracy. The process to pre-process video 60 may adapt processing parameters based on video source characteristics and recording conditions to optimize enhancement results for different input scenarios.

The process to pre-process video 60, in some embodiments, initiates with a step 62 that involves obtaining video captured by the mobile device 14 through various acquisition mechanisms and input validation procedures. The step 62 may receive video content transmitted via the internet 20 to the video analyzer 12, where the server 22 manages incoming data streams and establishes processing queues for multiple concurrent preprocessing requests. In some cases, the step 62 analyzes video metadata and encoding parameters to determine appropriate preprocessing strategies based on recording device characteristics, video resolution, frame rate, and compression settings. The step 62 may assess video quality indicators including brightness levels, contrast ratios, and audio signal strength to identify specific enhancement operations that may improve content suitability for computer vision analysis. The step 62 may coordinate with the data store 36 to maintain processing logs and quality metrics that support monitoring and optimization of preprocessing operations across different video sources and recording conditions.

Following video acquisition, the process to pre-process video 60 advances to a step 64 that applies stabilization algorithms to reduce effects of camera movement and shake artifacts present in video recordings. The step 64 may implement digital stabilization techniques that analyze frame-to-frame motion patterns and apply corrective transformations to minimize unwanted camera movement effects that could interfere with facial expression detection and body language analysis performed by the computer-vision model 26. In some cases, the step 64 utilizes optical flow algorithms that track feature points across consecutive video frames to estimate camera motion vectors and calculate appropriate stabilization corrections. The step 64 may apply geometric transformations including translation, rotation, and scaling operations to individual video frames to compensate for detected camera movement patterns. The step 64 may maintain temporal consistency across stabilized video sequences to preserve natural motion characteristics while eliminating artificial movement artifacts that could reduce feature extraction accuracy in subsequent processing stages.

As shown in FIG. 3, the process to pre-process video 60, in some embodiments, proceeds to a step 66 that normalizes lighting conditions across video frames to account for variations in ambient illumination and exposure settings during recording. The step 66 may analyze brightness histograms and color distribution patterns within video frames to identify lighting inconsistencies that could affect facial feature visibility and expression detection accuracy. In some cases, the step 66 applies histogram equalization techniques that redistribute pixel intensity values to enhance contrast and improve feature definition in underexposed or overexposed video regions. The step 66 may implement adaptive brightness correction algorithms that adjust illumination levels based on local image characteristics while preserving natural skin tones and facial feature appearance. The step 66 may coordinate with the computer-vision model 26 to ensure that lighting normalization operations enhance rather than degrade the visibility of facial expressions and micro-expressions that contribute to behavioral analysis accuracy.

The process to pre-process video 60, in some embodiments, continues with a step 68 that removes background noise from audio tracks associated with video recordings to improve speech clarity and vocal pattern analysis performed by the audio feature extractor 32. The step 68 may implement noise reduction algorithms that identify and filter consistent background frequencies including air conditioning systems, traffic sounds, and electronic interference that could mask speech characteristics or introduce artifacts into vocal tone analysis. In some cases, the step 68 applies spectral subtraction techniques that estimate noise profiles from silent portions of audio recordings and subtract these noise characteristics from speech segments to enhance vocal clarity. The step 68 may utilize adaptive filtering algorithms that distinguish between background noise and speech content based on frequency patterns and temporal characteristics to preserve natural vocal qualities while eliminating unwanted acoustic interference. The step 68 may coordinate with the audio pre-processor 30 to ensure that noise removal operations maintain synchronization between audio and video content throughout the preprocessing pipeline.

As further shown in FIG. 3, the process to pre-process video 60 concludes with a step 70 that advances processed video content to inference operations performed by the computer-vision model 26 and temporal model 28 within the video analyzer 12. The step 70 may validate preprocessing results to ensure that stabilization, lighting normalization, and noise removal operations have successfully enhanced video quality without introducing processing artifacts that could affect subsequent analysis accuracy. In some cases, the step 70 generates quality metrics and enhancement statistics that document preprocessing effectiveness and provide feedback for continuous improvement of preprocessing algorithms. The step 70 may coordinate with the server 22 to manage data flow between preprocessing operations and inference components, ensuring that enhanced video content reaches the computer-vision model 26 and temporal model 28 in appropriate formats and timing sequences. The step 70 may maintain processing metadata that associates preprocessed video content with original source characteristics and applied enhancement operations to support result interpretation and system debugging procedures.

The process to pre-process video 60 may execute these sequential enhancement operations through coordinated interactions between the video pre-processor 24 and other components of the video analyzer 12, with the server 22 managing computational resource allocation and processing pipeline coordination throughout the preprocessing workflow. In some cases, the process to pre-process video 60 processes multiple video submissions concurrently through parallel execution pathways that maximize computational efficiency while maintaining consistent enhancement quality across different preprocessing requests. The process to pre-process video 60 may adapt processing parameters based on video source characteristics detected during the step 62 to optimize enhancement results for different recording devices and environmental conditions. The process to pre-process video 60 may generate detailed processing logs and performance metrics that support system monitoring and continuous refinement of preprocessing capabilities within the computing environment 10, helping the foundation model 18 to access enhanced video content that facilitates more accurate behavioral analysis and classification operations.

### Scalable Matching Based on High-Dimensional Data

Some embodiments may mitigate problems with computer-implemented matching at scale. These approaches may leverage artificial intelligence to process relatively high dimensional data, such as natural language text, images, video, and audio to infer respective suitability rankings (e.g., preference) for pairwise combinations of members of different groups being matched. This approach may be deployed in a wide variety of contexts including dating applications, job placement applications, school placement applications, residency placement applications, heterogenous workload allocation in heterogenous distributed computing systems, and the like. An example embodiment is described with reference to job placement but that should not be read to imply that all embodiments are limited to this use case or that any other description herein is limiting.

Some embodiments include an artificial intelligence (AI) based recruitment system that analyzes an applicant's work style and motivators to match them with suitable job openings. The system is expected to improve the efficiency and effectiveness of the recruitment process by identifying candidates who are a good cultural fit and likely to thrive in the specific work environment.

Some computer-implemented job recruitment processes overlook the importance of aligning candidates' personal motivators and work styles with job roles and company culture. Some methods primarily focus on skills and experience, leading to potential mismatches in employee satisfaction and performance. Some embodiments provide a recruitment tool that considers these additional factors for better hiring outcomes.

In some embodiments, an AI-powered job search and recruitment system may include multiple integrated modules configured to enhance the matching process between job applicants and potential job openings by considering not only criteria like skills and experience, but also personal motivators and preferred work styles. The system may include an applicant input module where candidates provide detailed information regarding their work preferences, such as desired levels of autonomy, communication style, and motivators like career advancement opportunities or work-life balance. This input may be collected through various modalities, such as questionnaires or surveys, allowing for a comprehensive profile that reflects both the candidate's professional and personal attributes.

A job description collection module may gather and preprocess job-related data from multiple sources including job boards, company websites, and social media platforms. This data may be then analyzed by a natural language processing (NLP) module that extracts pertinent information, such as required skills, experience levels, and workplace characteristics. An AI matching algorithm, which may employ machine learning techniques, in some embodiments, compares the processed job data with the applicant's profile. The algorithm may evaluate not only the technical fit but also the alignment between the applicant's motivators and work style preferences with the company culture and specific job requirements. A recommendation module may then generate a ranked list of job openings for the applicant and a separate ranked list of candidates for recruiters, prioritizing matches based on the overall compatibility score. Interfaces for recruiters and applicants may present respective ranked potential matches for their evaluation and selection. This process is expected to increase the accuracy of job placements, improve job satisfaction, and reduce employee turnover. Similar benefits are expected in the other domains discussed above.

Some embodiments may include an AI-based job recruitment tool that uses applicants' motivators and desired work styles (e.g., inferred with the techniques described in the prior section or obtained with other approaches) to enhance the candidate selection process. Some embodiments are expected to improve job satisfaction and retention rates. The AI model, in some embodiments, is trained to understand and match these factors with job roles and company culture.

Some embodiments may address the technical problem of matching unstructured applicant data to unstructured job description data in a way that accounts for both objective qualifications and latent personal attributes. Input data (for example, resumes, free-text questionnaire responses, and job descriptions) tends to be inconsistent in structure, format, and vocabulary, making it difficult to compare meaningfully at scale. Rule-based or keyword approaches struggle to extract latent semantic relationships and contextual cues that go beyond explicit content.

To address this, some embodiments incorporate natural language processing (NLP) techniques and embedding models to convert unstructured applicant and job description data into structured, high-dimensional vector representations. These representations may be derived using techniques such as Word2Vec, GloVe, or transformer-based models like BERT. The system may apply these models to extract features not limited to technical skills and experience, but also reflecting personal motivators and preferred work styles. Once vectorized, the system may compute similarity scores between candidate and job embeddings using mathematical metrics. These similarity scores may provide a quantitative measure of compatibility based on the full set of structured features. The result may be a computational process that transforms disparate free-form content into a common mathematical representation for scalable comparison.

By converting psychologically meaningful but otherwise qualitative attributes into numerical form and integrating them into a vector-space compatibility model, the system may introduce an approach that leverages AI-based text understanding for a structured match-scoring framework. This architecture may improve data uniformity and allows for multi-factor evaluation within a technically consistent and machine-executable matching process.

Some embodiments may address the technical problem of computational inefficiency when evaluating large volumes of applicants against large numbers of job openings. Systems that perform full pairwise comparisons between all candidates and all roles may exhibit quadratic time complexity (O(n²)), which presents significant challenges in terms of latency and resource usage, particularly in high-scale environments. To reduce this computational burden, some embodiments incorporate clustering and approximate nearest-neighbor search algorithms. After vectorizing candidate and job attributes using NLP and embedding techniques, the system may apply clustering algorithms, such as k-means or hierarchical clustering, to group similar vectors into semantic cohorts. This approach may allow comparisons to be limited to candidates and job listings within the same or nearby clusters, thereby reducing the number of pairwise evaluations that must be performed.

In some embodiments, the system may apply ANN techniques, such as Hierarchical Navigable Small World (HNSW) graphs, to retrieve top-matching candidates or jobs from a high-dimensional embedding space. These algorithms may be designed for efficient traversal of vector spaces with sub-linear query time and are capable of retrieving the nearest vector neighbors with high precision and recall. This architecture may avoid exhaustive search and reduce latency in retrieval operations, allowing the system to scale to millions of vectors while maintaining responsiveness.

These techniques may operate directly on mathematical representations of textual data and may be implemented to solve a specific technical limitation in vector-based search systems. By reducing the volume of required similarity computations and maintaining approximate match quality, the system achieves a computational improvement that supports real-time interaction in a domain involving unstructured and semi-structured data.

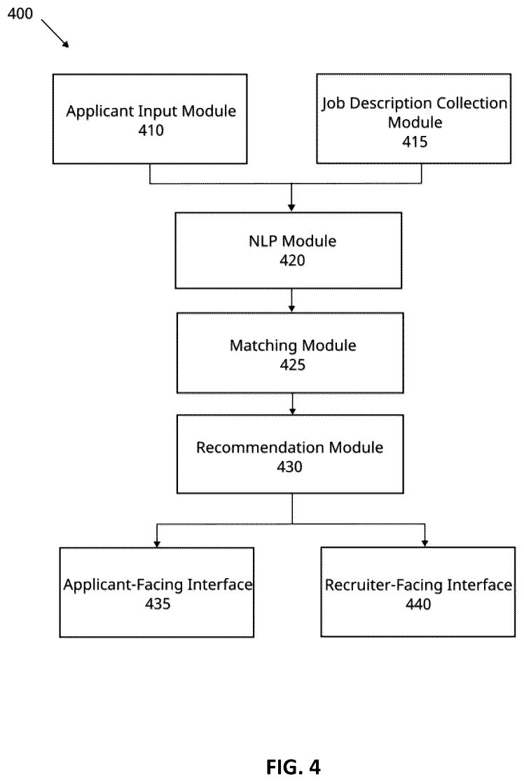

FIG. 4 depicts a system 400 for performing automated job search and recruitment using an AI-powered matching pipeline. The system may include a series of interconnected components that operate sequentially to process input data, extract features, perform matching, and present ranked recommendations to end users.

The system 400 may receive data from two input sources: an Applicant Input module 410 and a Job Description Collection module 415. The Applicant Input module 410 may be configured to receive applicant-provided data, including resume content, responses to surveys or questionnaires, and information relating to personal motivators and preferred work styles. The Job Description Collection module 415 may gather job description data from external and internal sources, such as job boards, company databases, and social media profiles. These two data sources may provide the raw textual input necessary for further processing. The outputs of both the Applicant Input module 410 and the Job Description Collection module 415 may be provided to an NLP module 420. The NLP module 420 may process the applicant and job description data using natural language processing techniques to extract structured attributes. These may include, for example, technical skills, years of experience, education, personal motivators, and organizational culture descriptors. The output constructed by the NLP module 420 may be provided to a Matching module 425. The Matching module 425 may compute degrees of similarity between the applicant and job vectors using one or more similarity metrics. These similarity scores may reflect the compatibility between a given applicant and a job description based on both objective and psychographic features. Based on the computed similarity scores, a Recommendation module 430 may create ranked outputs corresponding to candidate-job pairings. The Recommendation module 430 may incorporate heuristic rules and machine-learned ranking models to prioritize the most compatible matches. These recommendations may then be distributed to two interface components: an Applicant-Facing Interface 435, which presents a ranked list of job opportunities to individual applicants, and a Recruiter-Facing Interface 440, which presents a ranked list of candidate profiles for a given job description to recruiters or hiring managers.

Some embodiments may include a distributed computing environment in which various functional components are executed across multiple computing devices. In some embodiments, the computing devices may communicate with each other over one or more networks, which may include the Internet, a local area network), a wide area network, or any combination thereof. Communication between components may take place using standard communication protocols such as HTTP, HTTPS, RESTful APIs, gRPC, WebSockets, or proprietary protocols configured for secure data exchange. In some embodiments, the system architecture may include a plurality of user computing devices operated by applicants, recruiters, or other stakeholders. These user computing devices may include desktop computers, laptops, tablet devices, mobile phones, or wearable computing devices. In some embodiments, user interaction with the system may occur through a native application executing on the local device or through a web-based interface rendered by a browser and served by a remote web server. The interface may support HTTPS connections to allow for secure communication between clients and the backend services.

In some embodiments, the user computing devices may communicate with one or more backend servers hosted in a cloud computing environment or private enterprise infrastructure. In some embodiments, backend servers may be configured to execute various functions described herein, such as data ingestion, natural language processing, feature extraction, embedding generation, similarity computation, and recommendation ranking. In some embodiments, the backend infrastructure may be implemented using a microservices architecture, wherein different services perform specific functions and communicate asynchronously or synchronously via internal APIs or message queues. The backend components may run on physical or virtual machines. In some embodiments, the system may utilize auto-scaling groups to dynamically allocate computational resources based on load, allowing that matching and recommendation operations remain performant under high user volume. In some embodiments, the system architecture may also include one or more data storage systems, such as relational databases (e.g., PostgreSQL™, MySQL™), NoSQL databases (e.g., MongoDB™, or Cassandra™), or distributed file systems (e.g., Amazon S3™, HDFS, or the like). These storage systems may persist job descriptions, applicant information, vectorized feature representations, similarity scores, and user interaction data. In some embodiments, data stores may be optimized for fast retrieval using indexing strategies, caching layers, or content-addressable storage schemes.

In some embodiments, intermediate data such as vector representations or similarity scores may be cached using in-memory data stores to reduce redundant computation. In some embodiments, preprocessing or embedding models may be hosted in separate model-serving environments, which may be integrated via RESTful endpoints or real-time inference services.

In some embodiments, the system may be implemented using a monolithic architecture, wherein all processing operations are executed locally on a single computing device or a tightly integrated hardware platform. In some embodiments, the computing device may be a general-purpose computer, workstation, or server configured with sufficient processing, memory, and storage resources to perform each of the operations described herein. In some embodiments, the computing device may locally execute the full job-to-candidate matching pipeline, including ingestion of applicant inputs, collection or entry of job descriptions, natural language processing and parsing, vector embedding, similarity computation, and recommendation generation. The computing device may also render user interfaces directly, for instance via an attached monitor or touchscreen, or may serve local web pages accessible over a private intranet. In some embodiments, data collected through the system may be stored locally in one or more on-device databases, such as SQLite, an embedded document store, or a flat-file system using JSON, XML, or binary formats. In some embodiments, all models used for natural language processing, feature extraction, or ranking may be pre-loaded onto the device and executed via local inference engines such as ONNX Runtime, TensorFlow Lite, or PyTorch Mobile.

To support on-device privacy and regulatory compliance, some embodiments may be configured to operate entirely offline, without transmitting or receiving data over any external network. For example, a recruiter may input job descriptions through a local administrative interface, and applicants may interact with the system via kiosk terminals or authenticated local sessions. In some embodiments, no internet connection may be required for operation, although software or model updates may optionally be applied manually via physical media or local network transfer. In some embodiments, the system may be implemented in a virtual machine or container environment that runs entirely on a single host. This configuration may support easy deployment of the application on laptops or standalone servers while maintaining full functional parity with distributed versions. Local logging and audit tracking features may be included to record matching decisions, input data, and user interactions without requiring external monitoring tools.

In some embodiments, security may be provided through role-based access controls, encrypted data transmission, and secure authentication and authorization frameworks such as OAuth 2.0, OpenID Connect, or SAML. In some embodiments, audit logs may be maintained to track system usage and changes to job postings or applicant data, allowing for traceability and compliance with enterprise policies or regulatory frameworks.

In some embodiments, certain operations such as video preprocessing, initial NLP parsing, or resume standardization may be partially or fully offloaded to client devices to reduce server-side processing loads. For example, mobile applications may incorporate on-device machine learning models to extract structured features prior to transmission.

The Applicant Input module 410 may be configured to collect various forms of applicant data relevant to job compatibility analysis. In some embodiments, this module may provide an interface that supports both structured and unstructured input formats and may be deployed via a web browser, a mobile application, or an embedded frame in a third-party platform such as a recruiting portal or applicant tracking system. In some embodiments, the Applicant Input module 410 may allow users to provide responses to surveys, quizzes, or structured questionnaires designed to assess personal motivators and preferred work styles. This assessment data may be collected through a static form or a dynamically adaptive interface that adjusts questions based on prior inputs. The information gathered may relate to a range of personal work preferences, including but not limited to preferred work environment (e.g., collaborative, independent, high-structure), communication style (e.g., synchronous, asynchronous, team-oriented), level of desired autonomy, and forms of recognition (e.g., public praise, private feedback, advancement opportunities).

In some embodiments, the module may also capture narrative-style responses that allow applicants to describe past experiences, achievements, or situations that reveal their motivational drivers and working tendencies. These inputs may be parsed in later processing stages to infer latent psychographic attributes, such as leadership orientation, stress response, or goal alignment. The Applicant Input module 410 may support document ingestion workflows, including uploading of resumes, CVs, or cover letters, which may supplement structured input fields. In some embodiments, the Applicant Input module 410 may offer multi-language localization, support for assistive technologies (e.g., screen readers), and alternative input modalities, such as voice-based or touch-based interaction on mobile devices.

In some embodiments, uploaded documents may be automatically parsed or preprocessed to extract conventional applicant attributes such as job titles, employers, skills, certifications, or educational background. In some embodiments, the Applicant Input module 410 may implement input validation, field standardization, or pre-processing routines. In some embodiments, user responses may be stored in intermediate representations that preserve both raw input and normalized feature values for downstream analysis. The system 400 may optionally cache session state, allowing applicants to complete input over multiple sessions, and may track input versioning to support auditing or iterative updates.

In some embodiments, the Applicant Input module 410 may permit applicants to link external professional profiles such as LinkedIn or GitHub through secure authentication channels. Data retrieved through such integrations may be presented for review and confirmation by the applicant before being incorporated into their profile.

The Job Description Collection module 415 may be configured to retrieve job-related data from a variety of internal and external sources. In some embodiments, this module may support automated, semi-automated, or manual data acquisition processes to ingest job descriptions for use in downstream parsing and matching operations. The Jobe Description Collection module 415 may be programmed to search publicly available job boards, company career portals, and/or third-party job listing aggregators using web scraping techniques, APIs, or feed ingestion protocols (e.g., RSS, Atom, JSON). In some cases, the system may retrieve listings from corporate databases or internal enterprise systems containing proprietary job descriptions maintained by human resources personnel or recruiting teams. In some embodiments, the module may retrieve job description content from social media platforms or employer branding sites, such as LinkedIn, Twitter (X), or Glassdoor. This data may include structured postings as well as unstructured content derived from promotional materials, job-related commentary, or hashtags associated with open positions.

In some embodiments, recruiters and hiring managers may directly input job descriptions into the system through a dedicated interface. In some embodiments, the Job Description Collection module 415 may accept free-text input or structured form-based input, allowing internal users to describe key job attributes including role titles, responsibilities, required qualifications, desired experience levels, and organizational culture indicators. In some embodiments, the collected job data may be aggregated from multiple listings or sources that refer to the same or similar positions. Aggregation logic may include deduplication, normalization of job titles and taxonomies, and synthesis of data points from overlapping entries (e.g., combining role responsibilities from multiple listings for a given job title across different geographies).

In some embodiments, preprocessing of the collected job description data may be performed prior to delivery to the NLP module 420. In some embodiments, preprocessing may include text cleaning, removal of HTML markup or special characters, language normalization (e.g., casing, punctuation, token standardization), and application of custom filters (e.g., to remove advertisements or spam-like content). In some embodiments, the system may further classify job descriptions by domain, industry, seniority level, or job family to support domain-specific downstream processing or feature extraction.

In some embodiments, the Job Description Collection module 415 may operate in batch mode, periodically syncing job descriptions at set intervals or in real-time, ingesting listings as they become available through streaming or push-based mechanisms. In some embodiments, the module may also support version tracking, allowing updates to existing listings to be stored alongside historical versions for auditability or retraining of matching models.

In some embodiments, the Job Description Collection module 415 may implement quality assurance logic, including source reputation scoring, content completeness checks, or metadata validation routines. In some embodiments, the module may interoperate with external job taxonomy services (e.g., O*NET, ESCO, SOC codes) to tag job descriptions with standardized role identifiers or competency clusters. These identifiers may then be used to support more precise semantic matching or cross-industry benchmarking.

In some embodiments, the system may include a pre-processing stage that operates on applicant-provided documents and job description data before such data is forwarded to the NLP module 420 for deeper semantic analysis. The pre-processing phase may be applied to any form of unstructured or semi-structured textual input, including resumes, questionnaires, job postings, personal statements, or recruiter annotations. In some embodiments, pre-processing may include one or more text normalization procedures. For example, the system may perform case folding, in which all characters are converted to lowercase to allow for uniformity across tokens. In some embodiments, punctuation removal or character filtering may be applied to eliminate extraneous symbols or formatting artifacts that could introduce noise into downstream analysis. In some embodiments, the system may tokenize the text into discrete word units or sub-word units, such as byte-pair encodings or WordPiece tokens. This may be followed by stop-word removal, where high-frequency, semantically uninformative terms (e.g., “and,” “the,” “with”) are removed to reduce dimensionality and computational overhead. The system may apply stemming or lemmatization to reduce inflected forms of words to their base or canonical form (e.g., “running”→ “run”).

In some embodiments, the system may apply de-duplication techniques. In some embodiments, repeated phrases, bullet-point redundancies, or templated resume content may be detected and consolidated using hashing or similarity heuristics. In some embodiments, the system may detect and correct spelling or grammatical inconsistencies using a lightweight language model or dictionary-based correction engine. In some embodiments, possibly when processing free-form survey responses or narrative-style input, the system may apply sentence segmentation and part-of-speech tagging to identify grammatical structure and extract features aligned with known patterns (e.g., verb-object relationships or named entities). These structures may support downstream feature extraction in the NLP module 420.

In some embodiments where input data is received in non-textual formats (e.g., PDF or DOCX files), the pre-processing system may include document conversion utilities to extract raw text, clean headers/footers, and remove metadata or OCR noise. In some embodiments, layout-aware parsing may be used to preserve the semantic structure of columns, sections, or visual hierarchies within the original document.

In some embodiments, pre-processing may also include language detection and translation, facilitating multilingual support. For example, if non-English inputs are detected, the system may apply machine translation services (e.g., via transformer-based models) to convert the text into English or a designated canonical language for further analysis.

In some embodiments, pre-processing may be applied locally on a client device, possibly in mobile-first deployments or privacy-sensitive applications. Lightweight neural models or rule-based filters may execute within the client environment, reducing the amount of raw data transmitted to the central system.

In some embodiments, the result of the pre-processing stage may be a structured or semi-structured representation of the original text, suitable for embedding or further transformation by the NLP module 420. This representation may include token sequences, normalized term lists, or vector-ready documents aligned to the vocabulary space of the selected embedding model.

In some embodiments, the pre-processing operations described herein may be performed as a distinct stage prior to execution of the NLP module 420. In alternative embodiments, the pre-processing functionality may be incorporated into the NLP module 420 itself, wherein some or all of the pre-processing steps (such as normalization, tokenization, stop-word removal, and grammatical analysis) are treated as sub-processes within the broader NLP pipeline.

The NLP module 420 may be configured to analyze unstructured or semi-structured text data obtained from applicant inputs and job descriptions. In some embodiments, the NLP module may serve as the primary component responsible for transforming raw text into structured feature representations suitable for downstream processing, including embedding, similarity scoring, and recommendation generation. In some embodiments, the NLP module 420 may process a variety of textual sources, including resumes, cover letters, job descriptions, candidate questionnaires, and survey responses. In some embodiments, this processing may begin after initial pre-processing operations such as tokenization, normalization, and sentence segmentation have been completed. In alternative embodiments, the NLP module may incorporate one or more of those pre-processing tasks directly into its parsing pipeline.

In some embodiments, the NLP module 420 may be configured to extract a range of structured features from the input text. These features may include hard attributes, such as technical skills, years of experience, certifications, and education level, as well as soft attributes, such as communication style, motivational drivers, and work environment preferences. For example, the module may identify a candidate's self-described strengths such as “detail-oriented,” “self-starter,” or “team player,” which may be indicative of preferred work styles or alignment with specific company cultures. In some embodiments, the NLP module 420 may use keyword extraction techniques, named entity recognition (NER), or syntactic parsing to isolate meaningful tokens or phrases associated with work style descriptors, skills, or motivators. The module may be trained or configured to identify key phrases in job descriptions that relate to role expectations (e.g., “fast-paced environment,” “autonomous role,” “collaborative team”) and correlate these with corresponding applicant traits. In some embodiments, the NLP module may apply one or more pretrained or fine-tuned language models, including but not limited to Word2Vec, GloVe, and BERT-based transformer models. These models may be used to map words and phrases into a high-dimensional semantic space, such that the relationships between applicant qualifications and job requirements can be captured even when they are not expressed using identical terminology.

In some embodiments, the NLP module 420 may convert the extracted features into structured formats such as JSON, relational records, or feature vectors for later use by the embedding system. The output may include attribute-value pairs or semantic feature sets, which may be passed to subsequent components such as the matching module 425 or recommendation module 430.

In some embodiments, the NLP module 420 may be configured to operate in either batch or streaming mode. For example, it may process multiple applicant profiles asynchronously when triggered by a job posting event or analyze a new job description in real time when entered by a recruiter. In some embodiments involving real-time candidate-job matching, the NLP module 420 may include performance optimizations such as token caching, on-demand vector generation, or partial re-analysis based on content deltas.

In some embodiments, the NLP module 420 may support multilingual inputs by integrating with translation services or multilingual transformer models. This may assist parsing of resumes and job descriptions written in different languages, with semantic alignment preserved during the embedding and scoring phases. In some embodiments, the NLP module 420 may optionally incorporate logic to assess text completeness or coherence, such as checking whether critical features are missing from an applicant profile or whether a job posting lacks sufficient role detail. In some embodiments, these assessments may be used to flag incomplete entries or prompt additional input from the user.

In some embodiments, text parsing and feature extraction may be applied to scan resumes and natural language questionnaires from job applicants, as well as job openings and recruiter-provided questionnaires, to facilitate the computation of a preference score that matches applicants with job openings. The process, in some embodiments, may begin with text parsing, where the unstructured text from resumes and questionnaires is analyzed to identify and structure relevant information. Text parsing may involve tokenizing the text into individual words or phrases, followed by part-of-speech tagging to categorize words (e.g., nouns, verbs, adjectives) and syntactic parsing to determine the grammatical structure of sentences.

Once the text has been parsed, feature extraction may be performed to identify key information that describes the skills, experiences, education, preferences, and other relevant attributes of the job applicants. This extraction, in some embodiments, may be achieved through various NLP techniques, such as named entity recognition (NER) to identify entities like job titles, company names, and dates, or keyword extraction to highlight important terms related to specific skills or qualifications. Additionally, feature extraction may involve analyzing the frequency of certain terms or the context in which they appear, which may be captured through methods such as TF-IDF or word embeddings like Word2Vec, GloVe, or BERT, which represent the semantic meaning of words as vectors in a high-dimensional space (e.g., with more than 10 dimensions, more than 100 dimensions, or with more than 1,000 dimensions).

Similarly, job openings and recruiter questionnaires may be parsed and processed to extract features that describe the job requirements, responsibilities, desired qualifications, and cultural or organizational preferences. The same or similar NLP techniques may be applied to extract and represent these features in a structured format, allowing for direct comparison with the features extracted from the applicants' documents.

In some embodiments, content-based filtering may be applied to match job applicants with job openings by first processing resumes and natural language questionnaires provided by the applicants. This process may involve extracting features from the textual content, such as keywords, phrases, or entities that describe skills, experiences, education, and preferences of the applicants. These features may be identified using techniques such as NLP methods, which may include tokenization, stemming, lemmatization, and named entity recognition. For example, an NLP model may identify and extract job-specific terms from a resume, such as “Python programming,” “data analysis,” or “project management.” Additionally, the context of these terms within the document may be analyzed using vectorization methods like TF-IDF or word embeddings, such as Word2Vec or BERT, to generate a numerical representation of the applicant's qualifications and preferences.

Similarly, job openings and natural language questionnaires provided by recruiters may undergo a comparable feature extraction process. The extracted features from the job descriptions and recruiter questionnaires may include required skills, desired qualifications, job responsibilities, and cultural fit indicators. These features may also be vectorized to create a numerical profile of the job opening. In some embodiments, semantic similarity measures may be computed between the applicant's profile and the job opening's profile using techniques such as cosine similarity or dot product of the vector representations. The similarity score may represent the degree of match between the applicant's qualifications and preferences and the requirements of the job opening.

In some embodiments, classification and ranking models may be employed to scan resumes and natural language questionnaires from job applicants, as well as job openings and recruiter questionnaires, to compute a preference score that matches applicants with job openings. The process may begin by pre-processing the textual content of the resumes and questionnaires, including tokenization, stemming, and stop-word removal, followed by feature extraction. Features may include keywords, phrases, job titles, skills, and other relevant attributes, which may be represented as numerical vectors using techniques such as Term Frequency-Inverse Document Frequency (TF-IDF) or BM25 or word embeddings like Word2Vec or BERT.

Classification models may then be applied to categorize applicants into different predefined classes or labels, which may correspond to specific job roles, experience levels, or skill sets. For instance, a classification model such as a support vector machine (SVM), decision tree, or neural network may be trained on a labeled dataset of resumes and job descriptions to predict the most appropriate job category for each applicant. The output of this classification process may be a probability distribution across multiple job categories, reflecting the likelihood that a given applicant is suitable for each category.

Concurrently, the job openings and recruiter questionnaires may also be classified into the same or corresponding categories, using similar classification models. The classification process for job openings may involve analyzing the job requirements, qualifications, and responsibilities to determine the most relevant job category or categories.

Once both applicants and job openings have been classified, a ranking model may be applied to compute a preference score for each applicant-job opening pair. The ranking model may use the classification outputs, along with additional features such as the similarity between the applicant's and the job's feature vectors, to determine the relative suitability of the match. The ranking model may be implemented using techniques such as logistic regression, gradient boosting, or deep learning models that are trained to predict the likelihood of a successful match based on historical hiring data.

The ranking process may involve calculating a score for each applicant-job pair by aggregating various factors, such as the classification probabilities, similarity measures between feature vectors, and any additional contextual or domain-specific information. For example, the model may assign higher weights to certain skills or experiences that are particularly relevant to the job in question. The resulting preference score represents the strength of the match between the applicant and the job opening, with higher scores indicating a better match.

In some embodiments, the ranking model may be further refined through iterative training and validation, using feedback from actual hiring outcomes to adjust the model's parameters and improve its predictive accuracy. The final preference scores may be used to rank applicants for each job opening or to suggest job opportunities to applicants, facilitating a more efficient and accurate matching process.

In some embodiments, the matching module 425, may be configured to compare features extracted from applicant profiles with corresponding attributes found in job descriptions to assess compatibility between the two. In some embodiments, this comparison may consider a variety of attributes, including technical skills, prior work experience, education history, industry familiarity, and role-specific qualifications. In some embodiments, the matching module 425 may account for non-technical factors such as applicant motivators, preferred work styles, communication preferences, and cultural alignment indicators.

In some embodiments, the matching module 425 may incorporate machine learning techniques to dynamically improve match quality over time. The module may analyze historical data from previously submitted applicant profiles and associated job outcomes (e.g., interview progression, hiring decisions, performance reviews) to identify patterns indicative of successful placements. These patterns may then be used to refine the model's weighting of particular attributes during future candidate-job evaluations.

In some embodiments, the matching module 425 may compare structured candidate attributes (such as years of experience, skill keywords, or education level) with corresponding job requirements extracted from job descriptions. In some embodiments, this may involve computing one or more similarity scores between the respective vectorized feature sets of the applicant and the job, using mathematical distance metrics or learned scoring functions. These similarity scores may serve as a foundation for subsequent ranking operations, or may be used directly to assess match strength. In addition to objective qualifications, the matching module 425 may be trained or configured to assess psychographic alignment between applicants and roles in some embodiments. For example, if a job description emphasizes autonomy and self-direction, the module may assign greater value to applicants who have previously indicated a preference for independent work styles or who have provided narrative responses emphasizing self-motivation. Similarly, if a company emphasizes collaboration or mentorship, the module may surface applicants who are more aligned with team-oriented dynamics.

In some embodiments, the matching module 425 may operate as a standalone logic engine. In other embodiments, it may function as a part of a broader scoring pipeline involving pre-classification, feature encoding, or clustering. The module may take as input a combination of numerical vectors, category labels, and metadata derived from NLP and pre-processing stages, and may output a single match score, a ranked list of jobs or applicants, or an intermediate representation for downstream refinement.

In some embodiments, the matching module 425 may support flexible weighting schemes, allowing certain attributes to be emphasized or de-emphasized based on job context, user-configurable rules, or model-inferred significance. For example, in a senior technical role, skills and experience may carry greater weight than cultural motivators, whereas for an early-career role in a team-driven environment, the weighting may favor adaptability and cultural alignment.

In some embodiments, the AI matching algorithm may be implemented using rule-based heuristics augmented by machine learning, or it may rely entirely on learned models trained from labeled historical data. The system may include mechanisms for feedback incorporation, allowing hiring outcomes or recruiter selections to further fine-tune the model's behavior over time. In some embodiments, the matching module 425 may include or interact with explainability components, such as attention mechanisms or rule-based justifications, to surface the rationale behind a particular match score or recommendation.

In some embodiments, the matching module 425 may be deployed in real-time systems capable of generating live recommendations, or in batch-processing environments optimized for evaluating large candidate pools against high volumes of job listings. In some embodiments, the module may operate within a service-oriented architecture or as part of a monolithic inference pipeline depending on deployment needs.

In some embodiments, decision trees may be employed to facilitate the matching of job applicants with job openings by classifying and ranking applicants based on their resumes and natural language questionnaires. Decision trees may operate by recursively splitting the data into subsets based on feature values, creating a tree-like structure where each internal node represents a decision point (a feature test), and each leaf node represents a classification or outcome (e.g., the suitability of an applicant for a specific job).

To apply decision trees in the context of matching job applicants to job openings, the process may begin with feature extraction from the resumes, applicant questionnaires, job descriptions, and recruiter questionnaires. These features may include skills, experience levels, education, job preferences, and specific qualifications, all of which are represented as input variables for the decision tree model.

The decision tree may then be trained on a labeled dataset that contains historical data of applicants and job openings, where the labels represent successful or unsuccessful matches (e.g., hired or not hired). During training, the decision tree algorithm selects the feature and corresponding threshold that best splits the data into two groups, aiming to maximize the separation between different outcomes. This selection process may be guided by metrics such as information gain or Gini impurity, which measure the quality of the split.

For example, a decision node in the tree might test whether an applicant has a certain number of years of experience in a particular skill, such as “Does the applicant have more than 5 years of experience in Python programming?” Depending on the answer (“yes” or “no”), the decision tree will follow a specific branch, leading to further questions (nodes) or a final decision (leaf).

As the tree grows, it creates branches that represent different paths through the decision-making process, each path corresponding to a series of criteria that an applicant must meet to be classified into a particular category or to predict their suitability for a job. The terminal nodes (leaves) of the tree represent the final classifications or scores, such as whether the applicant is a strong match, weak match, or not a match at all for a given job.

Once trained, the decision tree can be used to classify new applicants by passing their features through the tree from the root to a leaf node. The output at the leaf node may be a probability score indicating the likelihood of a successful match between the applicant and a job opening. This probability can then be used as a preference score to rank applicants or recommend job openings.

In some embodiments, the decision tree may be pruned to avoid overfitting, where less important branches are removed to create a simpler model that generalizes better to new data. Additionally, an ensemble of decision trees, known as a random forest, may be used to improve the robustness and accuracy of the predictions by averaging the outputs of multiple trees trained on different subsets of the data.

In some embodiments, a neural network may be employed to match job applicants with job openings by analyzing resumes, applicant questionnaires, job descriptions, and recruiter questionnaires. Neural networks are a type of machine learning model composed of layers of interconnected nodes (neurons) that process input data through a series of transformations to produce an output, such as a classification or a preference score.

The neural network in this context may be a feedforward neural network, a convolutional neural network (CNN) adapted for text, or other models like a recurrent neural network (RNN) or transformer, depending on the complexity of the input data and the desired output. The input layer of the network may receive the vectorized features extracted from both the applicants' and recruiters' documents. These features might include not only the text embeddings but also other relevant data such as years of experience, education level, or specific job preferences.

The neural network, in some embodiments, processes these inputs through multiple hidden layers, where each neuron in a layer applies a weighted sum of its inputs, passes the result through an activation function (such as ReLU, sigmoid, or tanh), and then forwards the output to the neurons in the next layer. This process, in some embodiments, helps the network to learn complex, non-linear relationships between the input features and the output, such as how different combinations of skills and experiences might predict the suitability of an applicant for a particular job.

During training, the neural network, in some embodiments, is fed a large dataset of labeled examples, where each example includes an applicant's features, a job opening's features, and a label indicating whether a match was successful (e.g., whether the applicant was hired). The network, in some embodiments, adjusts its internal weights using backpropagation and an optimization algorithm like stochastic gradient descent (SGD), aiming to minimize the difference between its predicted output and the actual label (loss function).

For example, the network may learn that certain skills in a resume are highly predictive of success in specific types of job openings, or that a certain pattern of responses in a questionnaire indicates a strong cultural fit with a company. Similar learning may occur with respect to work styles, culture, goals, and other attributes. As the network trains, in some embodiments, it fine-tunes its parameters to improve the accuracy of its predictions.

Once trained, in some embodiments, the neural network can be used to evaluate new applicants. When a new resume or questionnaire is input, in some embodiments, the network processes the data through its layers and outputs a preference score, which may represent the likelihood that the applicant is a good match for a particular job opening. This score could then be used to rank applicants for a job or to suggest job opportunities to applicants.

In some embodiments, other neural network architectures, such as transformers (e.g., BERT or GPT models), may be used to capture the context and relationships between words or phrases in the text more effectively. These models, in some embodiments, can consider the entire input text as a sequence and process it in parallel, allowing for a deeper understanding of the content, which may lead to more accurate matching.

Additionally, the neural network model could be combined with other machine learning techniques, such as ensemble learning, where the neural network's predictions are integrated with those from other models (like decision trees or logistic regression) to produce a more robust and accurate final preference score.

The recommendation module 430 may be responsible for generating a compatibility score between a given applicant and one or more job openings, or conversely, between a given job opening and one or more applicants. In some embodiments, this compatibility score may reflect the overall degree of alignment between the two parties across both technical qualifications and soft attributes, and may be used to drive ranked outputs delivered to applicant- or recruiter-facing interfaces. In some embodiments, the recommendation module 430 may compute the compatibility score using a weighted aggregation of multiple contributing factors. These factors may include the degree of similarity between the applicant's and job's embedded feature vectors, the degree of categorical alignment (e.g., role type, seniority level), and a psychographic compatibility score derived from motivators and work style preferences. In some embodiments, each of these elements may be given different weights, which may be statically defined, dynamically adjusted based on role type or industry, or learned through machine learning optimization processes.

In some embodiments, the recommendation module 430 may implement one or more ranking models trained to prioritize candidates or job listings based on historical hiring data, recruiter preferences, or downstream success indicators (e.g., offer acceptance, tenure). These models may include logistic regression, gradient-boosted decision trees, or deep neural networks configured to estimate the likelihood of a successful match. In some embodiments, these models may be refined through feedback mechanisms or A/B testing strategies to improve ranking quality over time. In some embodiments, the recommendation module 430 may apply heuristic rules that reflect system-wide or domain-specific preferences. For example, the system may apply rules to deprioritize candidates lacking minimum required skills, or to boost listings for jobs located within a target geographic radius of the applicant. In some embodiments, rule-based logic and model-based scoring may be combined, with heuristics serving as gating or post-processing layers to override or refine model outputs.

In some embodiments, the resulting compatibility score may be represented numerically (e.g., as a scalar between 0 and 1), or ordinally (e.g., “High match,” “Moderate match,” “Low match”), and may be used to sort or filter candidate-job pairs before presentation to end users. The recommendation module 430 may also generate associated metadata (such as match explanations, confidence intervals, or contributing feature breakdowns) to support transparency and improve user trust. In some implementations, the recommendation module 430 may generate a bidirectional ranked output, where a given applicant sees their most relevant job opportunities, and recruiters see their highest-matching candidates. The ranked outputs may be computed independently or jointly, depending on the deployment configuration and matching symmetry requirements. In some embodiments, candidate preference scores for jobs may differ from job-side preference scores for candidates, reflecting asymmetrical priorities or information availability.

In some embodiments, the recommendation module 430 may be designed to operate in real-time (e.g., when a new applicant or job is added to the system), or in batch-processing mode, where candidate-job scoring is periodically refreshed across the database. The module may be integrated into the system's data pipeline, producing ranked results for downstream consumption by the applicant-facing interface 435 or recruiter-facing interface 440. In some embodiments, the recommendation module may be extensible, allowing for plug-in ranking strategies, threshold-based filters, or custom match logic tailored to the preferences of specific enterprises or user segments.

The applicant-facing interface 435 may be configured to present job opportunities to applicants based on compatibility scores generated by the system. This interface may serve as the primary point of interaction for users seeking employment matches and may display a ranked list of job openings tailored to the applicant's individual profile. In some embodiments, the interface may display the applicant's top matching job openings, with the highest-ranked jobs (e.g., based on compatibility scores) appearing first. In some embodiments, the compatibility scores may be derived from the outputs of the AI matching algorithm and the recommendation module and may take into account structured and unstructured applicant information, including skills, experience, education, motivators, and preferred work styles.

The applicant-facing interface 435 may include interactive features that allow the applicant to search, filter, and sort job listings according to various parameters. For example, filters may be applied to limit results by location, industry, required qualifications, salary range, remote/hybrid options, or employer size. The interface may also allow sorting based on score, posting date, company name, or other attributes relevant to the applicant's preferences. In some embodiments, each job listing displayed within the interface may include additional metadata to assist the applicant in evaluating the opportunity. This metadata may include job title, company name, summary of responsibilities, required skills, location, and compensation information if available. In some implementations, the system may also surface a brief explanation or visualization of why a particular job is a strong match such as highlighting overlapping skills, cultural alignment indicators, or previously successful applicant archetypes.

In some embodiments, the applicant-facing interface 435 may also support real-time updates as new job listings are collected by the job description collection module or as the applicant updates their own profile. In some embodiments, the interface may notify the user when new high-ranking opportunities become available or when job listings they have saved are about to expire. In some embodiments, notifications to applicants may be issued through SMS, email, mobile notifications, or other communication methods.

In some embodiments, applicants may interact with the interface through a desktop or mobile application, or via a web browser-based portal. In some embodiments, the interface may integrate with third-party platforms such as email clients or messaging services to deliver personalized job alerts or updates on application statuses. In some embodiments, the system may support interactive recommendation refinement, allowing applicants to provide feedback (e.g., thumbs up/down, “not interested,” or “interviewed here before”) to further personalize future recommendations. This feedback may be stored and optionally used to adjust ranking algorithms or retrain preference models over time. In some embodiments, the interface may also include options for viewing or exporting saved job opportunities, applying directly through embedded links or integrations, or scheduling follow-up actions such as interviews or reminders. In enterprise environments, white-labeled or employer-branded versions of the interface may be presented to candidates applying through dedicated career portals.

The recruiter-facing interface 440 may be configured to present recruiters, hiring managers, or other organizational users with a ranked list of applicants based on computed compatibility scores. This interface may serve as the primary point of interaction for users tasked with evaluating candidate pools and identifying potential hires. In some embodiments, the recruiter-facing interface 440 may display a list of applicants ranked by compatibility with a selected job opening. In some embodiments, the compatibility scores may reflect outputs from the AI matching algorithm and the recommendation module and may be based on a variety of applicant attributes including skills, work experience, education, motivators, and preferred work styles. Higher-ranked applicants may be displayed at the top of the interface, providing an at-a-glance view of candidates most likely to succeed in the given role. The recruiter-facing interface 440 may include features to search, filter, and sort candidate profiles. In some embodiments, recruiters may, for example, filter applicants by minimum years of experience, specific skill sets, education level, location, or availability. In some embodiments, sorting options may include compatibility score, alphabetical name ordering, application date, or recency of interaction. In some embodiments, the system may allow recruiters to define custom filters or weightings to reflect role-specific priorities or organizational preferences.

In some embodiments, each candidate entry within the interface may include a summary view of the applicant's qualifications, such as a skill list, job title history, education, and optionally, psychographic indicators derived from work style or motivator inputs. In some embodiments, recruiters may access an expanded view of the applicant's profile, which may include uploaded resumes, parsed content, and scoring rationale that highlights areas of strong alignment or mismatch. In some embodiments, the interface may include mechanisms for actionable engagement, such as saving a candidate to a shortlist, initiating direct outreach via email or integrated messaging tools, or triggering workflow actions (e.g., scheduling an interview, flagging for review, or sharing with another team member). In some embodiments, candidate statuses may be tracked and displayed, allowing recruiters to view progress across the hiring funnel.

In some embodiments, the recruiter-facing interface 440 may be rendered through a browser-based application, enterprise dashboard, or standalone desktop environment, and may integrate with internal applicant tracking systems (ATS) or human resource information systems (HRIS). In some embodiments, the interface may include access controls or user roles to restrict visibility or actions based on organizational policies.

In some embodiments, the system may allow recruiters to provide feedback on candidate quality (e.g., through ratings, comments, or match accuracy indicators), which may be used to improve future ranking results through retraining or personalization. The interface may also support side-by-side comparison views, pipeline visualizations, or export features to facilitate decision-making and collaboration among hiring stakeholders.

In some embodiments, the recruiter-facing interface 440 may be updated in real time as new applicants are submitted, as job descriptions are modified, or as underlying model outputs are refreshed. Notifications may be provided to recruiters when high-match candidates enter the system or when candidate engagement actions are required.

In some embodiments, job applicants and job openings may be mapped to embedding vectors using NLP techniques, which allow for the representation of textual data in a high-dimensional vector space like those noted above. These vectors may capture the semantic meaning of the content in resumes, applicant questionnaires, job descriptions, and recruiter questionnaires, facilitating efficient and accurate matching using algorithms like Hierarchical Navigable Small World (HNSW).

In some embodiments, the textual data from resumes and job descriptions may be transformed into embedding vectors using techniques such as Word2Vec, GloVe, or BERT. These models may convert words or phrases into dense, fixed-length vectors, where semantically similar terms are mapped to points that are close together in the vector space. For example, the phrase “software engineer with Python experience” in a resume may be transformed into an embedding vector that captures the proximity of this role to similar roles or skills within the embedding space.

Once the resumes and job descriptions have been mapped to their respective embedding vectors, these vectors may be used to measure similarity between job applicants and job openings. In some embodiments, the similarity measurement may involve calculating the cosine similarity or Euclidean distance between the vectors, where a smaller distance indicates a higher degree of similarity between the applicant's profile and the job requirements.

In some embodiments, the HNSW algorithm may be applied to efficiently match job applicants with job openings in a large dataset. HNSW is an approximate nearest neighbor search algorithm that constructs a graph-like data structure, where each node represents an embedding vector, and edges connect nodes that are close to each other in the vector space. The graph, in some embodiments, is built hierarchically, with multiple layers, where the top layers contain a coarse-grained representation of the vector space, and the bottom layers provide a more fine-grained representation.

When a new job applicant or job opening needs to be matched, in some embodiments, its embedding vector may first be placed in the graph starting from the top layer, navigating through the graph by moving from one node to the closest neighboring node until the nearest neighbor or a set of nearest neighbors is found. This process, in some embodiments, may efficiently identify the most similar vectors in the graph, which correspond to the most relevant job openings or applicants.

By using HNSW, in some embodiments, the matching process may handle large-scale datasets with high-dimensional embeddings, making it scalable and capable of providing real-time recommendations. This method, in some embodiments, also allows for dynamic updates, where new applicants and job postings can be added to the graph without requiring a complete rebuild.

To reduce computational complexity in pairwise comparisons between members of two sets, several techniques may be employed. One approach may be to use Approximate Nearest Neighbor (ANN) algorithms, such as HNSW or Locality-Sensitive Hashing (LSH). These algorithms may find the nearest neighbors with high probability while avoiding exhaustive comparisons. By constructing data structures that support fast retrieval of approximate nearest neighbors, they may significantly reduce the number of necessary comparisons, thereby reducing computational complexity and lowering run-time.

Clustering may be another technique where similar items within each set are grouped together, and comparisons are made only between elements within the same or closely related clusters. For example, k-means clustering may be used to partition both sets, and then comparisons can be limited to items within the same or similar clusters, thereby reducing the overall number of comparisons. This technique may leverage the assumption that items in distant clusters are less likely to be relevant to each other and can be ignored.

In some embodiments, dimensionality reduction methods like Principal Component Analysis (PCA), t-Distributed Stochastic Neighbor Embedding (t-SNE), or Uniform Manifold Approximation and Projection (UMAP) may be applied to reduce the dimensionality of the feature space before performing comparisons. By projecting data into a lower-dimensional space while preserving its essential structure, the computational load of each comparison may be reduced, thereby possibly decreasing the overall computational burden.

Blocking techniques may involve dividing the dataset into blocks or bins based on certain attributes, verifying that comparisons are made only within the same block. In the context of matching job applicants with job openings, blocking may be based on job titles or key skills, so that only applicants and openings within the same block are compared, drastically reducing the number of pairwise comparisons.

In some embodiments, caching or memorization can store the results of previous comparisons to avoid redundant calculations. If the same or similar comparison is encountered again, the cached result may be reused, thereby reducing computational overhead. This approach is particularly useful in iterative algorithms or systems where repeated comparisons are common.

In some embodiments, early stopping criteria may be introduced in the comparison process. For example, if a comparison between two items reveals that they are sufficiently dissimilar based on an initial subset of features, further comparisons can be terminated early, saving computational resources. This technique may be used in decision tree algorithms and other methods where partial evaluation is sufficient for decision-making. Using efficient data structures like kd-trees or ball trees may also reduce the complexity of pairwise comparisons. These structures may allow for efficient partitioning of the search space, facilitating quicker nearest neighbor searches by eliminating large portions of the space that are unlikely to contain relevant matches.

In some embodiments, parallel processing and distributed computing may be utilized to divide the pairwise comparisons across multiple processors or machines. By distributing the workload, the total time required for comparisons may be significantly reduced. Techniques like MapReduce may be particularly effective for this purpose, as they allow the computation to be scaled across large clusters of machines.

In some embodiments, to compute a preference score for matching applicants with job openings, the extracted features from both applicants and job postings may be compared. This comparison may involve calculating similarity measures between the feature sets, such as cosine similarity or Euclidean distance, which quantifies how closely the applicants' qualifications and preferences align with the job requirements. In some embodiments, additional contextual or domain-specific factors may be incorporated into the scoring process, such as weighting certain features more heavily based on their importance to the job or the organization.

The preference score may then be determined by aggregating the similarity measures across the different feature dimensions. This aggregation may involve summing weighted similarity scores, applying a machine learning model trained to predict match quality, or using other statistical methods to combine the features into a single score. The final preference score, in some embodiments, represents the strength of the match between the applicant and the job opening, with higher scores indicating a better fit. This score may be used to rank applicants for a particular job or suggest job openings to applicants, facilitating more efficient and effective matching of candidates to roles. A given applicant's preference score for a given opening, in some cases, may be different from that opening's preference score for the given applicant.

In some embodiments, a preference score may be determined after computing the similarity scores for each pair of applicant and job opening profiles. This preference score may take into account additional factors such as the relative importance of certain skills, experiences, or preferences, which may be weighted differently depending on the job context. In some embodiments, the preference score may be computed as a weighted sum or other aggregation of the similarity measures across different feature dimensions. In some embodiments, machine learning models, such as decision trees, support vector machines, or neural networks, may be trained on historical hiring data to predict the preference score more accurately, considering complex relationships between different features.

The resulting preference scores may be used to rank the applicants for each job opening or to recommend job openings to applicants, with higher scores indicating better matches. In some embodiments, additional filtering or post-processing steps may be applied to account for constraints such as location, availability, or specific requirements that must be met, further refining the matching process.

In some embodiments, clustering algorithms such as k-means or hierarchical clustering may be employed to group similar job applicants and job postings together. These algorithms may identify patterns and similarities within the data, allowing for the grouping of resumes and job descriptions into clusters that reflect shared characteristics, such as similar skill sets, experience levels, or job roles.

K-means clustering may be used to partition a set of applicants and job postings into a specified number of clusters, where each cluster represents a group of similar items. The process, in some embodiments, may begin by representing each applicant and job posting as a numerical vector based on extracted features. These features may include skills, experience, education, and other relevant attributes, which may be derived using NLP techniques like word embeddings or TF-IDF. The algorithm, in some embodiments, first selects a predefined number of cluster centroids, which may be chosen randomly or based on some heuristic. These centroids, in some embodiments, represent the initial centers of the clusters. Each applicant and job posting, in some embodiments, is then assigned to the nearest centroid, where “nearness” may be measured using Euclidean distance, cosine similarity, or the like. This step results, in some embodiments, in the formation of initial clusters, with each cluster containing items that are more similar to each other than to items in other clusters. The centroids of the clusters, in some embodiments, are then recalculated by taking the mean of all items within each cluster. This new centroid, in some embodiments, represents the center of the updated cluster. The steps of assignment and updating, in some embodiments, are repeated iteratively until the centroids stabilize and no longer change significantly, or until a maximum number of iterations is reached. The result, in some embodiments, is a set of clusters, where each cluster contains applicants or job postings that share similar characteristics. For example, one cluster might group applicants with strong programming skills and extensive experience in software development, while another cluster might contain applicants with a background in data analysis and machine learning. Similarly, job postings may be clustered based on required skills and job roles.

Hierarchical clustering, on the other hand, does not require the specification of the number of clusters in advance. Instead, in some embodiments, it builds a hierarchy of clusters that can be visualized as a tree-like structure called a dendrogram. This method may be used to create a nested grouping of applicants and job postings, which can be cut at different levels to produce various numbers of clusters. Hierarchical clustering may start with each applicant or job posting as its own cluster. The algorithm, in some embodiments, then repeatedly merges the two closest clusters based on a chosen distance metric, such as Euclidean distance or cosine similarity. This process, in some embodiments, continues until all items are merged into a single cluster, creating a hierarchical structure from the individual items to the overall grouping. Alternatively, hierarchical clustering may start with all applicants and job postings in a single cluster and then recursively split the cluster into smaller clusters until each item is in its own cluster. The resulting hierarchy can be visualized in a dendrogram, where the height of the branches indicates the distance or dissimilarity between the clusters. By cutting the dendrogram at different levels, different granularities of clustering can be achieved, allowing for flexible grouping of similar applicants and job postings. For example, hierarchical clustering might reveal that applicants can be grouped into broad categories such as “engineering roles” and “management roles,” and within these, further sub-clusters might distinguish between “software engineers” and “hardware engineers” or “project managers” and “product managers.”

The clusters generated by k-means or hierarchical clustering, in some embodiments, can be used to enhance the job matching process. Once applicants and job postings are grouped into clusters, a recruiter may focus on matching applicants within the same cluster as a particular job posting, which increases the likelihood of finding a strong fit. Additionally, the clusters can help in identifying gaps or surpluses in the applicant pool for certain job categories, facilitating more targeted recruitment efforts. Clustering, in some embodiments, can also facilitate personalized recommendations for job applicants by suggesting job openings from the same or similar clusters as their profile, thereby improving the relevance of the job opportunities presented to them.

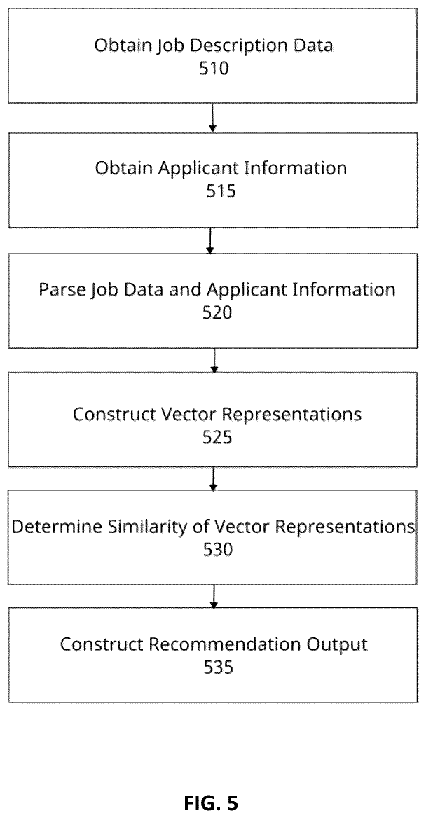

FIG. 5 is a block diagram illustrating a method for automated job search and recruitment. The method may be performed by a computing device and may comprise a sequence of operations for processing applicant and job-related data, determining compatibility, and generating ranked recommendations.

At block 510, the method may begin with obtaining job description data. In some embodiments, the computing device may collect job-related content from one or more sources, which may include external job boards, internal company databases, and publicly available social media profiles. This data may contain unstructured natural language content describing job titles, responsibilities, qualifications, company values, and organizational traits. At block 515, the method may include obtaining applicant information, which may comprise structured and unstructured data such as resume files, professional profiles, and applicant responses to questionnaires or forms. This information may include not only skills and experience, but also personal motivators and preferred work styles supplied by the applicant.

At block 520, the method may proceed to parse the job description data and applicant information using natural language processing techniques. In some embodiments, the computing device may extract structured attributes from the input data, including technical skills, education levels, years of experience, desired autonomy, communication preferences, and cultural alignment factors.

In some embodiments, the method continues at block 525 with constructing vector representations of the extracted candidate and job attributes. In some embodiments, the computing device may use one or more embedding models (such as word embeddings or transformer-based language models) to encode the parsed text into high-dimensional numerical vectors. These embeddings may capture the semantic meaning of the content in a machine-readable format suitable for comparison.

At block 530, the method may include determining the similarity of the vector representations. In some embodiments, the computing device may compute degrees of similarity between the encoded candidate vectors and job vectors using one or more distance or similarity metrics. These similarity scores may reflect how well the attributes of a given candidate align with the attributes of a given job description.

At block 535, the method may include constructing a recommendation output. In some embodiments, the computing device may generate a ranked list of candidate-job pairings based on the computed similarity scores. The output may include a set of job openings ranked for a given applicant, a set of applicants ranked for a given job, or both. These rankings may be suitable for display through applicant-facing or recruiter-facing interfaces.

### AI-Powered Video Analyzer for Compliance Assessment

Some embodiments may provide video content analysis and compliance monitoring. For example, some embodiments may include an artificial intelligence-powered system configured to determine whether video content conforms to organizational policies and applicable legal standards. The system may operate across a range of video formats and content types, including recruiting videos, training materials, or externally facing media, among others.

In some organizational settings, ensuring that video content conforms to relevant internal and external compliance requirements may be an important operational consideration. In some instances, existing review processes may involve human-led evaluation workflows, which may require substantial time and labor resources and may be subject to variability in judgment or interpretation. Accordingly, in some cases, there may be a need for a system that can perform compliance assessments in an automated or semi-automated manner.

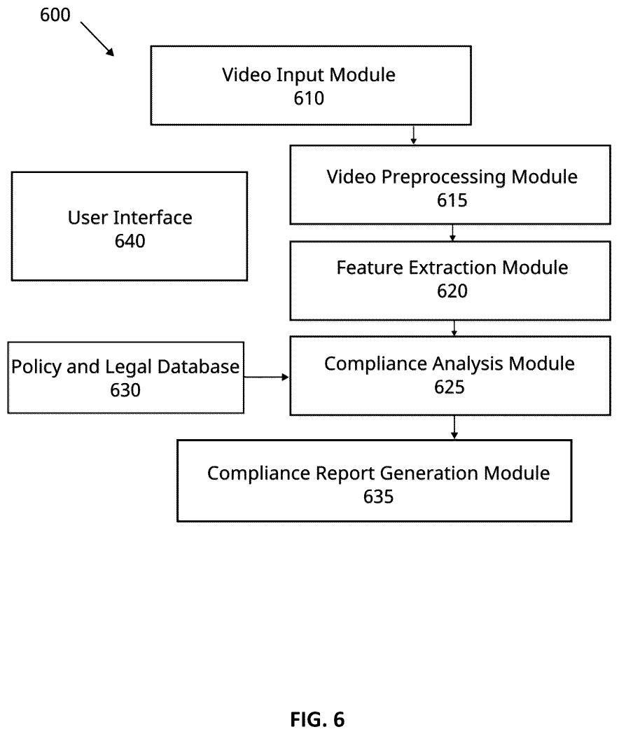

FIG. 6 illustrates an example system 600 for performing AI-powered video content analysis to assess compliance with organizational policies and applicable legal standards. In some embodiments, system 600 may include a series of interconnected processing components that receive, transform, analyze, and report on video data. These components may operate in a distributed computing environment, on a client-server architecture, or on a standalone computing platform. As shown in FIG. 6, system 600 may include a video input module 610 configured to obtain video content for compliance analysis. In some embodiments, the video input module 610 may support receiving pre-recorded video files, accessing video from storage locations, or ingesting live video streams from connected capture devices. The input video may include synchronized audio and visual data, such as speech, visuals, embedded text, or overlays. The input received by the video input module 610 may be provided to a video preprocessing module 615. In some embodiments, the video preprocessing module 615 may transform the raw video to improve signal quality and standardize formatting across diverse content sources. For example, the video preprocessing module 615 may stabilize the video by compensating for frame-to-frame motion, normalize lighting and color balance across frames, and suppress background noise within the audio stream to enhance clarity for speech processing. Following preprocessing, the processed video may be passed to a feature extraction module 620. In some embodiments, the feature extraction module 620 may apply computer vision and audio processing techniques to extract a set of structured content features. These features may include, but are not limited to, detected visual elements (e.g., people, gestures, objects), speech-derived textual content obtained through speech-to-text conversion, and any overlay or embedded text extracted using optical character recognition. The extracted features may be provided as input to a compliance analysis module 625. In some embodiments, the compliance analysis module 625 may evaluate the features with respect to a set of compliance criteria derived from a policy and legal reference database 630. The database 630 may include a data structure or knowledge base comprising company-specific policies, industry codes of conduct, or applicable legal requirements. In some embodiments, the database 630 may be periodically updated to reflect regulatory changes or organizational policy revisions. The compliance analysis module 625 may apply one or more machine learning models trained to identify semantic, contextual, and cross-modal indicators of noncompliance based on these reference materials. The output of the compliance analysis module 625 may be passed to a compliance report generation module 635. In some embodiments, the compliance report generation module 635 may generate a structured report that summarizes the outcome of the analysis, including a determination of whether the analyzed video conforms to applicable policies. In some embodiments, the report may include time-aligned annotations corresponding to video segments where potential violations were detected, along with references to the relevant rules or policy provisions. In some embodiments, the system 600 may also include a user interface 640 that facilitates interaction with the system. The user interface 640 may allow users to upload or select video content, view analysis results, adjust compliance settings, and access generated compliance reports. In some embodiments, the interface may also support role-based access control, visual overlays on flagged video segments, or dashboards summarizing compliance trends across multiple videos or users.

In some embodiments, the system may include a video input module 610 configured to receive video data for compliance analysis. The video input module 610 may support a variety of ingestion workflows, including upload of pre-recorded files, selection of video content from a repository, or streaming of real-time media. In some embodiments, the video input module 610 may interface with local or remote data storage resources, such as cloud-based repositories, content management systems, or enterprise file storage platforms. In some embodiments, the video input module 610 may be configured to support multiple video file formats and encoding standards. For example, supported formats may include, without limitation, MP4, MOV, AVI, MKV, or WebM, and codecs such as H.264, H.265 (HEVC), or VP9. In some embodiments, the module may parse file metadata to extract attributes such as resolution, frame rate, duration, audio channels, and encoding parameters. These attributes may be passed downstream to preprocessing module 615 to inform normalization or filtering decisions.

In some embodiments, the video input module 610 may include an interface by which a user or administrator may specify metadata associated with the uploaded or selected content. For example, the module 610 may support content tagging based on the type or context of the video, such as indicating whether the video is an employee training session, recruiting advertisement, internal corporate communication, or public-facing media. In some embodiments, these content tags may be used to adjust the compliance analysis criteria applied downstream, or to determine routing through different compliance workflows.

In some embodiments, the video input module 610 may include functionality for authenticating users or access requests prior to permitting upload or ingestion. In some embodiments, authentication may be implemented using API keys, user credentials, or integration with identity and access management systems. In some embodiments, access permissions may govern whether users are permitted to upload, review, or label content.

In cases where video content is received as a live stream, the video input module 610 may be configured to buffer real-time data and segment the stream into time-aligned chunks suitable for batch or rolling-window analysis. In some embodiments, the module 610 may include protocol support for live transmission formats, such as Real-Time Messaging Protocol (RTMP), HTTP Live Streaming (HLS), or WebRTC. In such embodiments, streamed video may be piped directly into the video preprocessing module 615 for near-real-time compliance evaluation. In some implementations, the video input module 610 may also extract or receive auxiliary metadata associated with the video content, such as author, date, title, department, or geographic origin. This metadata may be stored with the video or passed alongside to downstream modules for use in tailoring policy lookup or audit trail generation.

In some embodiments, the video input module 610 may perform preliminary validation of uploaded or received content. This may include verifying file integrity, checking for required audio or video tracks, scanning for corrupted segments, or confirming compatibility with downstream processing requirements.

In some embodiments, the video preprocessing module 615 may be configured to enhance the quality and consistency of video content prior to feature extraction and compliance analysis. In some embodiments, the video preprocessing module 615 may receive video data from the video input module 610 and apply one or more processing operations to prepare the content for downstream stages. These operations may be selected to improve clarity, reduce distortion, and standardize the visual and audio signals for more effective analysis.

In some embodiments, the video preprocessing module 615 may include functionality for stabilizing the image sequence to reduce artifacts caused by unintended camera motion. Stabilization may improve the interpretability of visual features by compensating for jitter, shake, or other inconsistencies that occur during video capture. In some embodiments, the video preprocessing module 615 may perform stabilization by analyzing successive frames to estimate relative motion. Motion estimation may be implemented by computing optical flow between pairs of adjacent frames. Optical flow may be derived by evaluating pixel intensity changes over time and identifying motion vectors that describe the apparent movement of scene elements or the camera. These vectors may represent local displacements of pixels or image regions between frames.

In some embodiments, the video preprocessing module 615 may compute optical flow using the Lucas-Kanade method. The Lucas-Kanade method may assume that motion within small image patches is approximately uniform and may solve a set of linear equations to estimate the displacement vectors within those patches. These local motion vectors may then be assembled into a dense or sparse representation of motion across the frame.

In some embodiments, the video preprocessing module 615 may implement various techniques for estimating optical flow between video frames to support stabilization. These techniques may include the Horn-Schunck method, which applies a global smoothness constraint to compute dense motion fields, and Farneback's algorithm, which models local pixel neighborhoods using polynomial approximations. The video preprocessing module 615 may also use a TV-L1 approach that formulates motion estimation as a regularized optimization problem to enhance robustness near motion boundaries and under noisy conditions. In some embodiments, the video preprocessing module 615 may employ a pyramidal optical flow method that estimates motion across multiple spatial resolutions to better capture large displacements. Deep learning-based techniques, such as FlowNet or PWC-Net, may also be used to infer motion vectors from frame pairs using trained convolutional networks, which may improve accuracy in scenes with complex or non-rigid motion. In some embodiments, the video preprocessing module 615 may utilize any one of the discussed optical flow estimation techniques individually or in combination, depending on system constraints or application requirements.

In some embodiments, after computing optical flow, the video preprocessing module 615 may aggregate the resulting motion vectors to estimate a global camera motion model. This aggregation may involve averaging vectors across selected frame regions or applying model fitting techniques to infer consistent global transformations. For example, the video preprocessing module 615 may use the RANSAC (Random Sample Consensus) algorithm to identify and exclude outlier vectors that correspond to object motion or noise, thereby isolating the motion attributable to the camera. The estimated global motion parameters may then be used to apply corrective transformations to the image frames to produce a stabilized output sequence.

In some embodiments, the video preprocessing module 615 may perform lighting normalization to correct exposure variation and achieve consistent visual characteristics across frames. This process may begin with histogram analysis, in which the distribution of pixel intensity values is computed for each frame. The histogram may reveal regions of underexposure or overexposure, as well as contrast compression. Based on this analysis, gamma correction may be applied using a non-linear function such as

$${I}_{out} = {I}_{in}^{γ} ,$$

where γ<1 brightens dark regions and γ>1 darkens overly bright regions. In some embodiments, the gamma parameter may be dynamically adjusted on a per-frame basis to map luminance values into a desired perceptual range.

In some embodiments, the video preprocessing module 615 may further apply histogram equalization to redistribute intensity values. This technique may involve computing the cumulative distribution function (CDF) of the frame's histogram and remapping each pixel's intensity value to align with a uniform distribution. Specifically, pixel intensities may be transformed using the CDF as a look-up table, such that lequalized=CDF(I_{original})×(L−1), where L is the number of intensity levels. Histogram equalization may improve contrast, particularly in low-light or low-dynamic-range regions, and contribute to lighting consistency across temporally adjacent frames.

In some embodiments, the video preprocessing module 615 may apply a Retinex algorithm, which may enhance images by modeling illumination-invariant reflectance properties. The Retinex approach may compute the reflectance R(x,y) at a pixel location (x,y) by evaluating the ratio between the observed intensity I(x,y) and an estimated illumination field L(x,y), such that R(x,y)=log (I(x,y)−log (L(x,y)). The illumination field may be estimated using local averaging, Gaussian filtering, or center-surround techniques. This operation may enhance shadows, normalize illumination gradients, and simulate human perception under varying lighting conditions.

In some embodiments, the video preprocessing module 615 may include color correction functionality to compensate for color temperature shifts and maintain chromatic consistency. The module may estimate the white point of each frame by identifying regions assumed to be neutral gray, and may then apply a transformation to balance the red, green, and blue (RGB) channels. In some embodiments, algorithms such as Gray World Assumption, White Patch Retinex, or shades-of-gray estimators may be used to infer the illuminant. The RGB values may then be scaled inversely relative to the estimated illuminant color to produce a corrected frame where white objects appear color-neutral.

In some embodiments, the above lighting normalization techniques may be used individually or in combination. The video preprocessing module 615 may select or sequence these techniques based on frame-level statistical measures or visual quality assessments. Parameters may be adaptively tuned using heuristics or optimization objectives related to brightness uniformity, contrast entropy, or perceptual similarity.

In some embodiments, the video preprocessing module 615 may perform noise reduction to suppress background artifacts while preserving the clarity of relevant visual content. Background noise may arise from a variety of sources, including low lighting, image sensor limitations, or compression-induced distortions. Such noise may manifest as high-frequency variations in pixel intensity or color, which may degrade the performance of downstream feature extraction models.

In some embodiments, the video preprocessing module 615 may apply spatial filtering to individual video frames to reduce localized noise. Spatial filtering may involve convolution-based operations such as Gaussian blur, which attenuates high-frequency components by applying a weighted average centered on each pixel, where the weights decay with distance. In some embodiments, a median filter may be used to replace each pixel's value with the median of its surrounding neighborhood, which may be effective for removing salt-and-pepper noise. The size of the filter kernel may be selected statically or adaptively, and in some embodiments, edge-preserving filters may be applied to retain structural detail while suppressing noise.

In some embodiments, the video preprocessing module 615 may apply temporal filtering techniques that leverage frame-to-frame coherence. For instance, frame averaging may be performed by aligning and averaging pixel values over a temporal window to suppress transient noise while retaining persistent features. In some embodiments, a Kalman filter may be used to model the expected evolution of pixel intensity over time. The Kalman filter may predict the value of a pixel based on prior observations and update this estimate as new frame data becomes available, thereby smoothing noisy fluctuations.

In some embodiments, the video preprocessing module 615 may employ non-local means (NLM) filtering, which identifies and averages self-similar patches across spatial or temporal neighborhoods. Unlike local filters, NLM filtering may exploit repeated textures or structures in different regions of the frame or across adjacent frames, providing more effective noise reduction in scenes with fine detail or subtle gradients.

In some embodiments, the video preprocessing module 615 may utilize machine learning-based denoising, such as a convolutional neural network trained to separate noise from signal. The model may be trained on paired datasets of noisy and clean video frames and may learn to suppress structured and unstructured noise patterns while retaining fine textures and edges. Once trained, the network may be applied to incoming frames in real time or batch mode.

In some embodiments, the video preprocessing module 615 may select one or more of the above techniques based on characteristics of the input content, such as estimated noise level, frame rate, motion, or contrast. Parameters for each technique may be dynamically adjusted during processing to maximize noise suppression while preserving perceptually important features.

In some embodiments, certain pre-processing tasks performed for video captured on a mobile client computing device may be offloaded to the device itself to reduce the computational load on a server, reduce bandwidth, reduce latency, and optimize the overall processing pipeline. These pre-processing tasks may include video stabilization, normalization of lighting conditions, removal of background noise, and cropping to eliminate extraneous background information.

To efficiently perform these tasks on resource-constrained mobile devices, lightweight neural network architectures such as MobileNetV2 or V3 may be employed. Some embodiments may use depthwise separable convolutions to reduce the computational complexity compared to traditional convolutional layers by separating the convolution operation into a depthwise convolution followed by a pointwise convolution. This approach may reduce the number of parameters and the amount of computation involved, making it feasible to run real-time video processing tasks directly on mobile devices.

In some embodiments, these pre-processing tasks may be further accelerated by leveraging dedicated AI co-processors available on the mobile computing devices. For example, Apple's devices may include a Neural Engine, which is optimized for performing machine learning tasks with low power consumption, while Google Pixel devices may include the Tensor Processing Unit (TPU), designed to accelerate machine learning workloads on the device. These co-processors may handle tasks such as running MobileNet models for video stabilization, lighting normalization, noise reduction, and cropping, allowing the client device to perform complex pre-processing tasks efficiently without heavily impacting battery life or performance. By offloading these tasks to the client device, the server may focus on more resource-intensive operations, such as gesture or facial expression recognition, thereby improving the overall system's performance (which is not to suggest that embodiments are limited to systems that afford this or any other benefit described herein). In some cases, some of the below feature extraction techniques may also be performed by the mobile computing device, with results fed to the server.

In some embodiments, the feature extraction module 620 may be configured to process incoming video data to derive structured features from multiple content modalities, including audio, visual, and textual elements. The features extracted by the feature extraction module 620 may be used as inputs to the compliance analysis module 625 for determination of whether the video content conforms to relevant organizational policies or legal requirements. The feature extraction module 620 may operate in real time on streaming video or in batch mode for stored video files, and may employ GPU acceleration, parallel processing, or distributed execution to increase throughput.

In some embodiments, for audio feature extraction, the feature extraction module 620 may first segment the audio stream into analysis windows aligned with video frame timing or other predefined intervals. Each audio segment may be processed using spectral analysis to identify characteristic frequency distributions, amplitude envelopes, and harmonic structures. In some embodiments, Mel-frequency cepstral coefficients (MFCCs) may be computed from the short-time Fourier transform (STFT) of the signal to produce compact feature vectors representing the timbral and phonetic qualities of speech. These features may be passed to an automatic speech recognition (ASR) system, which may be implemented using recurrent neural networks (RNNs), transformer-based encoders, or hybrid acoustic-language models to generate transcriptions. The module may further perform keyword spotting to detect the presence of terms or phrases that correspond to policy-defined trigger words. Additional audio analysis may include pitch tracking, prosody analysis, and speaker diarization to attribute speech segments to specific individuals or roles, as well as detection of non-speech acoustic events, such as background music or crowd noise, which may have compliance implications.

In some embodiments, for visual feature extraction, the feature extraction module 620 may analyze individual frames or sequences of frames to detect objects, scenes, or activities that are considered prohibited or high-risk under applicable policies. In some embodiments, this process may involve the application of convolutional neural networks (CNNs), vision transformers (ViTs), or 3D convolutional models trained to classify frame content. In some embodiments, the models may be trained on large-scale datasets and fine-tuned using policy-specific imagery to recognize domain-relevant categories. Detected elements may include specific objects (e.g., weapons, restricted symbols), visual cues (e.g., particular color combinations associated with branding violations), or human behaviors (e.g., hand gestures or physical actions). In some embodiments, the feature extraction module 620 may incorporate object tracking algorithms, such as SORT or DeepSORT, to maintain identity continuity of detected objects across multiple frames, facilitating behavioral analysis over time.

In some embodiments, for text overlay extraction, the feature extraction module 620 may apply optical character recognition (OCR) to detect and extract alphanumeric content appearing within the video frames. In some embodiments, OCR processing may include preprocessing steps such as binarization, deskewing, noise removal, and contrast enhancement to improve text detection accuracy. The OCR system may operate on entire frames or on regions of interest identified by text localization algorithms, such as EAST or CTPN. Extracted text strings may then be analyzed using natural language processing (NLP) pipelines to identify potentially noncompliant language. In some embodiments, the NLP analysis may include keyword and phrase detection, sentiment scoring, named entity recognition (NER), and syntactic parsing. In some embodiments, the extracted textual content may be cross-referenced with the corresponding audio transcript to verify alignment, detect discrepancies, or assess context. For example, the system may determine whether a subtitle matches the spoken content and whether either form contains policy-sensitive language.

In some embodiments, the feature extraction module 620 may produce synchronized, multimodal feature vectors that combine audio, visual, and text-based attributes for each segment of the video. These multimodal feature representations may be formatted to facilitate ingestion by downstream machine learning models in the compliance analysis module 625, facilitating context-aware, cross-modal decision-making. The feature extraction module 620 may also annotate extracted features with temporal metadata, spatial coordinates, or detection confidence scores to support fine-grained compliance reporting and explainable AI outputs.

In some embodiments, the policy and legal database 630 may store a comprehensive set of policy rules, legal requirements, and regulatory guidelines relevant to the compliance analysis of video content. The policy and legal database 630 may serve as a central reference source for the compliance analysis module 625, supporting the automated evaluation of extracted features against defined compliance criteria. The information stored in the policy and legal database 630 may cover all categories of issues that could render a video non-compliant, including but not limited to prohibited language, restricted imagery, unapproved branding, discriminatory content, privacy violations, or regulatory breaches.

In some embodiments, the policy and legal database 630 may be updated on a regular basis to reflect changes in applicable laws, industry standards, or organizational policy frameworks. Updates may be applied manually by authorized compliance officers, or automatically by synchronizing with external data sources such as legal code repositories, HR management systems, or regulatory bulletins. The database may store historical versions of policy rules, allowing compliance analysis to be performed against the policy set in effect at the time a video was created or distributed.

In some embodiments, the policy and legal database 630 may store information in multiple encoding formats to support different processing workflows. For example, policies may be stored as natural language text (such as excerpts from employee handbooks, codes of conduct, or legal statutes) for direct human review and NLP-based automated processing. In other embodiments, policies may be stored as machine-readable rules in a structured format, such as JSON, XML, or domain-specific policy definition languages. These structured representations may permit deterministic rule-based evaluation by the compliance analysis module 625 and may also serve as a source for generating labeled datasets used in training machine learning models.

In some embodiments, the policy and legal database 630 may include metadata associated with each policy entry, such as jurisdiction, effective date, source authority, enforcement priority, and applicable content categories. This metadata may allow the compliance analysis module 625 to filter or prioritize rules based on the specific context of the video being processed.

In some embodiments, the policy and legal database 630 may be deployed in different architectural configurations. In some embodiments, the data base may be deployed in a distributed architecture. In a distributed architecture, the database may be sharded or replicated across multiple servers or data centers, allowing geographically separated compliance analysis modules 625 to query local copies of the policy data for reduced latency and increased fault tolerance. In some embodiments, the data base may be deployed in a remote architecture. In a remote architecture, the policy and legal database 630 may reside in a centralized cloud environment, with the compliance analysis module 625 or other authorized systems accessing it via secure network connections and authenticated APIs. In some embodiments, the data base may be deployed in a physically connected architecture. In a physically connected architecture, the policy and legal database 630 may be hosted on the same physical hardware as the compliance analysis module 625, allowing high-speed inter-process communication and reducing reliance on network connectivity. The selection of architecture may depend on organizational requirements for performance, scalability, redundancy, and security. In some embodiments, the policy and legal database 630 may be implemented using any single one of the described architectures or a combination thereof, with hybrid configurations supporting both local and remote access patterns.

In some embodiments, the policy and legal database 630 may be implemented using relational or graph-based architectures to support rapid queries and semantic associations between related policy provisions. The database may provide full-text search, pattern matching, and ontology-based queries to improve retrieval when matching extracted features to stored rules. In some embodiments, the database may be linked to machine learning pipelines, allowing the automated suggestion of new or revised rules based on emerging content patterns, newly issued regulations, or changes to organizational guidelines.

In some embodiments, the AI analysis module 625 may apply a variety of machine learning approaches to evaluate multimodal content extracted from video data, including audio, text, and visual elements, to determine compliance with defined organizational policies and applicable legal standards. These approaches may include NLP for interpreting linguistic content, object recognition for identifying policy-relevant or prohibited imagery, and action recognition for detecting human behaviors classified as inappropriate under applicable rules. The AI analysis module 625 may be trained using datasets of labeled video segments that have been pre-classified as compliant or non-compliant based on the relevant policy framework, allowing the system to learn patterns of features that correlate with compliance determinations.

In some embodiments, the AI analysis module 625 may process audio and text data by applying NLP algorithms to detect and classify policy-relevant content. The audio stream may be transcribed to text using speech-to-text processing, which may include acoustic modeling, language modeling, and decoding stages. Once transcribed, the textual content may undergo NLP operations such as tokenization, lemmatization, part-of-speech tagging, and dependency parsing. The AI analysis module 625 may then perform tasks such as keyword detection, phrase matching, semantic similarity analysis, and sentiment classification to identify words, expressions, or inferred attitudes that align with predefined compliance or non-compliance indicators. In some embodiments, contextual models such as transformer-based language models may be used to assess the surrounding context of identified terms to reduce false positives and improve policy alignment. Detected entities or concepts may be mapped to policy provisions retrieved from the policy and legal database 630, and classification outputs may be associated with timecodes to support downstream compliance reporting.

In some embodiments, the AI analysis module 625 may perform visual analysis using object recognition and scene classification techniques to identify visual elements within the video frames that may be relevant to compliance evaluation. The object recognition process may include segmenting individual frames or regions of interest and applying trained deep learning models, such as CNNs, region-based convolutional neural networks (R-CNNs), or ViTs, to classify detected elements. In some embodiments, object recognition may be configured to detect and label prohibited items, symbols, logos, or other visual features identified as non-compliant in the policy and legal database 630. The AI analysis module 625 may also incorporate object tracking algorithms, such as Kalman filtering, SORT, or DeepSORT, to maintain persistent identities of detected objects across consecutive frames. This temporal linking of detections may allow the system to assess spatial and temporal context, such as whether a prohibited object is being used, displayed, or exchanged in a way that constitutes a violation.

In some embodiments, the AI analysis module 625 may also include an action recognition component configured to detect non-compliant movements or behaviors by analyzing sequences of video frames. The action recognition process may utilize temporal modeling architectures such as recurrent neural networks (RNNs), long short-term memory (LSTM) networks, gated recurrent units (GRUs), temporal convolutional networks (TCNs), or 3D convolutional neural networks (3D CNNs) that are capable of modeling the sequential nature of video data. In some embodiments, the detected actions may be compared against a database of labeled examples representing known compliant and non-compliant behaviors, with classification based on similarity measures or learned decision boundaries. Action recognition may incorporate multimodal cues, combining visual motion features (e.g., optical flow) with synchronized audio or text overlays to improve accuracy, particularly in cases where behaviors are context-dependent. The output of this process may include time-aligned annotations identifying the start and end of a detected action, its classification, and a confidence score, which may be used by the compliance report generation module 635.

In some embodiments, the AI analysis module 625 may employ one or more CNNs for the processing and analysis of visual data, including but not limited to image frames, frame sequences, or derived feature maps. While CNNs may be suitable for visual content, their architecture may also be adapted to other structured data domains, such as spectrograms for audio analysis or spatially organized sensor data. CNNs may progressively transform raw input values into higher-level, abstract representations by passing data through a series of convolutional layers, nonlinear activation functions, and pooling layers. These progressively abstracted feature maps may allow the network to capture increasingly complex spatial and semantic patterns, which can be used for tasks such as classification, detection, segmentation, or tracking within the compliance analysis pipeline.

In some embodiments, the initial processing stage of a CNN may involve a convolution operation. During convolution, a set of learnable filters (also known as kernels) may be applied to the input data in a sliding-window fashion. Each filter may be represented as a small matrix of weights, which may be tuned during training to detect particular local structures such as edges, curves, or texture patterns. At each spatial position, the filter may be multiplied element-wise with the corresponding portion of the input, and the results may be summed to produce a scalar output value. This process may be repeated across the entire spatial extent of the input, resulting in a feature map that encodes the activation of that filter at each location. In some embodiments, a single convolutional layer may consist of multiple filters, each producing its own feature map, allowing the CNN to capture a diverse set of local patterns simultaneously. Padding, stride adjustments, and dilation rates may be applied to control the spatial resolution and receptive field size of each feature map.

In some embodiments, the feature maps generated by the convolutional layers may be passed through one or more activation functions to introduce non-linearity into the model. One common activation is the Rectified Linear Unit (ReLU), which outputs zero for negative inputs and leaves positive inputs unchanged. By introducing non-linearity, the CNN may model complex, non-linear relationships between input features and output predictions, allowing it to detect patterns that linear transformations cannot capture. Alternative activations, such as leaky ReLU, parametric ReLU, or GELU (Gaussian Error Lincar Unit), may be used depending on training stability and performance requirements.

In some embodiments, the CNN may incorporate pooling layers to reduce the spatial dimensions of feature maps while preserving the most salient information following convolution and activation. This downsampling may reduce computational complexity, limit overfitting, and improve the network's robustness to spatial variations such as translation, scaling, or minor rotation of input objects. In some embodiments, max pooling may be applied, which selects the maximum value within each pooling region, whereas average pooling may compute the mean value in the region. Pooling kernels and strides may be tuned to control the degree of spatial reduction.

In some embodiments, later stages of the CNN may include fully connected layers, in which every neuron in the current layer is connected to every neuron in the previous layer. These dense layers may integrate spatially distributed features into a global representation that supports decision-making for classification or regression tasks. For classification, the output of the final fully connected layer may be passed through a softmax function to produce a probability distribution over the defined output classes, where each class may correspond to a compliance-relevant label (e.g., “contains prohibited object” or “no violation detected”).

In some embodiments, the CNN may be trained using large datasets that reflect the visual scenarios relevant to policy compliance detection. The network weights, including filter coefficients, may be updated by minimizing a loss function (e.g., cross-entropy for classification, mean squared error for regression, or focal loss for class imbalance scenarios) using backpropagation in combination with optimization algorithms such as stochastic gradient descent (SGD), Adam, RMSProp, or variants thereof. Regularization methods such as dropout, weight decay, and data augmentation (e.g., random cropping, flipping, color jitter, and Gaussian noise) may be applied to improve generalization and reduce overfitting. Transfer learning may be used to initialize the CNN with weights pretrained on large-scale datasets (e.g., ImageNet) before fine-tuning on policy-specific video datasets, thereby reducing the amount of labeled data required for effective training.

In some embodiments, CNN variants may be employed to address specific challenges in video-based compliance detection. For example, 3D CNNs may extend the convolution operation into the temporal dimension, allowing the model to learn spatiotemporal features directly from short frame sequences. Dilated convolutions may be used to expand the receptive field without increasing the number of parameters, facilitating the detection of large-scale patterns such as background scenes or group actions. Residual networks (ResNets) may incorporate skip connections to facilitate the training of very deep architectures, while inception-style architectures may apply multiple convolutional filter sizes in parallel to capture multi-scale patterns.

In some embodiments, the CNN processing within the AI analysis module 625 may be deployed for inference in environments with varying compute constraints. High-performance GPU or TPU acceleration may be used in server-side deployments to handle large-scale compliance evaluation workloads, while optimized lightweight CNN architectures such as MobileNet or EfficientNet may be employed for on-device inference in client-side or edge scenarios. Quantization, pruning, and knowledge distillation techniques may further reduce model size and computation time while maintaining acceptable accuracy for compliance-related tasks.

In some embodiments, the AI analysis module 625 may employ a ViT architecture in place of, or in combination with, a convolutional neural network for image or video processing tasks. Vision Transformers may adapt the transformer framework, originally developed for natural language processing tasks, to handle visual data. Unlike CNNs, which learn spatial features through convolutional filters applied locally across an image, ViTs may treat an image as a sequence of fixed-size patches and process these patches using a transformer architecture. This approach may allow the model to capture relationships between distant regions of an image without relying on the locality bias inherent in convolution operations.

In some embodiments, the ViT processing pipeline may begin by dividing the input image into a grid of small, non-overlapping patches of equal size, such as 16×16 or 32×32 pixels per patch. Each patch may then be flattened into a one-dimensional vector by concatenating its pixel values across the color channels. The flattened patch vectors may be projected into a higher-dimensional embedding space using a learnable linear transformation, producing a sequence of patch embeddings. Because transformers do not inherently encode spatial structure, positional encodings (either fixed or learnable) may be added to the patch embeddings to retain information about each patch's location within the original image. These positional encodings may allow the ViT to reason about relative and absolute positions, which is critical for spatially coherent interpretation.

In some embodiments, the resulting sequence of embedded patches, augmented with positional information, may be input into a transformer encoder consisting of multiple stacked layers. Each layer may include a multi-head self-attention mechanism and a position-wise feedforward neural network. The self-attention mechanism may compute a set of attention scores for each patch relative to all other patches, allowing the network to selectively focus on relevant regions regardless of their spatial distance. This global receptive field may allow the ViT to model long-range dependencies and aggregate context from disparate regions, which can be challenging for CNNs with limited receptive fields unless they are very deep or employ dilated convolutions.

In some embodiments, the self-attention mechanism may project each patch embedding into three separate learned representations: queries (Q), keys (K), and values (V). Attention scores may be computed by taking scaled dot-products of Q and K vectors, applying a softmax normalization to produce a weight distribution, and using these weights to compute weighted sums of the V vectors. The multi-head attention setup may run several attention mechanisms in parallel, each capturing different relational patterns between patches. The outputs from the multiple heads may be concatenated and passed through a linear projection before being fed into the feedforward network. Residual connections and layer normalization may be applied around both the self-attention and feedforward sublayers to stabilize training and improve gradient flow.

In some embodiments, the transformer layers may be repeated to form a deep stack, allowing progressively richer feature representations to be learned. A special classification token ([CLS]) may be prepended to the sequence of patch embeddings before entering the first transformer layer. This token's embedding, updated through each layer via self-attention interactions with the other patch embeddings, may serve as a global summary representation of the entire image or frame. At the output of the final transformer layer, the [CLS] embedding may be passed to a classification head, typically implemented as a fully connected layer, to produce task-specific outputs. For classification problems, the classification head may output a probability distribution over the target classes, such as compliance categories or object/action labels.

In some embodiments, ViTs may be trained from scratch on very large labeled datasets, or they may be initialized from pretrained weights obtained from large-scale image datasets (e.g., ImageNet-21k, JFT-300M) and then fine-tuned on policy-specific datasets. Because ViTs tend to require more data to achieve optimal performance than CNNs due to the absence of an inductive bias toward local spatial structures, transfer learning and extensive data augmentation (e.g., patch shuffling, random resizing, color jittering) may be employed to improve generalization. In some embodiments, a ViT may be extended to a TimeSformer or other spatiotemporal transformer variant, in which attention is computed jointly or factorized across spatial and temporal dimensions to model motion and appearance simultaneously in video analysis contexts.

In some embodiments, the VIT within the AI analysis module 625 may operate as a standalone vision backbone, or it may be integrated into a hybrid architecture where CNN-based early layers extract low-level features that are then fed into transformer layers for global reasoning. This hybrid approach may reduce the data and compute requirements of a pure ViT while retaining its ability to capture long-range dependencies. The ViT may be deployed for server-side high-throughput inference using GPUs or TPUs, or optimized via model distillation, quantization, or pruning for execution on edge devices in scenarios where compliance evaluation is performed close to the data source.

In some embodiments, one of the advantages of using a Vision Transformer within the AI analysis module 625 compared to a convolutional neural network may be the ViT's inherent ability to model global context across an image. Whereas CNNs capture local patterns using convolutional filters with a limited receptive field (requiring multiple stacked layers to gradually incorporate broader spatial relationships) a ViT may compute self-attention scores between every patch in an image simultaneously. This direct modeling of long-range dependencies may allow the ViT to better capture relationships between spatially distant elements, such as recognizing a prohibited gesture in one region of a frame and associating it with a contextually relevant object in another. In some embodiments, this global receptive field may be beneficial in compliance detection tasks where relationships between distant visual features contribute to determining whether a violation has occurred. The capacity to process all patches in parallel may also facilitate scaling the model to large datasets, where it can learn complex, non-local patterns that would otherwise require deeper convolutional hierarchies.

Vision Transformers may require substantially more training data to achieve optimal performance compared to CNNs. This requirement may arise from the fact that ViTs do not incorporate the inductive bias of spatial locality and translation invariance that is inherently built into convolutional architectures. Without this bias, the model must rely entirely on learning spatial relationships from data, which may make it more data-hungry. To address this, some embodiments may pretrain the ViT in the AI analysis module 625 on a large-scale general-purpose image dataset, such as ImageNet-21k or proprietary domain-specific corpora, before being fine-tuned on compliance-specific datasets. Fine-tuning may involve adjusting the pretrained parameters to the statistical and semantic properties of the target domain, allowing the ViT to leverage the broad visual knowledge acquired during pretraining while adapting to specialized tasks, such as detecting policy-relevant imagery or actions. In some embodiments, additional techniques such as data augmentation, self-supervised pretraining, and knowledge distillation may be employed to further improve performance in cases where compliance-specific labeled data is limited.

In some embodiments, the AI analysis module 625 may incorporate recurrent neural networks (RNNs) to process sequential data, such as audio waveforms, speech transcriptions, or sequences of visual frames. Unlike feedforward neural networks, which process each input independently without regard to order, an RNN is designed to capture temporal dependencies by maintaining an internal memory representation that evolves as it processes the sequence element-by-element. This architecture makes RNNs particularly well-suited to tasks in which the order and timing of information are important, such as language modeling, time-series prediction, sequential event classification, and speech recognition for compliance monitoring.

In some embodiments, an RNN may include recurrent layers that operate iteratively on the elements of an input sequence. At each time step t, the network may take as input both the current element xₜ and a hidden state vector hₜ₋₁ propagated from the previous step. These two inputs may be combined through learned weight matrices and a nonlinear activation function to produce an updated hidden state hₜ and, in some cases, an output vector yₜ corresponding to that time step. This iterative process may allow the RNN to integrate information from earlier elements of the sequence into its current state, effectively constructing a representation of the sequence's history.

In some embodiments, the hidden state acts as a form of memory, encoding relevant aspects of all previously seen inputs up to the current time step. This memory mechanism may allow the RNN to recognize dependencies in the data that span multiple steps. For example, in processing a sentence from a transcript, the RNN may use its hidden state to retain contextual information about earlier words, allowing it to correctly interpret the meaning of later words that depend on that context. Similarly, in visual sequence analysis, the hidden state may preserve information about preceding frames to support recognition of an ongoing action.

In some embodiments, one challenge in training standard RNNs may lie in their ability to learn long-term dependencies, where information from far earlier in the sequence significantly influences later outputs. This difficulty may result from the vanishing or exploding gradient problem during backpropagation through time (BPTT). When computing parameter updates across many time steps, the repeated multiplication of gradients may cause them to shrink toward zero (vanishing) or grow uncontrollably (exploding), impairing the network's ability to capture dependencies that extend beyond a relatively short time window.

In some embodiments, to address these limitations, the AI analysis module 625 may employ more advanced recurrent architectures such as LSTM networks or GRUs. These architectures introduce gating mechanisms that regulate the flow of information into, through, and out of the hidden state, allowing the network to selectively retain or discard information over long sequences. LSTMs and GRUs may therefore maintain relevant information over longer time horizons, making them well-suited for tasks such as detecting multi-step gestures, analyzing conversational context, or tracking complex visual activities for compliance evaluation. In some embodiments, the AI analysis module 625 may incorporate recurrent neural networks (RNNs) to process sequential data, such as audio waveforms, speech transcriptions, or sequences of visual frames. Unlike feedforward neural networks, which process each input independently without regard to order, an RNN is designed to capture temporal dependencies by maintaining an internal memory representation that evolves as it processes the sequence element-by-element. This architecture may make RNNs well-suited to tasks in which the order and timing of information are important, such as language modeling, time-series prediction, sequential event classification, and speech recognition for compliance monitoring.

In some embodiments, an RNN may include recurrent layers that operate iteratively on the elements of an input sequence. At each time step t, the network may take as input both the current element xₜ and a hidden state vector hₜ₋₁ propagated from the previous step. These two inputs may be combined through learned weight matrices and a nonlinear activation function to produce an updated hidden state hₜ and, in some cases, an output vector yₜ corresponding to that time step. This iterative process may allow the RNN to integrate information from earlier elements of the sequence into its current state, effectively constructing a representation of the sequence's history.

In some embodiments, the hidden state may act as a form of memory, encoding relevant aspects of all previously seen inputs up to the current time step. This memory mechanism allows the RNN to recognize dependencies in the data that span multiple steps. For example, in processing a sentence from a transcript, the RNN may use its hidden state to retain contextual information about earlier words, allowing it to correctly interpret the meaning of later words that depend on that context. Similarly, in visual sequence analysis, the hidden state may preserve information about preceding frames to support recognition of an ongoing action.

In some embodiments, one challenge in training standard RNNs may lie in their ability to learn long-term dependencies, where information from far earlier in the sequence significantly influences later outputs. This difficulty may result from the vanishing or exploding gradient problem during backpropagation through time (BPTT). When computing parameter updates across many time steps, the repeated multiplication of gradients can cause them to shrink toward zero (vanishing) or grow uncontrollably (exploding), impairing the network's ability to capture dependencies that extend beyond a relatively short time window.

In some embodiments, to address these limitations, the AI analysis module 625 may employ more advanced recurrent architectures such as LSTM networks or GRUs. These architectures may introduce gating mechanisms that regulate the flow of information into, through, and out of the hidden state, allowing the network to selectively retain or discard information over long sequences. LSTMs and GRUs may therefore maintain relevant information over longer time horizons, making them well-suited for tasks such as detecting multi-step gestures, analyzing conversational context, or tracking complex visual activities for compliance evaluation.

In some embodiments, the AI analysis module 625 may employ LSTM networks to improve the modeling of long-term dependencies in sequential data. LSTMs extend the basic recurrent neural network architecture by introducing a more sophisticated memory cell structure designed to mitigate the vanishing gradient problem and to allow information to persist across many time steps. This persistence may be managed through a set of gates (the input gate, forget gate, and output gate) that regulate the flow of information into, within, and out of the memory cell.

In some embodiments, the input gate may determine the degree to which new information from the current input and the previous hidden state should be written into the memory cell. The forget gate may determine which portions of the existing cell state should be discarded, allowing the LSTM to remove irrelevant or outdated information while preserving context that remains useful for future predictions. The output gate may regulate which parts of the cell state are exposed as the hidden state for the current time step, thereby influencing both the model's output and the information propagated forward in time. By learning these gating parameters during training, the LSTM may dynamically adjust its memory retention behavior, selectively carrying forward key contextual signals and discarding noise. In some embodiments, this capability may be valuable for compliance analysis tasks involving long sequences, such as detecting multi-step gestures, identifying patterns in extended conversations, or recognizing evolving visual activities in video footage.

In some embodiments, the AI analysis module 625 may alternatively employ GRUs, which may be a streamlined variant of the LSTM designed to reduce computational complexity while retaining the ability to capture long-term dependencies. GRUs may simplify the architecture by merging the functionality of the input and forget gates into a single update gate, which determines the balance between retaining information from the previous hidden state and incorporating new input. GRUs also include a reset gate, which controls how much of the past information to consider when computing the new candidate hidden state. This reduced gating structure may result in fewer parameters and faster training times, making GRUs advantageous in scenarios with limited computational resources, low-latency requirements, or smaller datasets. Despite their simpler design, GRUs have demonstrated competitive performance with LSTMs in many sequence modeling tasks and may be used in the AI analysis module 625 to process sequential audio, text, or visual signals where efficiency is a priority.

In some embodiments, the AI analysis module 625 may employ contrastive learning where compliance-related events or behaviors occur infrequently and labeled examples may be limited. In some embodiments, contrastive learning may operate by learning a representation space in which similar examples are embedded close together, while dissimilar examples are positioned farther apart. This framework may allow the AI analysis module 625 to uncover and encode the underlying structure of the data, thereby producing feature embeddings that are both robust and generalizable, even when the quantity of supervised training data is constrained.

In some embodiments, the process may begin by processing individual video frames or sequences of frames through the feature extraction module 620 to generate feature vectors that capture relevant spatial and temporal attributes. In some embodiments, these attributes may include pose, gesture trajectory, facial expression, object configuration, and background context for visual content. In some embodiments, they may include tone, pitch contour, inflection patterns, and prosodic features for audio content. In some embodiments, cross-modal feature fusion may be applied to combine cues from different modalities into a unified representation for multimodal inputs. These feature vectors may then be paired or grouped into anchor-positive-negative sets for use within a contrastive learning framework.

In some embodiments, contrastive learning may label relationships between feature vectors as either positive pairs (representing similar gestures, expressions, or behaviors) or negative pairs (representing dissimilar instances). A contrastive loss function, such as triplet loss, InfoNCE loss, or NT-Xent loss, may be applied to encourage the network to minimize the distance between positive pairs while maximizing the separation between negative pairs. In the case of triplet loss, the system may use an anchor vector representing a specific instance, a positive vector corresponding to another instance of the same class or behavioral category, and a negative vector corresponding to a different class or behavioral category. The learning objective may be to pull the anchor and positive vectors closer together in the embedding space while pushing the anchor and negative vectors farther apart.

In some embodiments, the effectiveness of contrastive learning may be enhanced through data augmentation, which may artificially expand the set of positive pairs by applying transformations to existing examples. Such transformations may include geometric adjustments (e.g., rotation, scaling, cropping), photometric changes (e.g., brightness shifts, color jittering, lighting modifications), temporal adjustments (e.g., speed variation, frame skipping, temporal cropping), or audio transformations (e.g., pitch shifting, time stretching, background noise addition). These augmented variations may be treated as positives for their original example, reinforcing the model's ability to recognize semantically equivalent content despite superficial differences in appearance, sound, or timing.

In some embodiments, temporal sequence modeling may be integrated into the contrastive learning process to account for dynamic features in gestures, facial expressions, and other compliance-relevant behaviors. By applying temporal encoders (e.g., LSTMs, GRUs, temporal convolutional networks, or transformer-based sequence models) the system may capture the evolution of actions over time, allowing it to distinguish between superficially similar but contextually different behaviors. For example, a gesture performed in an aggressive manner versus a neutral one may be differentiated by analyzing motion speed, posture transition, and accompanying audio tone.

In some embodiments, the output of the contrastive learning stage may be a low-dimensional embedding space in which compliance-relevant similarities and differences are geometrically represented. In some embodiments, these embeddings may be fed into downstream classifiers, clustering algorithms, or rule-based systems to identify and label gestures, expressions, or behaviors according to compliance criteria. In some embodiments, a feedback loop may also be incorporated into the training pipeline, whereby misclassified or borderline cases identified during evaluation are reintroduced into the contrastive learning process with corrected labels. This iterative refinement may allow the embedding space to become increasingly discriminative, improving the AI analysis module's ability to separate visually or acoustically similar instances that may be distinct compliance-wise.

In some embodiments, the AI analysis module 625 may be implemented using a transformer architecture, which may be well-suited for processing sequential or structured data across multiple modalities, including text, audio, and visual information represented as sequences of image patches or frame embeddings. In some embodiments, transformers may operate by applying self-attention mechanisms to the input data, allowing the model to assign varying levels of importance to different elements within the sequence when generating predictions. This ability to model pairwise relationships between all sequence elements directly, regardless of their relative position, may allow the transformer to capture both local and global dependencies efficiently, making it well-suited for compliance evaluation tasks where context is distributed across the input.

In some embodiments, implementing the AI analysis module 625 as a transformer may begin with encoding the input data into a sequence of embeddings. For text and audio, this may involve converting words, subwords, phonemes, or other linguistic units into dense vector representations via embedding layers trained from scratch or initialized from pretrained models. For visual data, video frames may be divided into patches (e.g., 16×16 pixels) or processed into region-of-interest crops, which may then be flattened and projected into an embedding space via linear layers or convolutional projection modules. Temporal information in video may be encoded by appending frame position embeddings, while spatial relationships between patches may be captured through learned or sinusoidal positional encodings.

In some embodiments, the transformer may process these embeddings through multiple encoder layers, each consisting of a multi-head self-attention mechanism and a position-wise feed-forward neural network. The self-attention mechanism may compute attention weights by projecting embeddings into query, key, and value spaces and measuring compatibility between queries and keys to determine how much each element should attend to others in the sequence. Multi-head attention may run multiple attention operations in parallel, facilitating capture of different types of relationships simultaneously (e.g., syntactic, semantic, spatial, or temporal). Residual connections, layer normalization, and dropout may be used within each layer to stabilize training and improve generalization.

In the context of NLP, the transformer may process text obtained from audio transcriptions or extracted text overlays to identify keywords, phrases, sentiments, or inferred intents that indicate compliance or non-compliance with defined policies. The self-attention layers may allow the model to detect not only the presence of certain terms but also the surrounding linguistic and contextual cues that influence their meaning. For visual content, the transformer may analyze sequences of image patches or temporally ordered frame embeddings to detect prohibited objects, unsafe scenes, or inappropriate actions, leveraging the model's global receptive field to correlate visual features across space and time.

In some embodiments, the AI analysis module 625 may be adapted from a foundation model based on a transformer architecture (such as OpenAI's GPT-4, Anthropic's Claude, Meta's LLAMA 3, or Google's BERT) through transfer learning and fine-tuning. Instead of training from scratch, which can be computationally expensive and require massive datasets, a pretrained model may be initialized with parameters learned from broad, large-scale corpora and then fine-tuned on a smaller, domain-specific dataset containing compliance-relevant examples. Fine-tuning may involve adjusting all model parameters or selectively training only certain layers (e.g., classification heads or adapter layers) while freezing the remainder of the network, thereby reducing computational cost and minimizing the risk of catastrophic forgetting of general knowledge.

In some embodiments, the AI analysis module 625 may be implemented using a transformer architecture, which may be suitable for processing sequential data across multiple modalities, including text, audio, and visual information represented as sequences of image patches or frame embeddings. Transformers may operate by applying self-attention mechanisms to the input data, allowing the model to evaluate the relative importance of different elements in the sequence when generating predictions. Some embodiments may capture both local and global dependencies within the input, supporting context-aware compliance analysis even when relevant features are dispersed across different points in time or space.

In some embodiments, implementing the AI analysis module 625 as a transformer may involve encoding input data into embeddings suitable for sequential processing. For text and audio data, this may include converting words, subwords, or phonemes into dense vector representations via learned embedding layers. For visual data, video frames may be divided into non-overlapping patches (e.g., 16×16 pixels), which may be flattened and projected into a higher-dimensional embedding space via learnable linear transformations. Positional encodings (either learned or fixed) may be added to these embeddings to provide the transformer with spatial or temporal ordering information, as the architecture may lack the inherent inductive bias of CNNs for spatial locality. Once embedded, the sequences may be passed through multiple transformer encoder layers, each comprising a multi-head self-attention mechanism and a position-wise feed-forward neural network. In some embodiments, the self-attention mechanism may compute query, key, and value projections for each element, determine attention scores via scaled dot products, and produce weighted combinations of value vectors based on those scores. Multi-head attention may allow the network to model different types of relationships simultaneously, while residual connections, layer normalization, and dropout may improve training stability and generalization.

In some embodiments, the transformer in the AI analysis module 625 may process transcribed audio or extracted on-screen text to detect keywords, phrases, sentiments, or inferred intents indicating compliance or non-compliance with organizational guidelines. The model's attention layers may support detection of not only the explicit presence of prohibited terms but also the surrounding context that informs whether a violation has occurred. For visual compliance tasks, the transformer may process sequences of image patch embeddings or temporally ordered frame embeddings to identify prohibited objects, unsafe scenes, or non-compliant actions, leveraging the global receptive field of self-attention to correlate features across frames or regions.

In some embodiments, the AI analysis module 625 may be based on a foundation model such as OpenAI's GPT-4, Anthropic's Claude, Meta's LLAMA 3, or Google's BERT. Adapting such a model to compliance-specific tasks may be achieved through transfer learning and fine-tuning. Fine-tuning may involve retraining all or part of the model's parameters on a smaller, labeled dataset specifically curated for compliance detection. In some embodiments, this dataset may contain examples relevant to organizational policies and legal requirements, supporting the model to specialize in detecting non-compliant content while retaining the broad generalization capabilities acquired during large-scale pretraining.

In some embodiments, the pretrained transformer may be adjusted incrementally to fit the specific task of policy enforcement. The parameter updates may be small relative to the pretrained weights, allowing the model to adapt without losing the foundational knowledge obtained during its initial training. This strategy may provide a high degree of performance while avoiding the computational and data-collection costs of training from scratch. In some embodiments, parameter-efficient adaptation techniques may be used to customize the transformer for specific compliance tasks without retraining all model weights. One such approach may be prompt engineering, in which task-specific instructions, contextual cues, and examples are embedded directly into the model's input, guiding its output behavior without altering underlying parameters. This may be useful in cases where rapid reconfiguration is needed for new policies or when a single base model must support multiple organizations with distinct compliance rules. In some embodiments, an adaptation method may involve inserting adapter layers between the layers of the pretrained transformer. These adapter layers may be trained on compliance-specific data while the vast majority of the pretrained parameters remain fixed. This approach may significantly reduce training time and memory usage, facilitate modular switching between different policy domains, and facilitate deployment on systems with constrained computational resources.

In some embodiments, the AI analysis module 625 may employ few-shot prompting to adapt to varied or evolving compliance policies without the need for large, labeled datasets. Few-shot prompting may leverage the pretrained transformer's ability to generalize from a small set of examples (e.g., one to five) that may demonstrate compliant and non-compliant cases according to a specific policy. In some embodiments, these examples may be presented as input-output pairs, where the input contains a text snippet, audio transcription segment, or visual description, and the output includes a compliance classification and, optionally, an explanatory rationale. For example, in the case of an HR policy prohibiting certain sensitive language in workplace communications, a few-shot prompt may consist of several labeled examples of prohibited phrases alongside their “noncompliant” labels. The transformer may use its extensive pretraining to generalize from these examples, detecting policy violations in new, unseen data even when the language differs in exact phrasing or modality. This generalization may extend across modalities, facilitating detection of gestures or symbolic content described in text or transcribed from video.

In some embodiments, few-shot prompting may be further enhanced through task-specific prompt design, where the prompt may include explicit instructions such as “Identify language that violates our sensitivity policy” followed by illustrative examples. This targeted prompt construction may focus the model's attention on relevant aspects of the input, improving classification accuracy without additional training. Few-shot prompting may be advantageous when organizations have idiosyncratic or rapidly changing policies that are not represented in common pretraining corpora. Rather than requiring extensive retraining or the creation of large bespoke datasets, policy maintainers may supply a small, curated set of representative examples. The AI analysis module 625, guided by these prompts, may then apply the inferred policy rules to a broader corpus of content, supporting rapid adaptation and deployment in dynamic compliance environments.

In some embodiments, the AI analysis module 625 may be trained on a large corpus of labeled video content, with each video pre-classified as compliant or non-compliant according to the applicable organizational policies and legal guidelines stored in the policy and legal database 630. In some embodiments, the training process may follow a supervised learning paradigm, wherein each training sample consists of both the input video data and its corresponding compliance label. This pairing may allow the AI analysis module 625 to learn mappings from the multimodal feature space, comprising audio, visual, and textual attributes, to a target classification space. Through iterative parameter updates driven by loss minimization techniques such as cross-entropy or focal loss, the model may progressively refine its internal representations, thereby improving its ability to detect and categorize policy-relevant events, objects, and language in previously unseen video content.

In some embodiments, the functionality of the AI analysis module 625 may be organized into a chain of agents architecture, wherein the overall compliance analysis task may be decomposed into a sequence of specialized, interdependent processing stages. Each agent may be dedicated to a specific subtask, with its output feeding directly into the next stage of the pipeline. This modular decomposition may be represented as a directed acyclic graph (DAG), where nodes represent agents and edges represent data flow between them. Such an arrangement may support parallelization of independent subtasks, dynamic reconfiguration to handle different analysis workflows, and scalability to accommodate varying workloads or evolving policy requirements.

In some embodiments, the process may begin with a preprocessing agent responsible for preparing the raw video data for downstream analysis. The preprocessing agent may handle tasks such as video decompression, format conversion, frame extraction at defined temporal intervals, and audio stream segmentation. In some embodiments, the process may also perform basic enhancement and normalization steps, including resolution adjustment, aspect ratio correction, color normalization, and audio volume leveling. For audio, the preprocessing agent may remove background noise or perform voice activity detection to segment speech from silence or environmental sounds. For visual data, preprocessing may include stabilization, lighting correction, and removal of visual artifacts. The preprocessed video frames, synchronized audio segments, and any associated metadata generated at this stage may then be passed to the next set of specialized feature extraction agents.

In some embodiments, a set of specialized feature extraction agents may operate on the prepared data. In some embodiments, a visual feature extraction agent may process video frames to detect objects, identify human faces, recognize gestures, or classify scenes. This agent may employ CNNs, ViTs, or hybrid architectures to generate feature maps, identify regions of interest, and extract embeddings that represent the visual content at multiple levels of abstraction. In some embodiments, the visual agent may also perform object tracking across frames to capture temporal consistency and context for compliance evaluation.

In some embodiments, an audio feature extraction agent may operate in parallel to process the audio stream. This agent may extract features such as speech content, background noises, prosodic patterns, or specific audio signatures. Speech segments may be transcribed using ASR systems, which may integrate acoustic models, language models, and decoding algorithms. The transcribed text may then undergo NLP-based processing to detect keywords, prohibited phrases, or sentiment cues relevant to compliance policies. Additionally, the audio agent may output time-aligned feature vectors capturing both linguistic and paralinguistic elements for downstream multimodal analysis.

In some embodiments, if the video contains text overlays, a text extraction agent may employ OCR techniques to detect and convert visible text into a machine-readable format. OCR preprocessing may include image binarization, skew correction, and region segmentation to improve recognition accuracy. The extracted text may be accompanied by metadata such as bounding box coordinates, font characteristics, and temporal occurrence in the video. This text output may then be analyzed via NLP pipelines for compliance-relevant content and cross-referenced with the audio transcript to verify consistency or detect discrepancies.

Once the multimodal features have been extracted by the specialized feature extraction agents, in some embodiments, a set of content analysis agents may perform policy-specific evaluation to determine whether any aspect of the video content violates compliance criteria defined in the policy and legal database 630. In some embodiments, a text compliance analysis agent may process both transcribed speech from the audio stream and text detected via OCR from on-screen overlays. This agent may apply a variety of NLP models (e.g., transformer-based language models, RNNs, or rule-based pattern matchers) to detect prohibited terms, sensitive topics, and inappropriate sentiments that are defined as non-compliant by organizational policy or legal requirements. The analysis may consider both lexical features (e.g., exact keyword matches) and semantic context (e.g., sentiment polarity, topic classification, or intent detection) to reduce false positives caused by ambiguous wording. The output of this agent may include a compliance classification score or categorical label for the textual content, as well as time-aligned annotations mapping specific violations to their positions within the audio track or video timeline.

In some embodiments, a visual compliance analysis agent may evaluate frame- and object-level features produced by the visual feature extraction agent. This analysis may employ pretrained object detection models (e.g., Faster R-CNN, YOLO, or DETR) that may have been fine-tuned to the compliance-relevant classes for a specific organization. The visual compliance agent may identify and label prohibited objects (e.g., weapons, unsafe equipment, unauthorized logos), gestures (e.g., offensive hand signs), or actions (e.g., unsafe workplace conduct). The output of this agent may include a list of detected non-compliant elements with associated confidence scores, bounding box coordinates, and frame/time indices to support precise localization within the video.

In some embodiments, a behavioral compliance analysis agent may integrate both visual and audio features to detect policy-violating behaviors or interactions that span multiple modalities. This may involve action recognition pipelines based on temporal convolutional networks, 3D CNNs, LSTMs, GRUs, or transformer-based sequence models to detect patterns such as aggressive movement, discriminatory gestures, or unprofessional conduct. The model may also analyze temporal dependencies, interaction patterns between detected entities, and accompanying audio cues to classify a behavior as compliant or non-compliant. The behavioral compliance agent's output may include a set of identified non-compliant behaviors, each linked to specific start and end timestamps in the video. After all modality-specific content analysis agents have completed their evaluations, in some embodiments, a decision-making agent may aggregate the outputs into a unified compliance determination. This aggregation may involve a rule-based inference engine (mapping specific detected events to compliance outcomes) or a meta-classifier that takes as input the outputs from the various agents (e.g., keyword detections, object classifications, action labels) and produces an overall compliance score or categorical decision. The decision-making agent may assign weights to different inputs based on policy priority, detection confidence, or historical accuracy metrics. The output of the decision-making agent may be a structured compliance report, which may detail each violation detected, the supporting evidence (e.g., text excerpts, object images, action descriptors), and their exact positions in the video timeline. This report may be passed to the compliance report generation module 635 for formatting into human-readable and/or machine-consumable formats, supporting both automated enforcement systems and human review processes.

In some embodiments, the compliance report generation module 635 may incorporate a reporting and feedback agent configured to transform the aggregated outputs of the decision-making agent into one or more human-readable and/or machine-readable reports. These reports may present compliance findings in a structured, clear, and actionable manner, allowing reviewers to quickly identify, assess, and remediate potential violations. The reporting and feedback agent may compile data from all upstream content analysis agents, retaining temporal and spatial metadata to allow reviewers to precisely locate each detected event in the original video.

In some embodiments, the report may contain detailed annotations that may mark the specific frames, video segments, or audio intervals where non-compliance was detected. These annotations may include timestamps, bounding boxes for visual detections, and highlighted transcripts for text or speech violations. Cross-references may be provided to link each violation to the relevant policy or regulation from the policy and legal database 630.

In some embodiments, the reporting and feedback agent may also perform a process refinement function. Based on the patterns observed in the generated reports (e.g., frequent false positives for certain categories or missed detections) the agent may produce recommendations for model retraining or rule adjustments. In some embodiments, these recommendations may be passed to system administrators or directly into automated retraining workflows, allowing the AI analysis module 625 to evolve in response to new data, updated organizational policies, or changes in legal requirements. In some embodiments, the reporting and feedback agent may operate as part of a chain of agents architecture, where the entire AI-driven compliance evaluation pipeline may be organized as a DAG. In this DAG, each node represents an agent performing a specific analysis or transformation task, and each edge represents the flow of data between agents. This structure may support parallel processing, allowing multiple agents to analyze different modalities or content segments simultaneously. Such parallelism may significantly reduce end-to-end processing time and improve scalability for high-volume workloads. In some embodiments, the DAG structure may be dynamically configurable, supporting the addition, removal, or reordering of agents to accommodate new compliance tasks, adapt to emerging policy requirements, or focus on specific content domains. This flexibility may allow the system to rapidly deploy new analysis capabilities without requiring a full redesign of the processing pipeline.

In some embodiments, the compliance report generation module 635 may produce reports in multiple formats. For human review, the report may be formatted as an interactive HTML dashboard or PDF containing embedded video snippets, annotated screenshots, violation summaries, and direct references to relevant policies. For integration with other systems, the module may generate machine-readable outputs in formats such as JSON, XML, or CSV, containing structured violation data, metadata, and classification scores. These structured outputs may be ingested by case management tools, compliance tracking systems, or automated enforcement mechanisms.

In some embodiments, the compliance report generation module 635 may also support role-based access control, making sure that report content is appropriately filtered or redacted based on the reviewer's permissions. For example, certain sensitive details (e.g., personally identifiable information) may be omitted or anonymized in reports for general compliance teams but retained in full for legal review.

In some embodiments, the disclosed system addresses technical limitations in computerized video analysis by implementing a multistage, multimodal pipeline that transforms raw sensor signals into synchronized, machine-interpretable representations. The architecture may include stabilization of frame sequences using optical-flow methods (e.g., Lucas-Kanade, Horn-Schunck, Farnebäck, TV-L1, or pyramidal variants) to reduce motion-induced artifacts, lighting normalization using histogram analysis, histogram equalization, gamma correction, and Retinex processing to mitigate exposure variance and illumination gradients, and audio denoising via spatial/temporal filtering, non-local means, Kalman filtering, or learned denoisers. These signal-level transformations produce temporally aligned, noise-reduced inputs that improve downstream machine learning effectiveness and reduce false triggers caused by jitter, compression, or poor capture conditions.

In some embodiments, the system may provide a technical improvement in classification accuracy by computing and fusing cross-modal features that are not practically processed by a human or a single-modality rules engine at production scale. Visual content may be encoded by convolutional backbones, 3D CNNs, or vision transformers operating on patch embeddings. Audio may be encoded via MFCC/STFT features passed through RNN/LSTM/GRU or transformer encoders. On-frame text may be extracted using OCR and represented as token embeddings. A fusion subsystem may align these streams with shared timestamps and apply attention-based weighting so that, for example, a spoken phrase and a simultaneous gesture are evaluated together rather than in isolation. This arrangement may reduce both missed violations and spurious flags in contexts where meaning depends on temporal co-occurrence across modalities.

In some embodiments, the system may improve determinism and reproducibility in computer-executed policy evaluation through a versioned policy and legal database 630 accessed at inference time. Policies may be stored in both natural-language and machine-readable forms with metadata (jurisdiction, effective date, scope, priority). The compliance analysis module 625 may map detections to the active rule set using the video's policy context and may record model version identifiers and cryptographic digests of applied rules. This may yield a traceable, replayable computation: the same input, with the same context, produces the same output, which may differ materially from ad hoc human judgment and from generic “apply policy” logic unmoored from a time-indexed rule corpus.

In some embodiments, the disclosure may address bandwidth and energy constraints in distributed environments by pushing selected preprocessing to client devices and edge nodes. The video input module 610 and the video preprocessing module 615 may offload stabilization, lighting normalization, denoising, cropping, and even lightweight feature extraction to mobile devices using depthwise-separable networks (e.g., MobileNet V2/V3) and on-device accelerators (e.g., neural engines or tensor cores). This reduces uplink payload size and server-side compute while preserving fidelity for server-side fusion and classification. The result is a computer-centric improvement: less data transported, fewer server cycles per decision, and lower queuing delay when many users submit content simultaneously.

In some embodiments, the system may provide a technical remedy for data sparsity and distribution shift by incorporating contrastive representation learning and parameter-efficient adaptation. Contrastive losses (e.g., triplet or InfoNCE) trained over gesture, expression, and phrase embeddings may create separable manifolds even when labeled examples are scarce. Adapter layers, prompt-based conditioning, and few-shot prompts may specialize large transformer backbones to organization-specific policies while leaving base parameters largely fixed, thus maintaining inference stability and minimizing memory and compute footprints during updates. These mechanisms may address model drift without full retraining and support rapid, machine-level reconfiguration when policies change.

In some embodiments, the reporting flow may yield machine-actionable artifacts (e.g., time-aligned annotations, bounding boxes, transcript spans, confidence scores, and rule citations) produced by the compliance report generation module 635. These artifacts may not be merely narrative outputs and may be structured data consumable by downstream systems for automatic redaction, re-cutting, or blocking before publication. This end-to-end transformation (from raw video/audio signals to structured compliance directives) may reflect a specific improvement in computer-driven media processing, rather than an instruction to apply a business policy.

In some embodiments, the user interface 640 may provide the primary interaction layer between the system and one or more human users. The user interface 640 may be configured to display information, analysis results, and controls generated by the underlying modules of the system, and to receive user inputs for initiating, adjusting, or reviewing compliance analysis operations. The user interface 640 may present information visually, audibly, or through haptic feedback, and may accept input through a variety of modalities, including text entry, pointing devices, touch gestures, voice commands, and programmatic API calls.

In some embodiments, the user interface 640 may operate as a graphical user interface rendered on a display device, such as a monitor, tablet screen, or mobile display, In some embodiments, other implementations (e.g., web-based dashboards or command-line environments) may be employed. The user interface 640 may be configured to receive input from local input devices, such as a keyboard, mouse, touch panel, or microphone, as well as from remote client devices communicating over a network. The interface may support interactive workflows, allowing users to navigate between different views, filter displayed content, and request additional detail for specific results or system events.

In some embodiments, the user interface 640 may integrate with the system's backend modules to both retrieve and submit data. For example, the interface may receive analysis results from the compliance analysis module 625, display them in a structured and navigable format, and accept user feedback on detected items, which may then be stored or transmitted for further processing. Similarly, the interface may present policy configuration options linked to the policy and legal database 630, and accept edits or selection inputs from authorized users, which may be applied in subsequent compliance determinations. In some embodiments, the user interface 640 may be implemented as a thin client that communicates with application logic running on a server, or as a thick client where substantial portions of the processing and rendering occur locally. The interface may be responsive to different device form factors and network conditions, and may provide adaptive layouts or data loading strategies to maintain usability across varying environments.

In some embodiments, the user interface 640 may interoperate with the video input module 610 to support upload of files, selection of live streams, selection of stored content from repositories, capture of descriptive metadata, and assignment of content type tags. The user interface 640 may present file validation feedback, codec/format summaries, and source provenance, and may allow users to batch videos into analysis jobs or schedule analyses. In some embodiments, the user interface 640 may expose controls for the video preprocessing module 615, including previews of stabilization, lighting normalization, and noise reduction. The user interface 640 may allow selection of preprocessing presets, adjustment of kernel sizes or gamma values, toggling of optical-flow methods, and cropping or redaction of regions of interest prior to analysis. In some embodiments, the user interface 640 may present diagnostics from the feature extraction module 620, including frame-level overlays for detected objects, pose keypoints, text bounding boxes from OCR, and audio activity heatmaps aligned to the timeline. The user interface 640 may display detection confidence scores, allow filtering by modality, and permit users to download extracted transcripts or text overlays. In some embodiments, the user interface 640 may provide configuration and browsing tools for the policy and legal database 630, including selection of jurisdiction, department, or effective date, comparison of policy versions, viewing of rule metadata, and editing of machine-readable rules where permitted. The user interface 640 may present policy citations next to detections and allow mapping of organization-specific terminology to controlled vocabularies. In some embodiments, the user interface 640 may expose run-time controls for the compliance analysis module 625, including model/pipeline selection, threshold tuning, class weighting, and modality weighting. The user interface 640 may support uploading few-shot exemplars, managing adapter packs, entering prompt instructions for transformer-based workflows, and initiating re-analysis on selected segments. The user interface 640 may surface calibration plots, drift indicators, and summary metrics for recent runs.

In some embodiments, the user interface 640 may present outputs from the compliance report generation module 635 as interactive reports with a synchronized timeline, thumbnails, bounding-box overlays, transcript highlights, and direct links to implicated policy entries from the policy and legal database 630. The user interface 640 may support exporting reports to PDF, JSON, XML, or CSV, adding reviewer notes, assigning items for follow-up, and triggering remediation workflows. In some embodiments, the user interface 640 may provide feedback and labeling tools that write back to training or governance stores, including relabeling of segments, approval/rejection of detections, and submission of counter-examples for contrastive or supervised retraining. The user interface 640 may allow curators to assemble datasets, define folds, and queue fine-tuning or adapter training jobs. In some embodiments, the user interface 640 may include administration and governance controls, such as role-based access control, retention settings, redaction of sensitive regions, audit logs, API key management, and connector configuration for repositories or notification systems. The user interface 640 may present health and capacity dashboards for distributed or remote deployments, job queues, and throughput/latency statistics. In some embodiments, the user interface 640 may support integration and notification flows, including webhooks to case-management tools, ticket creation, and alerts based on rule triggers or risk thresholds. The user interface 640 may provide accessibility features, keyboard navigation, captions, and localization for multilingual teams.

In some embodiments, the physical architecture of the computing environment may be distributed, with user computing devices communicating over one or more networks, such as the internet, WANs, or LANs, to a remote server system or cloud-hosted service that executes some or all stages of the video processing pipeline described herein. In some embodiments, the system may accommodate a plurality of user devices, including mobile devices (e.g., smartphones, tablets, wearable devices), desktop or laptop computers, or other network-enabled terminals. Video content may be submitted through a native application executing locally on the device or via a web browser interface that communicates securely with backend services. In some embodiments, the native application may perform client-side preprocessing operations such as stabilization, lighting normalization, or feature extraction.

In some embodiments, the remote processing environment may include application servers, load balancers, and hardware accelerators such as GPUs, TPUs, or dedicated AI inference processors to execute modules including the video preprocessing module 615, feature extraction module 620, compliance analysis module 625, and compliance report generation module 635. In alternative embodiments, the system may be deployed as an on-premises installation within an organization's local infrastructure, an edge-computing architecture where processing is performed closer to the source of data capture, or a hybrid model in which some processing stages are performed on client devices and others in centralized environments. In some embodiments, communications may be encrypted and authenticated, and the architecture may be configured to scale to accommodate varying workloads across multiple users or organizations.

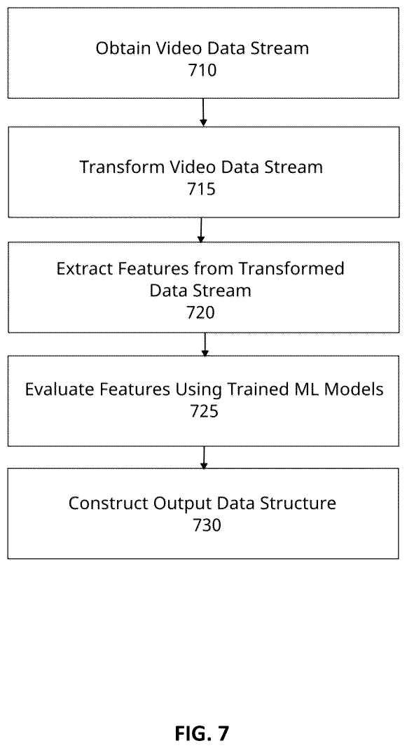

FIG. 7 is a flow chart of a method 700. In some embodiments, method 700 may begin in step 710 by obtaining a video data stream comprising a sequence of image frames and synchronized audio. The obtaining operation may occur through the user interface 640 and the video input module 610 and may include: accepting file uploads (e.g., MP4, MOV, MKV, WebM) with codecs such as H.264/H.265/VP9/AV1, ingesting live streams via RTMP, HLS, DASH, or WebRTC, or retrieving content from storage resources such as local disks, network-attached storage, or cloud repositories. The system may parse container metadata (e.g., frame rate, presentation timestamps, time base, color space, audio sample rate), verify integrity using checksums, and extract auxiliary metadata (author, capture device, creation time, jurisdiction tags) for later policy scoping. In some embodiments, live inputs may be buffered into time-aligned chunks using ring buffers with backpressure control, while variable-bit-rate inputs may be normalized through adaptive re-muxing to stabilize downstream timing. Authentication and access control may be applied prior to ingestion, and transport security may be used for remote submissions. Clock skew between audio and video tracks may be corrected using container PTS/DTS reconciliation to maintain cross-modal alignment in subsequent stages.

In some embodiments, the transform stage in step 715 may standardize signal characteristics to improve downstream learning performance. For stabilization, the system may compute optical flow between consecutive frames (e.g., pyramidal Lucas-Kanade, Horn-Schunck, Farnebäck, or TV-L1), fit a global motion model (affine or homography) using RANSAC to reject local object motion, and warp frames accordingly with interpolation and edge in-painting. For luminance and color consistency, the system may perform per-frame histogram analysis, apply gamma mapping, histogram equalization or CLAHE for contrast, Retinex-style illumination estimation for shading removal, and white-balance correction using gray-world or learned illuminant estimation. In some embodiments, temporal smoothing of exposure and color gains may be applied to avoid flicker. For audio cleanup, the system may run voice activity detection (e.g., MFCC- or spectrogram-based neural VAD), attenuate non-speech bands using spectral subtraction or a Wiener filter, apply dereverberation (e.g., WPE) when room echoes are detected, and perform beamforming if multi-mic inputs are available. Parameters (e.g., stabilization strength, CLAHE clip limit, denoise thresholds) may be adaptively selected from frame- and segment-level statistics to preserve content while suppressing artifacts.

In some embodiments, the feature extraction module 620 in step 720 may produce synchronized, machine-interpretable representations across modalities. For visual features, the system may apply convolutional backbones (e.g., residual/dilated CNNs), 3D CNNs for short clips, or vision transformers on patch embeddings. In some embodiments, outputs may include object proposals, region embeddings, scene labels, pose keypoints, and per-frame descriptors with timestamps. Object tracking (e.g., Kalman/SORT/DeepSORT) may maintain identities across frames for temporal reasoning. For speech, the audio track may be converted to time-frequency representations (e.g., STFT/mel spectrograms) and processed by recurrent, transducer, conformer, or transformer ASR models to obtain transcripts with token-level timing, language identification, speaker diarization, and prosody vectors may be added where useful for policy context. For visible text, OCR may be performed using text detectors (e.g., EAST/CRAFT) and recognizers, with geometric normalization (e.g., deskewing, dewarping) and binarization to improve accuracy. The output may include strings, bounding boxes, confidence scores, and frame/time indices. A synchronization layer may align all extracted items onto a common timeline using media timestamps so that subsequent analysis can evaluate co-occurrence across modalities.

In some embodiments, the compliance analysis module 625 may evaluate in step 725 the synchronized features with trained models configured to capture semantic, contextual, and cross-modal relationships. Modality-specific detectors (e.g., object/gesture/action models, text/NLP classifiers, keyword spotters with context windows) may produce preliminary labels and scores. In some embodiments, a fusion model may then combine visual, audio, and textual embeddings using cross-attention or gated weighting to detect patterns whose evidentiary cues span modalities (e.g., a phrase spoken concurrently with a gesture and an on-screen caption). In some embodiments, active compliance rules may be retrieved from the policy and legal database 630 based on metadata such as jurisdiction, department, audience, or effective date, and detections may be mapped to rule identifiers and priorities. In some embodiments, calibration techniques (e.g., temperature scaling, isotonic regression) may be applied to normalize scores across model versions. In some embodiments, thresholding may be policy-specific and an ensemble or meta-classifier may reconcile conflicting signals. In some embodiments, the system may record evaluation provenance, including model versions, configuration hashes, and the policy snapshot applied to the video, to support reproducibility.

In some embodiments, the system may construct in step 730 a structured output that encodes the compliance assessment and its evidentiary basis. The data structure (e.g., JSON or protocol buffers) may include: per-segment records with start/end timestamps, references to implicated frames, bounding boxes or masks for visual items, transcript spans for speech, OCR spans for on-screen text, feature embeddings or representative thumbnails where permitted, labels and calibrated confidence scores, and policy entries with identifiers, titles, effective dates, and citations. In some embodiments, global metadata may include the video identifier, source, preprocessing parameters, model and policy versions, decision thresholds, and audit hashes. The structure may optionally carry remediation directives (e.g., redact a region, mute an interval, replace a caption) and reviewer fields for human adjudication. The output may be passed to the compliance report generation module 635 for rendering into human-readable reports or exported as machine-readable artifacts for downstream enforcement, archiving, or retraining feedback loops.

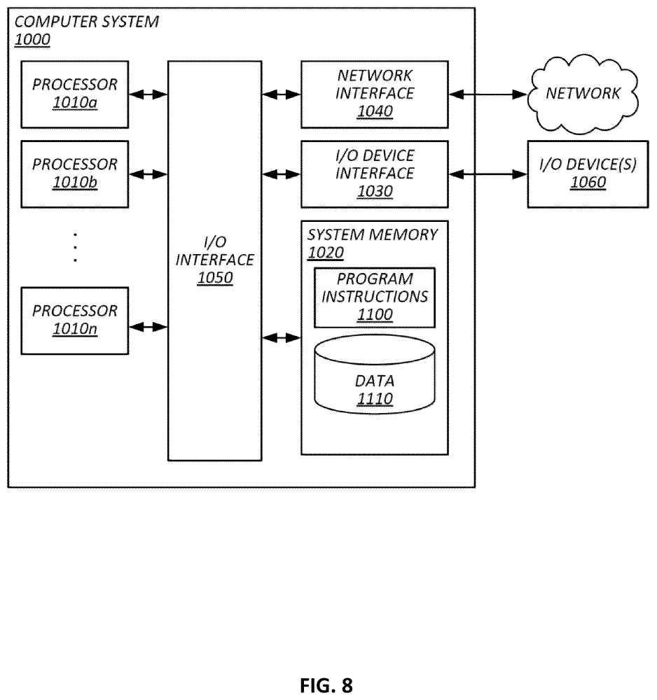

FIG. 8 is a diagram that illustrates an exemplary computing system 1000 in accordance with embodiments of the present technique. A single computing device is shown, but some embodiments of a computer system may include multiple computing devices that communicate over a network, for instance in the course of collectively executing various parts of a distributed application. Various portions of systems and methods described herein, may include or be executed on one or more computer systems similar to computing system 1000. Further, processes and modules described herein may be executed by one or more processing systems similar to that of computing system 1000.

Computing system 1000 may include one or more processors (e.g., processors 1010a-1010n) coupled to system memory 1020, an input/output I/O device interface 1030, and a network interface 1040 via an input/output (I/O) interface 1050. A processor may include a single processor or a plurality of processors (e.g., distributed processors). A processor may be any suitable processor capable of executing or otherwise performing instructions. A processor may include a central processing unit (CPU) that carries out program instructions to perform the arithmetical, logical, and input/output operations of computing system 1000. A processor may execute code (e.g., processor firmware, a protocol stack, a database management system, an operating system, or a combination thereof) that creates an execution environment for program instructions. A processor may include a programmable processor. A processor may include general or special purpose microprocessors. A processor may receive instructions and data from a memory (e.g., system memory 1020). Computing system 1000 may be a uni-processor system including one processor (e.g., processor 1010a), or a multi-processor system including any number of suitable processors (e.g., 1010a-1010n). Multiple processors may be employed to provide for parallel or sequential execution of one or more portions of the techniques described herein. Processes, such as logic flows, described herein may be performed by one or more programmable processors executing one or more computer programs to perform functions by operating on input data and generating corresponding output. Processes described herein may be performed by, and apparatus can also be implemented as, special purpose logic circuitry, e.g., an FPGA (field programmable gate array) or an ASIC (application specific integrated circuit). Computing system 1000 may include a plurality of computing devices (e.g., distributed computer systems) to implement various processing functions.

I/O device interface 1030 may provide an interface for connection of one or more I/O devices 1060 to computer system 1000. I/O devices may include devices that receive input (e.g., from a user) or output information (e.g., to a user). I/O devices 1060 may include, for example, graphical user interface presented on displays (e.g., a cathode ray tube (CRT) or liquid crystal display (LCD) monitor), pointing devices (e.g., a computer mouse or trackball), keyboards, keypads, touchpads, scanning devices, voice recognition devices, gesture recognition devices, printers, audio speakers, microphones, cameras, or the like. I/O devices 1060 may be connected to computer system 1000 through a wired or wireless connection. I/O devices 1060 may be connected to computer system 1000 from a remote location. I/O devices 1060 located on remote computer system, for example, may be connected to computer system 1000 via a network and network interface 1040.

Network interface 1040 may include a network adapter that provides for connection of computer system 1000 to a network. Network interface 1040 may facilitate data exchange between computer system 1000 and other devices connected to the network. Network interface 1040 may support wired or wireless communication. The network may include an electronic communication network, such as the Internet, a local area network (LAN), a wide area network (WAN), a cellular communications network, or the like.

System memory 1020 may be configured to store program instructions 1100 or data 1110. Program instructions 1100 may be executable by a processor (e.g., one or more of processors 1010a-1010n) to implement one or more embodiments of the present techniques. Instructions 1100 may include modules of computer program instructions for implementing one or more techniques described herein with regard to various processing modules. Program instructions may include a computer program (which in certain forms is known as a program, software, software application, script, or code). A computer program may be written in a programming language, including compiled or interpreted languages, or declarative or procedural languages. A computer program may include a unit suitable for use in a computing environment, including as a stand-alone program, a module, a component, or a subroutine. A computer program may or may not correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program may be deployed to be executed on one or more computer processors located locally at one site or distributed across multiple remote sites and interconnected by a communication network.

System memory 1020 may include a tangible program carrier having program instructions stored thereon. A tangible program carrier may include a non-transitory computer readable storage medium. A non-transitory computer readable storage medium may include a machine readable storage device, a machine readable storage substrate, a memory device, or any combination thereof. Non-transitory computer readable storage medium may include non-volatile memory (e.g., flash memory, ROM, PROM, EPROM, EEPROM memory), volatile memory (e.g., random access memory (RAM), static random access memory (SRAM), synchronous dynamic RAM (SDRAM)), bulk storage memory (e.g., CD-ROM and/or DVD-ROM, hard-drives), or the like. System memory 1020 may include a non-transitory computer readable storage medium that may have program instructions stored thereon that are executable by a computer processor (e.g., one or more of processors 1010a-1010n) to cause the subject matter and the functional operations described herein. A memory (e.g., system memory 1020) may include a single memory device and/or a plurality of memory devices (e.g., distributed memory devices). Instructions or other program code to provide the functionality described herein may be stored on a tangible, non-transitory computer readable media. In some cases, the entire set of instructions may be stored concurrently on the media, or in some cases, different parts of the instructions may be stored on the same media at different times.

I/O interface 1050 may be configured to coordinate I/O traffic between processors 1010a-1010n, system memory 1020, network interface 1040, I/O devices 1060, and/or other peripheral devices. I/O interface 1050 may perform protocol, timing, or other data transformations to convert data signals from one component (e.g., system memory 1020) into a format suitable for use by another component (e.g., processors 1010a-1010n). I/O interface 1050 may include support for devices attached through various types of peripheral buses, such as a variant of the Peripheral Component Interconnect (PCI) bus standard or the Universal Serial Bus (USB) standard.

Embodiments of the techniques described herein may be implemented using a single instance of computer system 1000 or multiple computer systems 1000 configured to host different portions or instances of embodiments. Multiple computer systems 1000 may provide for parallel or sequential processing/execution of one or more portions of the techniques described herein.

Those skilled in the art will appreciate that computer system 1000 is merely illustrative and is not intended to limit the scope of the techniques described herein. Computer system 1000 may include any combination of devices or software that may perform or otherwise provide for the performance of the techniques described herein. For example, computer system 1000 may include or be a combination of a cloud-computing system, a data center, a server rack, a server, a virtual server, a desktop computer, a laptop computer, a tablet computer, a server device, a client device, a mobile telephone, a personal digital assistant (PDA), a mobile audio or video player, a game console, a vehicle-mounted computer, or a Global Positioning System (GPS), or the like. Computer system 1000 may also be connected to other devices that are not illustrated, or may operate as a stand-alone system. In addition, the functionality provided by the illustrated components may in some embodiments be combined in fewer components or distributed in additional components. Similarly, in some embodiments, the functionality of some of the illustrated components may not be provided or other additional functionality may be available.

Those skilled in the art will also appreciate that while various items are illustrated as being stored in memory or on storage while being used, these items or portions of them may be transferred between memory and other storage devices for purposes of memory management and data integrity. Alternatively, in other embodiments some or all of the software components may execute in memory on another device and communicate with the illustrated computer system via inter-computer communication. Some or all of the system components or data structures may also be stored (e.g., as instructions or structured data) on a computer-accessible medium or a portable article to be read by an appropriate drive, various examples of which are described above. In some embodiments, instructions stored on a computer-accessible medium separate from computer system 1000 may be transmitted to computer system 1000 via transmission media or signals such as electrical, electromagnetic, or digital signals, conveyed via a communication medium such as a network or a wireless link. Various embodiments may further include receiving, sending, or storing instructions or data implemented in accordance with the foregoing description upon a computer-accessible medium. Accordingly, the present techniques may be practiced with other computer system configurations.

In block diagrams, illustrated components are depicted as discrete functional blocks, but embodiments are not limited to systems in which the functionality described herein is organized as illustrated. The functionality provided by each of the components may be provided by software or hardware modules that are differently organized than is presently depicted, for example such software or hardware may be intermingled, conjoined, replicated, broken up, distributed (e.g. within a data center or geographically), or otherwise differently organized. The functionality described herein may be provided by one or more processors of one or more computers executing code stored on a tangible, non-transitory, machine readable medium. In some cases, notwithstanding use of the singular term “medium,” the instructions may be distributed on different storage devices associated with different computing devices, for instance, with each computing device having a different subset of the instructions, an implementation consistent with usage of the singular term “medium” herein. In some cases, third party content delivery networks may host some or all of the information conveyed over networks, in which case, to the extent information (e.g., content) is said to be supplied or otherwise provided, the information may be provided by sending instructions to retrieve that information from a content delivery network.

The reader should appreciate that the present application describes several independently useful techniques. Rather than separating those techniques into multiple isolated patent applications, applicants have grouped these techniques into a single document because their related subject matter lends itself to economies in the application process. But the distinct advantages and aspects of such techniques should not be conflated. In some cases, embodiments address all of the deficiencies noted herein, but it should be understood that the techniques are independently useful, and some embodiments address only a subset of such problems or offer other, unmentioned benefits that will be apparent to those of skill in the art reviewing the present disclosure. Due to cost constraints, some techniques disclosed herein may not be presently claimed and may be claimed in later filings, such as continuation applications or by amending the present claims. Similarly, due to space constraints, neither the Abstract nor the Summary of the Invention sections of the present document should be taken as containing a comprehensive listing of all such techniques or all aspects of such techniques.

It should be understood that the description and the drawings are not intended to limit the present techniques to the particular form disclosed, but to the contrary, the intention is to cover all modifications, equivalents, and alternatives falling within the spirit and scope of the present techniques as defined by the appended claims. Further modifications and alternative embodiments of various aspects of the techniques will be apparent to those skilled in the art in view of this description. Accordingly, this description and the drawings are to be construed as illustrative only and are for the purpose of teaching those skilled in the art the general manner of carrying out the present techniques. It is to be understood that the forms of the present techniques shown and described herein are to be taken as examples of embodiments. Elements and materials may be substituted for those illustrated and described herein, parts and processes may be reversed or omitted, and certain features of the present techniques may be utilized independently, all as would be apparent to one skilled in the art after having the benefit of this description of the present techniques. Changes may be made in the elements described herein without departing from the spirit and scope of the present techniques as described in the following claims. Headings used herein are for organizational purposes only and are not meant to be used to limit the scope of the description.

As used throughout this application, the word “may” is used in a permissive sense (i.e., meaning having the potential to), rather than the mandatory sense (i.e., meaning must). The words “include”, “including”, and “includes” and the like mean including, but not limited to. As used throughout this application, the singular forms “a,” “an,” and “the” include plural referents unless the content explicitly indicates otherwise. Thus, for example, reference to “an element” or “a element” includes a combination of two or more elements, notwithstanding use of other terms and phrases for one or more elements, such as “one or more.” The term “or” is, unless indicated otherwise, non-exclusive, i.e., encompassing both “and” and “or.” Terms describing conditional relationships, e.g., “in response to X, Y,” “upon X, Y,”, “if X, Y,” “when X, Y,” and the like, encompass causal relationships in which the antecedent is a necessary causal condition, the antecedent is a sufficient causal condition, or the antecedent is a contributory causal condition of the consequent, e.g., “state X occurs upon condition Y obtaining” is generic to “X occurs solely upon Y” and “X occurs upon Y and Z.” Such conditional relationships are not limited to consequences that instantly follow the antecedent obtaining, as some consequences may be delayed, and in conditional statements, antecedents are connected to their consequents, e.g., the antecedent is relevant to the likelihood of the consequent occurring. Statements in which a plurality of attributes or functions are mapped to a plurality of objects (e.g., one or more processors performing steps A, B, C, and D) encompasses both all such attributes or functions being mapped to all such objects and subsets of the attributes or functions being mapped to subsets of the attributes or functions (e.g., both all processors each performing steps A-D, and a case in which processor 1 performs step A, processor 2 performs step B and part of step C, and processor 3 performs part of step C and step D), unless otherwise indicated. Similarly, reference to “a computer system” performing step A and “the computer system” performing step B can include the same computing device within the computer system performing both steps or different computing devices within the computer system performing steps A and B. Further, unless otherwise indicated, statements that one value or action is “based on” another condition or value encompass both instances in which the condition or value is the sole factor and instances in which the condition or value is one factor among a plurality of factors. Unless otherwise indicated, statements that “each” instance of some collection have some property should not be read to exclude cases where some otherwise identical or similar members of a larger collection do not have the property, i.e., each does not necessarily mean each and every. Limitations as to sequence of recited steps should not be read into the claims unless explicitly specified, e.g., with explicit language like “after performing X, performing Y,” in contrast to statements that might be improperly argued to imply sequence limitations, like “performing X on items, performing Y on the X′ed items,” used for purposes of making claims more readable rather than specifying sequence. Statements referring to “at least Z of A, B, and C,” and the like (e.g., “at least Z of A, B, or C”), refer to at least Z of the listed categories (A, B, and C) and do not require at least Z units in each category. Unless specifically stated otherwise, as apparent from the discussion, it is appreciated that throughout this specification discussions utilizing terms such as “processing,” “computing,” “calculating,” “determining” or the like refer to actions or processes of a specific apparatus, such as a special purpose computer or a similar special purpose electronic processing/computing device. Features described with reference to geometric constructs, like “parallel,” “perpendicular/orthogonal,” “square”, “cylindrical,” and the like, should be construed as encompassing items that substantially embody the properties of the geometric construct, e.g., reference to “parallel” surfaces encompasses substantially parallel surfaces. The permitted range of deviation from Platonic ideals of these geometric constructs is to be determined with reference to ranges in the specification, and where such ranges are not stated, with reference to industry norms in the field of use, and where such ranges are not defined, with reference to industry norms in the field of manufacturing of the designated feature, and where such ranges are not defined, features substantially embodying a geometric construct should be construed to include those features within 15% of the defining attributes of that geometric construct. The terms “first”, “second”, “third,” “given” and so on, if used in the claims, are used to distinguish or otherwise identify, and not to show a sequential or numerical limitation. As is the case in ordinary usage in the field, data structures and formats described with reference to uses salient to a human need not be presented in a human-intelligible format to constitute the described data structure or format, e.g., text need not be rendered or even encoded in Unicode or ASCII to constitute text; images, maps, and data-visualizations need not be displayed or decoded to constitute images, maps, and data-visualizations, respectively; speech, music, and other audio need not be emitted through a speaker or decoded to constitute speech, music, or other audio, respectively. Computer implemented instructions, commands, and the like are not limited to executable code and can be implemented in the form of data that causes functionality to be invoked, e.g., in the form of arguments of a function or API call. To the extent bespoke noun phrases (and other coined terms) are used in the claims and lack a self-evident construction, the definition of such phrases may be recited in the claim itself, in which case, the use of such bespoke noun phrases should not be taken as invitation to impart additional limitations by looking to the specification or extrinsic evidence.

In this patent, to the extent any U.S. patents, U.S. patent applications, or other materials (e.g., articles) have been incorporated by reference, the text of such materials is only incorporated by reference to the extent that no conflict exists between such material and the statements and drawings set forth herein. In the event of such conflict, the text of the present document governs, and terms in this document should not be given a narrower reading in virtue of the way in which those terms are used in other materials incorporated by reference.

The present techniques will be better understood with reference to the following enumerated embodiments in Group A.

1. A tangible, non-transitory, machine-readable medium storing instructions that when executed effectuate operations comprising: obtaining, with a computer system, video of a person; pre-processing, with the computer system, the video; inferring, with a computer-vision model executed by the computer system, based on the pre-processed video, a work style or motivation of the person by detecting facial expressions and body language of the person in the pre-processed video; and classifying, with the computer system, the person based on the inferred work style or motivation; and storing, with the computer system, the classification of the person.

2. The medium of embodiment 1, wherein: both a work style and a motivation for engaging in work are inferred.

3. The medium of embodiment 1, wherein classifying comprises designating the person as suitable or unsuitable for hiring.

4. The medium of embodiment 1, the operations comprising using the classification to prepare a career plan or development plan for the person.

5. The medium of embodiment 4, wherein the career plan or development plan are prepared by a language model having an indication of the classification in context.

6. The medium of embodiment 1, the operations comprising: obtaining audio of the person speaking in the obtained video, wherein the classifying is based on the audio.

7. The medium of embodiment 6, the operations comprising: extracting natural language text uttered in the audio with a speech-to-text model, wherein classifying based on the audio comprises classifying based on the extracted natural language text.

8. The medium of embodiment 7, the operations comprising: detecting a tone of the person in the audio with a speech model, wherein classifying based on the audio comprises classifying based on the tone.

9. The medium of embodiment 1, wherein inferring comprises: applying a first filter matrix to values corresponding to a first subset of pixels at a first location in a frame of the video to compute a first value; and applying the first filter matrix to values corresponding to a second subset of pixels at a second location in the frame of the video to compute a second value.

10. The medium of embodiment 9, the operations comprising: applying a second filter matrix to both the first value and the second value, wherein the inferring is based on a result of applying the second filter matrix.

11. The medium of embodiment 1, wherein inferring comprises: extracting a sequence of feature sets in a sequence of frames of the video with a convolutional neural network or a vision transformer; and detecting a facial expression that unfolds over a plurality of the frames with a temporal model based on the sequence of feature sets.

12. The medium of embodiment 11, wherein: the temporal model comprises a cyclic neural network.

13. The medium of embodiment 11, wherein: the temporal model comprises a feed forward neural network having one or more attention heads.

14. The medium of embodiment 1, wherein: the video of the person is obtained with mobile computing device; the person is talking about a career in the video during a video resume, job interview, or self-assessment; and the classification is also based on a resume or survey response of the person.

15. The medium of embodiment 1, wherein inferring comprises identifies micro-expressions, gestures, and tone variations indicative of underlying motivators and preferred work styles.

16. The medium of embodiment 1, wherein the classifying is performed with a classifier trained on a dataset of labeled video recordings with known user work styles and motivators.

17. The medium of embodiment 1, wherein: pre-processing comprises stabilizing the video to reduce an effect of camera movement during video capture.

18. The medium of embodiment 1, wherein: pre-processing comprises normalizing an effect of lighting conditions during video capture.

19. The medium of embodiment 1, wherein: pre-processing comprises removing background noise in audio of the video.

20. The medium of embodiment 1, wherein: inferring is performed with steps for inferring the work style or motivation.

21. The medium of embodiment 1, wherein: pre-processing is performed with steps for pre-processing video from a mobile computing device camera.

22. A method, comprising: obtaining, with a computer system, video of a person; pre-processing, with the computer system, the video; inferring, with a computer-vision model executed by the computer system, based on the pre-processed video, a work style or motivation of the person by detecting facial expressions and body language of the person in the pre-processed video; and classifying, with the computer system, the person based on the inferred work style or motivation; and storing, with the computer system, the classification of the person.

Additional techniques will be better understood with reference to the following enumerated embodiments in group B:

Embodiment 1: A method for automated job search and recruitment, comprising: obtaining, by a computing device, job description data from one or more sources comprising job boards, company databases, and social media profiles; obtaining, by the computing device, applicant information comprising resume data and user-provided responses; parsing, by the computing device, the applicant information and the job description data to extract candidate and job attributes; constructing, by the computing device, respective vector representations of the candidate and job attributes using one or more embedding models trained to represent textual inputs in a high-dimensional vector space, the one or more embedding models comprising word embedding models or transformer-based language models; determining, by the computing device, degrees of similarity between the vector representations of the candidate and job attributes; and constructing, by the computing device, an output comprising ranked recommendation for at least one of a set of job openings ranked for a given applicant or a set of candidates ranked for a given job description, based on the determined similarity.

Embodiment 2: The method of embodiment 1, further comprising: applying one or more trained machine learning models configured to modify the contribution of individual features during similarity computation and ranking, wherein the modification is based at least in part on correlations between features derived from applicant information and demographic attributes associated with the applicant.

Embodiment 3: The method of embodiment 1, wherein receiving the applicant information comprises receiving data indicative of an applicant's personal motivators and preferred work style.

Embodiment 4: The method of embodiment 1, wherein collecting the job description data comprises aggregating the data from multiple sources and preprocessing the aggregated data for subsequent analysis.

Embodiment 5: The method of embodiment 1, wherein parsing the applicant information and the job description data comprises extracting information relating to skills, experience, and education from resumes and job descriptions.

Embodiment 6: The method of embodiment 1, wherein determining the degrees of similarity between the vector representations comprises applying one or more machine learning techniques trained to associate candidate attributes with job attributes.

Embodiment 7: The method of embodiment 1, wherein generating the output comprising the ranked recommendation includes applying heuristic rules and one or more machine learning models to produce the ranking.

Embodiment 8: The method of embodiment 1, wherein constructing the ranked recommendation comprises applying objective criteria derived from the candidate and job attributes to reduce an influence of subjective or biased factors in the ranking.

Embodiment 9: The method of embodiment 1, further comprising: displaying, with the computing device, a user interface, the user interface configured to receive input from a user, the user input being indicative of a search, filter, or view operation to search, filter, or view candidate profiles and corresponding ranked recommendations.

Embodiment 10: The method of embodiment 1, wherein the candidate and job attributes comprise at least one of: technical skills, years of experience, education level, certifications, job titles, personal motivators, preferred work styles, cultural traits, and organizational characteristics.

Embodiment 11: The method of embodiment 1, wherein determining the degrees of similarity between the vector representations comprises computing one or more of the following values: cosine similarity, Euclidean distance, dot product, Manhattan distance, or Minkowski difference.

Embodiment 12: The method of embodiment 1, further comprising steps for classifying at least one of the applicant information or the job description data into one or more predefined categories using a machine learning classification model.

Embodiment 13: The method of embodiment 1, wherein determining the degrees of similarity comprises performing an approximate nearest neighbor search using a Hierarchical Navigable Small World graph.

Embodiment 14: The method of embodiment 1, wherein parsing the applicant information and job description data comprises translating non-English content into a canonical language using a machine learning translation model.

Embodiment 15: The method of embodiment 1, wherein determining the degrees of similarity comprises evaluating compatibility based on objective features and psychographic attributes, the psychographic attributes comprising at least one of: preferred work style, autonomy preference, motivators, or communication style.

Embodiment 16: The method of embodiment 1, further comprising constructing, by the computing device, a description of reasoning for a match between the applicant and the job description, the description comprising a subset of attributes identified as contributing most significantly to the determined similarity or ranked recommendation.

Embodiment 17: The method of embodiment 16, wherein the constructing comprises: applying a feature attribution technique to a machine learning model used in the similarity or ranking computation, the feature attribution technique comprising one or more of: attention weighting, integrated gradients, SHAP values, or perturbation-based analysis; and selecting, based on the feature attribution technique output, a plurality of candidate or job attributes having contribution values above a threshold, the selected attributes being included in the description of reasoning for display to a user.

Embodiment 18: The method of embodiment 1, further comprising: receiving, by the computing device, user-provided feedback data corresponding to prior ranked recommendations, the feedback data indicating user interest or disinterest in one or more previously recommended applicant-job pairings; and modifying, by the computing device, one or more machine learning models used in the recommendation generation based at least in part on the feedback data to influence subsequent ranking outputs.

Embodiment 19: The method of embodiment 1, wherein obtaining the applicant information comprises: establishing, by the computing device, a secure connection with one or more external profile services using an authentication protocol; retrieving structured profile data via the secure connection; and incorporating the retrieved data into the applicant information, the retrieved data comprising at least one of professional experience, educational background, technical skills, endorsements, or certifications.

Additional techniques will be better understood with reference to the following enumerated embodiments in group C:

Embodiment 1: A computer-implemented method for determining whether video content conforms to organizational policies and legal requirements, the method comprising: obtaining, by a computing device, a video data stream comprising a sequence of image frames and associated audio; transforming, by the computing device, the obtained video data stream by: reducing frame-to-frame motion artifacts to stabilize the image sequence; normalizing luminance and color distribution across frames to achieve temporal lighting consistency; and suppressing non-speech audio components to reduce acoustic interference in downstream speech analysis; extracting, by the computing device, a plurality of features from the transformed video data stream, the features comprising: visual content derived from analyzing pixel-level patterns across a sequence of frames using a convolutional neural network; audio-derived textual content obtained via speech-to-text conversion using a deep recurrent or transformer-based sequence model; and embedded or overlay text extracted using optical character recognition techniques; evaluating, by the computing device, the plurality of features with respect to a plurality of compliance rules by applying one or more trained machine learning models to detect patterns indicative of potential violations, the trained models configured to capture semantic, contextual, and cross-modal relationships between extracted content and predefined policy constraints; and constructing, by the computing device, an output data structure comprising an assessment of whether the video content conforms to the plurality of compliance rules, the output data structure identifying nonconforming segments and providing time-aligned annotations corresponding to the detected nonconformities.

Embodiment 2: The method of embodiment 1, wherein obtaining the video data stream comprises retrieving, by the computing device, previously recorded video content from a data storage resource comprising one or more of a local memory, a network-accessible storage device, or a cloud-based video repository.

Embodiment 3: The method of embodiment 2, wherein the data storage resource received the video content from one or more upstream sources comprising at least one of a video capture device, third-party content platform, or enterprise content management system.

Embodiment 4: The method of embodiment 1, wherein obtaining the video data stream comprises receiving, by the computing device, video content transmitted as a live stream from a real-time capture source, the real-time capture source comprising one or more network-connected image acquisition devices.

Embodiment 5: The method of embodiment 1, wherein determining the visual content from the transformed video data stream comprises: processing the image sequence using a convolutional neural network configured to detect spatial and temporal visual features across multiple frames; identifying one or more object regions by applying a region proposal mechanism, wherein each proposed region is evaluated for the presence of visual elements indicative of compliance-relevant content; classifying detected objects by comparing learned feature embeddings against class-specific thresholds using a softmax activation function; localizing facial regions and computing facial expression embeddings using a facial landmark estimation network; extracting body pose keypoints by applying a multi-stage pose estimation model to detected human figures, the keypoints comprising at least limb positions, orientation, and hand gestures; and aggregating detected visual features across a temporal window by applying attention-weighted pooling, wherein greater emphasis is assigned to frames exhibiting abrupt or anomalous movement patterns.

Embodiment 6: The method of embodiment 1, wherein determining the audio-derived textual content comprises: transforming an audio signal into a time-frequency representation using a short-time Fourier transform to produce a spectrogram; extracting acoustic features from the spectrogram by applying a convolutional encoder followed by a recurrent or transformer-based decoder trained for automatic speech recognition; constructing a phoneme-level hypothesis stream using a connectionist temporal classification decoder, and mapping phonemes to word-level transcriptions via a lexicon and language model; detecting speaker diarization segments by clustering audio embeddings derived from the recognition network; performing voice activity detection using a neural network classifier to segment speech from non-speech audio; and classifying emotional tone using a paralinguistic model trained to infer affective state from prosodic and spectral features, the emotional tone comprising categories such as anger, enthusiasm, discomfort, or neutrality.

Embodiment 7: The method of embodiment 1, wherein evaluating the plurality of features with respect to the compliance rules comprises accessing a data source comprising a collection of organizational policies and legal standards, the data source being periodically updated to reflect changes in internal policy frameworks or applicable regulatory requirements.

Embodiment 8: The method of embodiment 1, wherein reducing frame-to-frame motion artifacts comprises computing an optical flow field between consecutive frames using a pyramidal Lucas-Kanade algorithm, filtering out outlier motion vectors with a RANSAC process, and applying an affine transformation to each frame to correct estimated global camera motion.

Embodiment 9: The method of embodiment 1, wherein normalizing luminance and color distribution comprises performing histogram equalization on each frame, applying a Retinex-based illumination correction to remove non-uniform lighting, and adjusting white balance parameters based on a detected scene color temperature.

Embodiment 10: The method of embodiment 1, wherein suppressing non-speech audio components comprises performing voice activity detection using a neural network trained on Mel-frequency cepstral coefficient features, and applying a spectral subtraction algorithm to attenuate non-speech frequency components during detected speech intervals.

Embodiment 11: The method of embodiment 1, wherein evaluating the plurality of features comprises performing cross-modal attention between visual embeddings, audio embeddings, and text embeddings to detect compliance violations indicated by temporally co-occurring cues across different modalities.

Embodiment 12: The method of embodiment 1, wherein evaluating the plurality of features comprises retrieving, from a version-controlled policy and legal database, a set of active compliance rules based on jurisdiction and content metadata, and mapping detected features to rule identifiers with associated enforcement priorities.

Embodiment 13: The method of embodiment 1, wherein constructing the output data structure comprises including, for each detected nonconformity, a frame index or timestamp, a bounding-box location for visual elements, a transcript span for speech content, and a policy identifier corresponding to the violated rule.

Embodiment 14: The method of embodiment 1, wherein the method further comprises: distributing processing of the video data stream across multiple computing nodes, with preprocessing, feature extraction, and evaluation stages executed in parallel on respective hardware accelerators; and synchronizing intermediate outputs via a directed acyclic graph-based job scheduler to reduce end-to-end analysis latency.

Embodiment 15: The method of embodiment 1, wherein evaluating the plurality of features comprises selecting a version of the plurality of compliance rules from a version-controlled policy database based on a timestamp associated with the video data stream, and applying only the selected version during compliance evaluation.

Embodiment 16: The method of embodiment 1, wherein at least one of the obtaining, transforming, extracting, evaluating, or constructing is performed on at least one of a client device or a cloud-based computing environment.

Embodiment 17: The method of embodiment 1, wherein constructing the output data structure comprises constructing a machine-readable compliance report conforming to at least one of a JavaScript Object Notation schema or an Extensible Markup Language schema, the schema including fields for at least one of time-aligned annotations, detected violation categories, model confidence scores, or policy identifiers.

Embodiment 18: The method of embodiment 1, wherein the video data stream comprises a candidate introduction video submitted as part of a hiring process.

Embodiment 19: The method of embodiment 1, wherein extracting the plurality of features comprises steps for generating visual, audio, and textual features from the transformed video data stream.

Embodiments 20: A computer readable medium storing instructions for, or computer system configured to execute, any of the embodiments in groups A-C.

What is claimed is:

1. A computer-implemented method for determining whether video content conforms to organizational policies and legal requirements, the method comprising:
obtaining, by a computing system, a video data stream comprising a sequence of image frames and associated audio;
transforming, by the computing system, the obtained video data stream by:
reducing frame-to-frame motion artifacts to stabilize the image sequence;
normalizing luminance and color distribution across frames to achieve temporal lighting consistency; and
suppressing non-speech audio components to reduce acoustic interference in downstream speech analysis;
extracting, by the computing system, a plurality of features from the transformed video data stream, the features comprising:
visual content derived from analyzing pixel-level patterns across a sequence of frames using a convolutional neural network;
audio-derived textual content obtained via speech-to-text conversion using a deep recurrent or transformer-based sequence model; and
embedded or overlay text extracted using optical character recognition techniques;
evaluating, by the computing system, the plurality of features with respect to a plurality of compliance rules by applying one or more trained machine learning models to detect patterns indicative of potential violations, the trained models configured to capture semantic, contextual, and cross-modal relationships between extracted content and predefined policy constraints; and
constructing, by the computing system, an output data structure comprising an assessment of whether the video content conforms to the plurality of compliance rules, the output data structure identifying nonconforming segments and providing time-aligned annotations corresponding to the detected nonconformities.

2. The method of claim 1, wherein obtaining the video data stream comprises retrieving, by the computing system, previously recorded video content from a data storage resource comprising one or more of a local memory, a network-accessible storage device, or a cloud-based video repository.

3. The method of claim 2, wherein the data storage resource received the video content from one or more upstream sources comprising at least on of a video capture device, third-party content platform, or enterprise content management system.

4. The method of claim 1, wherein obtaining the video data stream comprises receiving, by the computing system, video content transmitted as a live stream from a real-time capture source, the real-time capture source comprising one or more network-connected image acquisition devices.

5. The method of claim 1, wherein determining the visual content from the transformed video data stream comprises:
processing the image sequence using a convolutional neural network configured to detect spatial and temporal visual features across multiple frames;
identifying one or more object regions by applying a region proposal mechanism, wherein each proposed region is evaluated for the presence of visual elements indicative of compliance-relevant content;
classifying detected objects by comparing learned feature embeddings against class-specific thresholds using a softmax activation function;
localizing facial regions and computing facial expression embeddings using a facial landmark estimation network;
extracting body pose keypoints by applying a multi-stage pose estimation model to detected human figures, the keypoints comprising at least limb positions, orientation, and hand gestures; and
aggregating detected visual features across a temporal window by applying attention-weighted pooling, wherein greater emphasis is assigned to frames exhibiting abrupt or anomalous movement patterns.

6. The method of claim 1, wherein determining the audio-derived textual content comprises:
transforming an audio signal into a time-frequency representation using a short-time Fourier transform to produce a spectrogram;
extracting acoustic features from the spectrogram by applying a convolutional encoder followed by a recurrent or transformer-based decoder trained for automatic speech recognition;
constructing a phoneme-level hypothesis stream using a connectionist temporal classification decoder, and mapping phonemes to word-level transcriptions via a lexicon and language model;
detecting speaker diarization segments by clustering audio embeddings derived from the recognition network;
performing voice activity detection using a neural network classifier to segment speech from non-speech audio; and
classifying emotional tone using a paralinguistic model trained to infer affective state from prosodic and spectral features, the emotional tone comprising categories such as anger, enthusiasm, discomfort, or neutrality.

7. The method of claim 1, wherein evaluating the plurality of features with respect to the compliance rules comprises accessing a data source comprising a collection of organizational policies and legal standards, the data source being periodically updated to reflect changes in internal policy frameworks or applicable regulatory requirements.

8. The method of claim 1, wherein reducing frame-to-frame motion artifacts comprises computing an optical flow field between consecutive frames using a pyramidal Lucas-Kanade algorithm, filtering out outlier motion vectors with a RANSAC process, and applying an affine transformation to each frame to correct estimated global camera motion.

9. The method of claim 1, wherein normalizing luminance and color distribution comprises performing histogram equalization on each frame, applying a Retinex-based illumination correction to remove non-uniform lighting, and adjusting white balance parameters based on a detected scene color temperature.

10. The method of claim 1, wherein suppressing non-speech audio components comprises performing voice activity detection using a neural network trained on Mel-frequency cepstral coefficient features, and applying a spectral subtraction algorithm to attenuate non-speech frequency components during detected speech intervals.

11. The method of claim 1, wherein evaluating the plurality of features comprises performing cross-modal attention between visual embeddings, audio embeddings, and text embeddings to detect compliance violations indicated by temporally co-occurring cues across different modalities.

12. The method of claim 1, wherein evaluating the plurality of features comprises retrieving, from a version-controlled policy and legal database, a set of active compliance rules based on jurisdiction and content metadata, and mapping detected features to rule identifiers with associated enforcement priorities.

13. The method of claim 1, wherein constructing the output data structure comprises including, for each detected nonconformity, a frame index or timestamp, a bounding-box location for visual elements, a transcript span for speech content, and a policy identifier corresponding to the violated rule.

14. The method of claim 1, wherein the method further comprises:
distributing processing of the video data stream across multiple computing nodes, with preprocessing, feature extraction, and evaluation stages executed in parallel on respective hardware accelerators; and
synchronizing intermediate outputs via a directed acyclic graph-based job scheduler to reduce end-to-end analysis latency.

15. The method of claim 1, wherein evaluating the plurality of features comprises selecting a version of the plurality of compliance rules from a version-controlled policy database based on a timestamp associated with the video data stream, and applying only the selected version during compliance evaluation.

16. The method of claim 1, wherein at least one of the obtaining, transforming, extracting, evaluating, or constructing is performed on at least one of a client device or a cloud-based computing environment.

17. The method of claim 1, wherein constructing the output data structure comprises constructing a machine-readable compliance report conforming to at least one of a JavaScript Object Notation schema or an Extensible Markup Language schema, the schema including fields for at least one of time-aligned annotations, detected violation categories, model confidence scores, or policy identifiers.

18. The method of claim 1, wherein the video data stream comprises a candidate introduction video submitted as part of a hiring process.

19. The method of claim 1, wherein extracting the plurality of features comprises steps for generating visual, audio, and textual features from the transformed video data stream.

20. A tangible, non-transitory, machine-readable medium storing instructions that when executed effectuate operations comprising:
obtaining, by a computing system, a video data stream comprising a sequence of image frames and associated audio;
transforming, by the computing system, the obtained video data stream by:
reducing frame-to-frame motion artifacts to stabilize the image sequence;
normalizing luminance and color distribution across frames to achieve temporal lighting consistency; and
suppressing non-speech audio components to reduce acoustic interference in downstream speech analysis;
extracting, by the computing system, a plurality of features from the transformed video data stream, the features comprising:
visual content derived from analyzing pixel-level patterns across a sequence of frames using a convolutional neural network;
audio-derived textual content obtained via speech-to-text conversion using a deep recurrent or transformer-based sequence model; and
embedded or overlay text extracted using optical character recognition techniques;
evaluating, by the computing system, the plurality of features with respect to a plurality of compliance rules by applying one or more trained machine learning models to detect patterns indicative of potential violations, the trained models configured to capture semantic, contextual, and cross-modal relationships between extracted content and predefined policy constraints; and
constructing, by the computing system, an output data structure comprising an assessment of whether the video content conforms to the plurality of compliance rules, the output data structure identifying nonconforming segments and providing time-aligned annotations corresponding to the detected nonconformities.
